(19) United States
(12) Patent Application Publication
(10) Pub. No.: US 2017/0357325 A1
(43) Pub. Date: Dec. 14, 2017

(54) Localized Deflection Using a Bending Haptic Actuator

(71) Applicant: Apple Inc., Cupertino, CA (US)

(72) Inventors: Jui-Ming Yang, Sunnyvale, CA (US); Nathan K. Gupta, San Francisco, CA (US); Po-Jui Chen, Taichung (TW); Teera Songatikamas, San Jose, CA (US); Kyle J. Campiotti, San Jose, CA (US); Robert L. Sheridan, Sunnyvale, CA (US); Xiaonan Wen, San Jose, CA (US); Xiaofan Niu, Campbell, CA (US); James E. Pedder, Thame (GB)

(21) Appl. No.: 15/622,017

(22) Filed: Jun. 13, 2017

Related U.S. Application Data
(60) Provisional application No. 62/349,799, filed on Jun. 14, 2016.
(60) Provisional application No. 62/395,967, filed on Sep. 16, 2016.
(60) Provisional application No. 62/354,089, filed on Jun. 23, 2016.
(60) Provisional application No. 62/398,469, filed on Sep. 22, 2016.

(51) Int. Cl. G06F 3/01; G06F 3/041; G06F 3/044

(52) U.S. Cl. CPC G06F 3/016; G06F 3/044; G06F 3/0414; G06F 3/0412

(57) ABSTRACT

An electronic device configured to provide localized haptic feedback to a user on one or more regions or sections of a surface of the electronic device. A support structure is positioned below the surface, and one or more haptic actuators are coupled to the support structure. In some examples, the support structure is shaped or configured to amplify a response to a haptic actuator. When a haptic actuator is actuated, the support structure deflects, which causes the surface to bend or deflect at a location that substantially corresponds to the location of the activated haptic actuator. In some examples, prior to providing haptic feedback, at least one haptic actuator is electrically pre-stressed to place the haptic actuator(s) in a pre-stressed state. When haptic feedback is to be provided, at least one haptic actuator transitions from the pre-stressed state to a haptic output state to produce one or more deflections in the surface. In other examples, a haptic structure incorporates a piezoelectric element that is shaped to reduce the overall cost of the haptic structure while still providing high actuation performance.

### CROSS-REFERENCE TO RELATED APPLICATION(S)

The application claims the benefit under 35 U.S.C. §119(e) of U.S. Provisional Patent Application No. 62/349,799, filed on Jun. 14, 2016, and entitled “Reduced Cost Piezoelectric Wafer for Localizing Haptic Output For An Electronic Device;” U.S. Provisional Patent Application No. 62/354,089, filed on Jun. 23, 2016, and entitled “Localized Deflection of a Surface in an Electronic Device;” U.S. Provisional Patent Application No. 62/395,967, filed on Sep. 16, 2016, and entitled “Displacement Amplification in Bending Haptic Actuator;” and U.S. Provisional Patent Application No. 62/398,469, filed on Sep. 22, 2016, and entitled “Pre-Stressed Haptic Actuator in an Electronic Device,” each of which is incorporated by reference as if fully disclosed herein.

### FIELD

The described embodiments relate generally to haptic output devices in electronic devices. More particularly, the present embodiments relate to a haptic output device that is configured to provide localized deflection of a surface of an electronic device.

### BACKGROUND

Electronic devices are commonplace in today's society. Some of these electronic devices can incorporate a haptic output system. A haptic output system uses the sense of touch to convey information to a user. An electronic device activates the haptic output system to solicit a user's attention, enhance the user's interaction experience with the electronic device, displace the electronic device or a component of the electronic device, or for any other suitable notification or user experience purpose. Typically, the haptic output system generates the haptic output through the production of forces, vibrations, and/or motions. In many situations, the haptic output is perceived by a user as haptic feedback.

### SUMMARY

Embodiments described herein relate to an electronic device that is configured to provide localized haptic feedback to a user on one or more surfaces of the electronic device. In one aspect, an electronic device can include an intermediate layer positioned below a surface and a support structure positioned below the intermediate layer. A haptic actuator is coupled to the support structure, and the support structure is shaped or configured to amplify a haptic response at the surface. Actuation of the haptic actuator causes the support structure to deflect, which in turn causes the intermediate layer to deflect and the surface to deflect. Deflection of the support structure produces a deflection in the surface of the electronic device at a location that corresponds to a location of the haptic actuator on the support structure. In some embodiments, a circuit layer is attached to a surface of the support structure and the haptic actuator is attached and electrically connected to the circuit layer. In other embodiments, one or more signal lines or conductive traces may be included in the support structure and electrically connected to the haptic actuator. The circuit layer or the signal lines can be used to activate the haptic actuator.

In an example embodiment, an electronic device is provided. The electronic device includes a cover sheet defining a surface, a haptic actuator positioned below the cover sheet, and a support structure coupled to the haptic actuator. Actuation of the actuator causes a deflection in the surface at a location that substantially corresponds to a location of the haptic actuator. The support structure amplifies the deflection in the surface.

In another embodiment, the support structure includes a cavity within a side of the support structure opposite the cover sheet. The cavity is substantially centered over the haptic actuator. In another embodiment, the support structure includes a force concentration region positioned over the haptic actuator. Actuation of the haptic actuator causes an amplified deflection within the force concentration region.

In another embodiment, the support structure is curved away from the cover sheet at a location coupled to the haptic actuator. In another embodiment, the support structure has an arm, and an end of the arm displaces upward in response to actuation of the haptic actuator. In another embodiment, the electronic device includes an upper support structure positioned below the cover sheet and curved toward the cover sheet, a lower support structure positioned below the upper support structure and curved away from the cover sheet, and a haptic actuator positioned between and coupled to the upper support structure and the lower support structure.

One or more haptic actuators may be placed in a pre-stressed state prior to providing the haptic feedback. The pre-stressed state positions the haptic actuators closer to the surface to be deflected. In this manner, the time lag between actuation of the haptic actuator(s) and providing the haptic output in the surface may be reduced. Additionally, the actuation performances of the haptic actuators can be more uniform, which results in a more uniform haptic output on the surface.

In one aspect, an electronic device includes a support structure positioned below a surface to be deflected, a haptic actuator coupled to the support structure, and a processing unit coupled to the haptic actuator. The processing unit is configured to cause a pre-stress signal to be transmitted to the haptic actuator to cause the haptic actuator to be placed in a pre-stressed state. The pre-stressed state causes the support structure to deflect and position the haptic actuator closer to the surface. The processing unit is further configured to cause an actuation signal to be transmitted to the haptic actuator to cause the haptic actuator to be placed in a haptic output state. The haptic output state causes the deflection of the support structure to increase locally and produce a deflection in the surface at a location that substantially corresponds to a location of the haptic actuator on the support structure.

In another aspect, an electronic device includes a support structure that is connected to a surface to be deflected. The support structure includes a support plate and sides extending from the support plate to the surface. In some embodiments, a haptic actuator is attached to the support plate and a circuit layer is attached and electrically connected to the haptic actuator. In other embodiments, a circuit layer is attached to the support plate and the haptic actuator is attached and electrically connected to the circuit layer. When the haptic actuator is in a rest or non-actuated state, the support plate is positioned a first distance from the surface to define a gap between the surface and the support plate. A processing unit is configured to cause a pre-stress signal to be transmitted to the haptic actuator to cause the haptic actuator to be placed in a pre-stressed state. In one embodiment, the pre-stressed state causes the support structure to deflect and positions the support plate within the gap at a second distance below the surface, where the second distance is less than the first distance. In some situations, the deflection of the support plate can close the gap. Closure of the gap occurs when the support plate contacts the surface without producing a deflection in the surface. The processing unit is also configured to cause an actuation signal to be transmitted to the haptic actuator to cause the support structure to further deflect and position the support structure at a third distance below the surface. The third distance is less than the second distance and produces a deflection in the surface at a location that substantially corresponds to a location of the haptic actuator on the support structure.

In another embodiment, the pre-stressed state causes the support structure to deflect to expand or enlarge the gap, which positions the support structure at a fourth distance below the surface. The fourth distance is greater than the first distance associated with the non-actuated state. When the processing unit causes an actuation signal to be transmitted to the haptic actuator, the support structure deflects and positions the support structure at the third distance below the surface. The third distance is less than the fourth distance and produces a deflection in the surface at a location that substantially corresponds to a location of the haptic actuator on the support structure.

In some embodiments, an intermediate layer (e.g., one or more layers) can be attached to the surface. In such embodiments, the gap is defined between the support plate and the intermediate layer. In a non-limiting example, the surface is a cover sheet that is positioned over a display layer, a backlight assembly, and a first force-sensing component. In one embodiment, the first force-sensing component is positioned between the display layer and the backlight assembly. In another embodiment, the first force-sensing component is disposed below the backlight assembly. Thus, the intermediate layer includes the display layer, the backlight assembly, and the first force-sensing component. A second force-sensing component may be attached to a top surface of the support plate. When the haptic actuator is placed in the pre-stressed state, the support plate can deflect toward the bottom surface of the intermediate layer to position the support plate within the gap. In some situations, pre-stressing the haptic actuator can cause the gap between the intermediate layer and the second force-sensing component to be closed. Closure of the gap occurs when the second force-sensing component contacts the intermediate layer without producing a deflection in the cover sheet.

In some embodiments, the closure of the gap can be detected when the haptic actuator is in the pre-stressed state. In a first non-limiting example, the haptic actuator can include a piezoelectric material. A processing unit can be configured to receive an output signal from the piezoelectric material that indicates the gap is closed. In a second non-limiting example, the haptic actuator can be attached to the bottom surface of the support plate and another haptic actuator may be positioned over, or attached to, the top surface of the support plate. A processing unit can be configured to receive an output signal from the second haptic actuator that indicates the gap is closed. In a third non-limiting example, the haptic actuator can be attached to the bottom surface of the support plate and a strain sensor may be positioned over, or attached to, the top surface of the support plate. A processing unit can be configured to receive a strain signal from the strain sensor that indicates the gap is closed. Techniques other than these three representative methods can be used to detect the closure of the gap.

In other embodiments, the expansion of the gap can be detected when the haptic actuator is in the pre-stressed state. At least one of the first, the second, and/or the third force-sensing components can be configured to detect the displacement of the support structure. For example, expansion of the gap may be detected through capacitance changes between the first and the second force-sensing components and/or through capacitance changes between the third force-sensing component and the support structure. A processing unit can be configured to receive a sense signal from a respective force-sensing component and to associate the sense signal to the enlargement of the gap.

In yet another aspect, an electronic device can include a support plate, a surface, a gap between the support plate and the surface, and a haptic actuator attached to the support plate. A method of operating the electronic device includes transmitting a pre-stress signal to the haptic actuator to place the haptic actuator in a pre-stressed state. The pre-stress signal causes the support plate to deflect toward the surface and position the haptic actuator closer to the surface without deflecting the surface. A determination may be made as to whether to place the haptic actuator in a haptic output state that causes the deflection in the support plate to increase locally and deflect the surface. If the haptic actuator is to be placed in the haptic output state, an actuation signal is transmitted to the haptic actuator to place the haptic actuator in the haptic output state. When the haptic output state ends, another pre-stress signal may be transmitted to the haptic actuator to place the haptic actuator in a second pre-stressed state.

In yet another aspect, an electronic device can include a surface; an intermediate layer formed with one or more layers attached to the surface; a support plate; a gap between the support plate and the intermediate layer; and a haptic actuator attached to the support plate. A method of operating the electronic device includes transmitting a pre-stress signal to the haptic actuator to place the haptic actuator in a pre-stressed state. The pre-stress signal causes the support plate to deflect toward the intermediate layer and position the haptic actuator closer to the surface without producing a deflection in the surface. A determination may be made as to whether to place the haptic actuator in a haptic output state that causes the deflection in the support plate to increase locally and produce the deflection in the surface. If the haptic actuator is to be placed in the haptic output state, an actuation signal is transmitted to the haptic actuator to place the haptic actuator in the haptic output state. When the haptic output state ends, another pre-stress signal may be transmitted to the haptic actuator to place the haptic actuator in a second pre-stressed state.

In some embodiments, if the haptic actuator will not be placed in the haptic output state, the transmission of the pre-stress signal to the haptic actuator can cease to place the haptic actuator in a rest state. Alternatively, if the haptic actuator will not be placed in the haptic output state, the transmission of the pre-stress signal to the haptic actuator may continue to maintain the pre-stressed state. In some embodiments, the method can also include detecting a closure of the gap while the pre-stress signal is transmitted to the haptic actuator.

In another aspect, an electronic device includes a surface to be deflected and a support plate. The support plate is positioned a first distance below the surface to define a gap between the surface and the support plate. A haptic actuator is attached to the support plate. A processing unit is configured to cause a pre-stress signal to be transmitted to the haptic actuator to cause the haptic actuator to be placed in a pre-stressed state. In one embodiment, the pre-stressed state can cause the support structure to deflect and position the support structure within the gap at a second distance below the surface, where the second distance is less than the first distance. In another embodiment, the pre-stressed state can cause the support structure to deflect and position the support structure at a third distance below the surface, where the third distance is greater than the first distance.

In yet another aspect, an electronic device can include an intermediate layer positioned below a surface and a support structure positioned below the intermediate layer. A haptic actuator is coupled to the support structure, and the support structure includes one or more openings formed through the support structure adjacent at least one side of the haptic actuator. For example, an opening can be formed through the support structure adjacent two opposing sides of the haptic actuator. Actuation of the haptic actuator causes the support structure to deflect, which in turn causes the intermediate layer to deflect and the surface to deflect. Deflection of the support structure produces a deflection in the surface of the electronic device at a location that corresponds to a location of the haptic actuator on the support structure. In some embodiments, a circuit layer is attached to a surface of the support structure and the haptic actuator is attached and electrically connected to the circuit layer. In other embodiments, one or more signal lines or conductive traces may be included in the support structure and electrically connected to the haptic actuator. The circuit layer or the signal line(s) can be used to activate the haptic actuator.

In one non-limiting example, a support structure is attached to a cover sheet in an electronic device. A display layer (intermediate layer) is positioned between the cover sheet and the support structure. A circuit layer is attached to a bottom surface of the support structure, and one or more haptic actuators are attached and electrically connected to the circuit layer. When at least one haptic actuator is activated, the support structure deflects upwards toward the cover sheet, and the deflection transmits through the display layer and the cover sheet to produce a deflection in a top surface of the cover sheet. A user may perceive the deflection in the cover sheet as haptic feedback.

In some embodiments, one or more additional layers or elements can be positioned between the cover sheet and the support structure. For example, in one embodiment a backlight assembly can be positioned below the display layer. Additionally or alternatively, one or more touch and/or force-sensing components can be positioned between the cover sheet and the support structure. For example, in one embodiment a first force-sensing component may be attached to a backlight assembly and a second force-sensing component can be attached to the support structure (e.g., on a top surface of the support structure). In such embodiments, the support structure can be spaced apart from the first force-sensing component such that a gap is defined between the first force-sensing component and the second force-sensing component.

In another aspect, an electronic device can include an intermediate layer positioned below a surface and a support structure positioned below the intermediate layer. A circuit layer is selectively attached (e.g., rigidly affixed) to a surface of the support structure, and a haptic actuator is attached and electrically connected to the circuit layer. In particular, one or more first sections of the circuit layer are affixed to the surface of the support structure and one or more second sections of the circuit layer are not affixed to the surface of the support structure. Actuation of the haptic actuator causes the support structure to deflect and produce a deflection in the surface of the electronic device at a location that corresponds to a location of the haptic actuator on the circuit layer and the support structure.

In another aspect, a haptic or deflection module is configured to produce one or more localized deflections in a surface in an electronic device. The haptic or deflection module includes a support structure positioned below the surface and a circuit layer positioned on a bottom surface of the support structure. A haptic actuator is attached and electrically connected to the circuit layer. The support structure includes a first opening and a second opening formed through the support structure, the first opening positioned along a first side of the haptic actuator and the second opening positioned along a second side of the haptic actuator. Actuation of the haptic actuator causes the support structure to deflect and produce a deflection in the surface at a location in the surface that corresponds to a location of the haptic actuator on the circuit layer.

In yet another aspect, a haptic or deflection module is configured to produce one or more localized deflections in a surface of an electronic device. The deflection module includes a support structure positioned below the surface, and a circuit layer positioned on a bottom surface of the support structure. One or more first sections of the circuit layer are rigidly affixed to the bottom surface of the support structure and one or more second sections of the circuit layer are not affixed to the bottom surface of the support structure. A haptic actuator is attached and electrically connected to the circuit layer. Actuation of the haptic actuator causes the support structure to deflect and produce a deflection in the surface at a location in the surface that corresponds to a location of the haptic actuator on the circuit layer.

A method for producing a haptic or deflection module includes providing a support structure for an electronic device. One or more openings can be formed through the support structure adjacent a location of a haptic actuator. Additionally or alternatively, a circuit layer is selectively attached to the support structure. In particular, one or more first sections of the circuit layer are rigidly attached to a surface of the electronic device, while one or more second sections of the circuit layer are not attached to the surface of the support structure. One or more haptic actuators are attached and electrically connected to the circuit layer. The deflection module may then be attached to a component in the electronic device. Example components include, but are not limited to, an enclosure, a frame, an input surface, or a cover sheet of the electronic device.

In another aspect, due to the cost of the materials in the haptic structure, the embodiments described herein are directed to using materials, shapes and configurations that reduce the overall cost of the haptic structure.

More specifically, described herein is a haptic structure for an electronic device. The haptic structure comprises a piezoelectric material, a first electrode coupled to a first side of the piezoelectric material and a second electrode coupled to a second side of the piezoelectric material. The haptic structure also includes a first electrical contact formed from a first material and coupled to the first electrode and a second electrical contact formed from a second material that is different than the first material. The second electrical contact is coupled to the second electrode and has a width that is less than a width of the first electrical contact.

Other embodiments described herein may generally relate to a haptic structure for providing localized haptic output for an electronic device. The haptic structure includes a cross-shaped piezoelectric material operative to deflect and provide haptic output in response to a received stimulus. The haptic structure also includes a first flex comprising a ground electrical contact coupled to a first side of the cross-shaped piezoelectric material and a second flex comprising a drive electrical contact coupled to a second side of the cross-shaped piezoelectric material. The second flex and the drive electrical contact have a width that is less than a width of the first flex.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example of an electronic device that can provide localized deflection of a surface.

FIG. 2A depicts a cross-sectional view of an example of the electronic device, taken along line A-A of FIG. 1.

FIG. 2B depicts the example electronic device of FIG. 2A, illustrating a haptic actuator being actuated.

FIG. 2C depicts a cross-sectional view of another example of the electronic device, taken along line A-A of FIG. 1.

FIG. 2D depicts the example electronic device of FIG. 2C, illustrating a haptic actuator being actuated.

FIG. 3A depicts a first example haptic actuator, in the form of a piezoelectric transducer.

FIG. 3B depicts a second example haptic actuator, which may be a piezoelectric transducer.

FIG. 3C depicts a third example haptic actuator, which may include reduced cost circuit and ground layers.

FIG. 3D depicts a fourth example haptic actuator, which may include reduced cost and increased performance circuit and ground layers.

FIG. 4 depicts a plan view of one example of the deflection module shown in FIGS. 2A and 2B, as viewed from below.

FIG. 5A depicts a first example of a deflection module having a support structure shaped to amplify the output of a haptic actuator

FIG. 5B depicts the example deflection module of FIG. 5A, illustrating a haptic actuator being actuated.

FIG. 6A depicts a second example of a deflection module having a support structure shaped to amplify the output of a haptic actuator.

FIG. 6B depicts the example deflection module of FIG. 6A, illustrating a haptic actuator being actuated.

FIG. 7A depicts a third example of a deflection module having a support structure shaped to amplify the output of a haptic actuator.

FIG. 7B depicts the example deflection module of FIG. 7A, illustrating a haptic actuator being actuated.

FIG. 8A depicts a fourth example of a deflection module having a support structure shaped to amplify the output of a haptic actuator.

FIG. 8B depicts the example deflection module of FIG. 8A, illustrating a haptic actuator being actuated.

FIG. 9A depicts a fifth example of a deflection module having a support structure shaped to amplify the output of a haptic actuator.

FIG. 9B depicts the example deflection module of FIG. 9A, illustrating a haptic actuator being actuated.

FIG. 9C depicts another embodiment of the fifth example of a deflection module having a support structure shaped to amplify the output of a haptic actuator.

FIG. 9D depicts the example deflection module of FIG. 9C, illustrating a haptic actuator being actuated.

FIG. 10A depicts a sixth example of a deflection module having a support structure shaped to amplify the output of a haptic actuator.

FIG. 10B depicts the example deflection module of FIG. 10A, illustrating a haptic actuator being actuated.

FIG. 11A depicts a seventh example of a deflection module having a support structure shaped to amplify the output of a haptic actuator.

FIG. 11B depicts the example deflection module of FIG. 11A, illustrating a haptic actuator being actuated.

FIG. 11C depicts an example linking mechanism of the seventh example deflection module.

FIG. 11D depicts the example linking mechanism of FIG. 11C, illustrating a haptic actuator being actuated.

FIG. 11E depicts another example linking mechanism of the seventh example deflection module.

FIG. 11F depicts the example linking mechanism of FIG. 11E, illustrating a haptic actuator being actuated.

FIG. 11G depicts another example linking mechanism of the seventh example deflection module.

FIG. 11H depicts the example linking mechanism of FIG. 11G, illustrating a haptic actuator being actuated.

FIG. 12 depicts a cross-sectional view of the electronic device taken along line A-A in FIG. 1.

FIG. 13A depicts a cross-sectional view of another example electronic device with the haptic actuators in a non-actuated state.

FIG. 13B depicts the electronic device shown in FIG. 13A with the haptic actuators in a pre-stressed state.

FIG. 13C depicts the electronic device shown in FIG. 13B with one haptic actuator in a haptic output state.

FIG. 14 depicts an example graph representing the deflection of a cover sheet in response to the application of a signal to a haptic actuator.

FIG. 15A depicts an example graph illustrating an example pre-stress signal that can be applied to a haptic actuator.

FIG. 15B depicts an example graph of an output signal produced by the haptic actuator based on the input signal shown in FIG. 15A.

FIG. 16A depicts a top view of a haptic actuator that can be used to sense the closure of a gap.

FIG. 16B depicts a side view of the haptic actuator shown in FIG. 16A.

FIG. 17 depicts a second technique for pre-stressing a haptic actuator and sensing the closure of a gap.

FIG. 18A depicts a third technique for pre-stressing a haptic actuator and sensing the closure of a gap.

FIG. 18B depicts a third technique for pre-stressing a haptic actuator and sensing the closure of a gap.

FIG. 19 depicts a fourth technique for pre-stressing a haptic actuator and sensing the closure of a gap.

FIG. 20 depicts a cross-sectional view of another example of the electronic device taken along line A-A in FIG. 1.

FIG. 21 depicts a cross-sectional view of another example of the electronic device taken along line A-A in FIG. 1, where the haptic actuators are in a pre-stressed state.

FIG. 22 depicts a flowchart of a method of calibrating the pre-stress signals for an array of haptic actuators.

FIG. 23 depicts a flowchart of a method of operating an electronic device.

FIG. 24 depicts one example of a first deflection module that is configured to produce increased deflection.

FIG. 25 depicts one example of a second deflection module that is configured to produce increased deflection.

FIG. 26 depicts one example of a third deflection module that is configured to produce increased deflection.

FIG. 27 depicts one example of a fourth deflection module that is configured to produce increased deflection.

FIG. 28 depicts a flowchart of a method of producing a deflection module that provides localized deflection in a surface of an electronic device that is positioned over the deflection module.

FIG. 29 illustrates an arrangement of haptic structures that may be used to provide localized haptic output for an electronic device.

FIG. 30A illustrates an example shape of a piezoelectric wafer that may be incorporated in the haptic structures described herein.

FIG. 30B illustrates another example shape of a piezoelectric wafer that may be incorporated in the haptic structures described herein.

FIG. 30C illustrates a third example shape of a piezoelectric wafer that may be incorporated in the haptic structures described herein.

FIG. 31 illustrates an example piezoelectric sheet for cutting cross-shaped piezoelectric wafers that may be integrated with a haptic structure.

FIG. 32 illustrates an example piezoelectric sheet for cutting wafers of piezoelectric material into cross-shaped sections that may be integrated with a haptic structure.

FIG. 33 depicts a system diagram including example components of an electronic device in accordance with the embodiments described herein.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, they are intended to cover alternatives, modifications, and equivalents as can be included within the spirit and scope of the described embodiments as defined by the appended claims.

The following disclosure relates to an electronic device that is configured to provide localized haptic feedback to a user on one or more surfaces of the electronic device. The surface that receives the haptic output can be a surface of an input device, a cover sheet disposed over a component of the input device, a cover sheet disposed over a component of the electronic device, and/or at least a portion of the enclosure of the electronic device. Haptic output is generated through the production of mechanical movement, vibrations, and/or force. In some embodiments, the haptic output can be created based on an input command (e.g., one or more touch and/or force inputs), a simulation, an application, or a system state. When the haptic output is applied to a surface (or surfaces), a user can detect or feel the haptic output and perceive the haptic output as localized haptic feedback.

The localized haptic output can be produced based on a user interacting with one or more regions of a surface of an electronic device. For example, a user can be providing touch and/or force inputs on a cover sheet positioned over a display in an electronic device. A user can provide the touch and/or force inputs based on an application or a user interface rendered on the display. Localized haptic output may be provided to a region of the cover sheet in response to at least one touch and/or force input.

Additionally or alternatively, localized haptic feedback can be applied to one or more regions of a surface of an electronic device that the user is touching. For example, localized haptic output may be applied to one or more regions of an enclosure of the electronic device when the user is touching the region and/or touching the enclosure.

In a particular embodiment, a haptic or deflection module is positioned below a surface of the electronic device. The haptic or deflection module includes one or more haptic actuators that are coupled to at least one surface of a support structure. In some embodiments, the haptic actuator is coupled to at least one surface of a support structure. In some embodiments, the haptic actuator(s) is coupled to the support structure through a circuit layer. The circuit layer is operatively (e.g., electrically) connected to a signal generator that produces one or more electrical signals. The circuit layer is configured to provide the electrical signal(s) to each individual haptic actuator to selectively actuate one or more haptic actuators concurrently, with some overlap in time, or sequentially. When actuated, the surface bends or deflects at a location that substantially corresponds to the location of the haptic actuator on the support structure.

In some embodiments, one or more intermediate layers are positioned between the surface and the haptic or deflection module. For example, in one embodiment the surface is a cover sheet and the intermediate layer includes a display layer disposed between the cover sheet and the haptic or deflection module. Deflection of the support structure transmits through the display layer to the top surface of the cover sheet and causes a region or section of the cover sheet to bend or deflect.

The support structure may be designed to amplify a haptic response at the surface in response to actuation of the haptic actuator. In an example embodiment, the support structure may be designed to be more flexible at a location above the haptic actuator. In some examples, the support structure includes a cavity above the haptic actuator to increase the flexibility directly above the haptic actuator and amplify deflection of the support structure. In other examples, the support structure includes a force concentration region above the haptic actuator. The force concentration region may be formed from a material with a lower modulus of elasticity than surrounding regions, increasing flexibility and deflection in response to the haptic actuator.

In another example embodiment, the support structure may be pre-curved and/or pre-strained into a curve. The curved shape of the support structure may act as a spring which “pops” from a downward curve into an upward curve when the haptic actuator is actuated. The support structure is mechanically unstable at an intermediate position, so that when it moves past a midpoint it “pops” and transfers a distinctive haptic response to the surface.

In another example embodiment, the support structure includes a movable arm. The arm moves upward in response to actuation of the haptic actuator, causing a corresponding deflection on the surface. In some examples, a pair of arms are connected by a hinge to form a scissor mechanism. In other examples, a pair of arms are connected by a flexure that bends upwards in response to actuation of the haptic actuator.

In another example embodiment, an upper support structure and lower support structure surround the haptic actuator. Both support structures respond to actuation of the haptic actuator by deflecting vertically. The lower support structure is in contact with a rigid lower layer such that when it deflects, it causes the upper support structure to be moved upward. The upper support structure simultaneously deflects upward. This adds the deflection of the upper support structure to the response of the lower support structure to amplify the haptic response at the surface.

In some embodiments, the support structure may extend along a length and a width of the display layer. An array of haptic actuators may be coupled to the support structure to provide localized feedback across the surface. In other embodiments, the support structure may extend more or less than the length and width of the display. In still other embodiments, the support structure may be an array of support structures, corresponding to an array of haptic actuators.

In another particular embodiment, the haptic actuator(s) can operate in three states: a rest state, a pre-stressed state, and an actuation state. The rest state occurs when the haptic actuators are not activated. The pre-stressed state occurs when the haptic actuators receive a pre-stress signal. The pre-stress signal actuates the haptic actuators and causes the support structure to deflect and position the haptic actuators closer to a surface to be deflected without deflecting (or substantially deflecting) the surface. The actuation state occurs when one or more of the pre-stressed haptic actuators receive an actuation signal. The actuation signal further activates the haptic actuator(s), which causes the deflection in the support structure to increase locally and deflect the surface at a location that substantially corresponds to the location of the haptic actuator(s) on the support structure.

Thus, a deflection module and/or a haptic output device is arranged to operate in three configurations: a rest configuration where the haptic actuators are not actuated, a pre-stressed configuration where the haptic actuators are actuated and positioned either closer to or farther from the surface without deflecting (or substantially deflecting) the surface, and a haptic output configuration where one or more haptic actuators are further actuated to produce a deflection or deflections in the surface.

In some implementations, a haptic or deflection module may be configured to produce increased deflection. In an example, a haptic actuator may be rigidly affixed to a support structure through a circuit layer. However, only shorter sides of a rectangular support structure are rigidly attached to a component in an electronic device. This may relax strain in the support structure, facilitating a greater amount of deflection in response to actuation of the haptic actuator.

In another example, an array of haptic actuators may be attached to a support structure through a circuit layer. Only two sides of each haptic actuator may be rigidly attached to the circuit layer, which may similarly facilitate greater deflection in response to actuation of one or more haptic actuators. In other examples, the support structure may additionally or alternatively incorporate openings in order to further relieve strain in the support structure, further facilitating deflection in response to actuation of a haptic actuator.

In some implementations, the size of the piezoelectric material (e.g., piezoelectric element) may be related to the amount of deflection of the haptic structure and, as a result, the amount of haptic output that is perceivable by a user. Thus, the larger the piezoelectric material, the higher the amount of deflection. However, the cost of the piezoelectric material also scales by size. The larger the piezoelectric material, the greater the cost to produce the haptic structure.

In order to address the high cost of producing haptic structures, some embodiments described herein are directed to piezoelectric elements having a cross-shaped configuration. These cross-shaped piezoelectric elements include areas that are most contributive to providing the haptic output. As such, performance between a cross-shaped piezoelectric element and a square-shaped piezoelectric element is largely maintained while saving approximately 4/9 of the material. Although a cross-shaped piezoelectric element is mentioned, the embodiments described herein may have other shapes, such as, for example, a “T” shape, an “X” shape and so on.

Other components of the haptic structure described herein may also be reduced such that additional cost savings are realized. For example, different materials may be used in conjunction with flex circuits that make up the haptic structure. In another embodiment, one or more dimensions of the flex circuits that make up the haptic structure may be reduced.

As briefly described above, the haptic structure may include a piezoelectric material. The piezoelectric material may have any suitable shape including, but not limited to, the cross-shape described above. Two electrodes may be positioned on opposite faces of the piezoelectric material. For example, a top electrode can be formed on a top face of the piezoelectric material and a bottom electrode can be formed on a bottom face of the piezoelectric material.

In some cases, the bottom electrode can wrap around a sidewall of the piezoelectric material. In such a configuration, the top electrode and the bottom electrode both occupy a portion of the top face of the piezoelectric material.

The piezoelectric material and its corresponding electrodes may be coupled to a top flex and a bottom flex. A first electrical connection can be made between the top electrode and the top flex, and a second electrical connection can be made between the bottom electrode and the bottom flex. The first electrical connection may be made from a first material while the second electrical connection is made from a second material. For example, the first electrical connection may be a silver trace while the second electrical connection is a copper trace. In other implementations, the first and second connections may be made from the same material.

The first and second electrical connections can be established using any number of suitable techniques including, but not limited to, soldering, welding, bonding with electrically conductive adhesive, bonding with electrically conductive tape, placing electrically conductive surfaces in contact, and so on.

In some embodiments, the bottom flex may have a width that is less than the top flex. More specifically, in order to decrease costs but maintain reliability, when a copper trace is used with the bottom flex and a silver trace is used with the top flex, the bottom flex may have a width that is less than the top flex.

As used herein, the terms “connected” and “coupled” are generally intended to be construed broadly to cover direct connections and indirect connections. In the context of electrical or circuit operations, the terms “connected” and “coupled” are intended to cover circuits, components, and/or devices that are connected such that an electrical parameter passes from one to another. Example electrical parameters include, but are not limited to, voltages, currents, magnetic fields, control signals, and/or communication signals. Thus, the terms “coupled” and “connected” include circuits, components, and/or devices that are coupled directly together or through one or more intermediate circuits, components, and/or devices.

Additionally, the terms “connected”, “affixed”, “attached”, “over”, “overlying”, and “on” are intended to be construed broadly, and therefore should not be interpreted to preclude the presence of one or more intervening layers or other intervening components or elements. Thus, a given layer or element that is described herein as being a layer overlying another layer or element, a layer/element or positioned on or positioned over another layer/element, may be separated from the latter layer (or element) by one or more additional layers (or elements). Similarly, a given layer or element that is described herein as being attached, affixed, and connected to another layer or element may be separated from the latter layer (or element) by one or more additional layers (or elements).

Directional terminology, such as “top”, “bottom”, “front”, “back”, “leading”, “trailing”, etc., is used with reference to the orientation of the Figure(s) being described. Because components in various embodiments can be positioned in a number of different orientations, the directional terminology is used for purposes of illustration only and is in no way limiting.

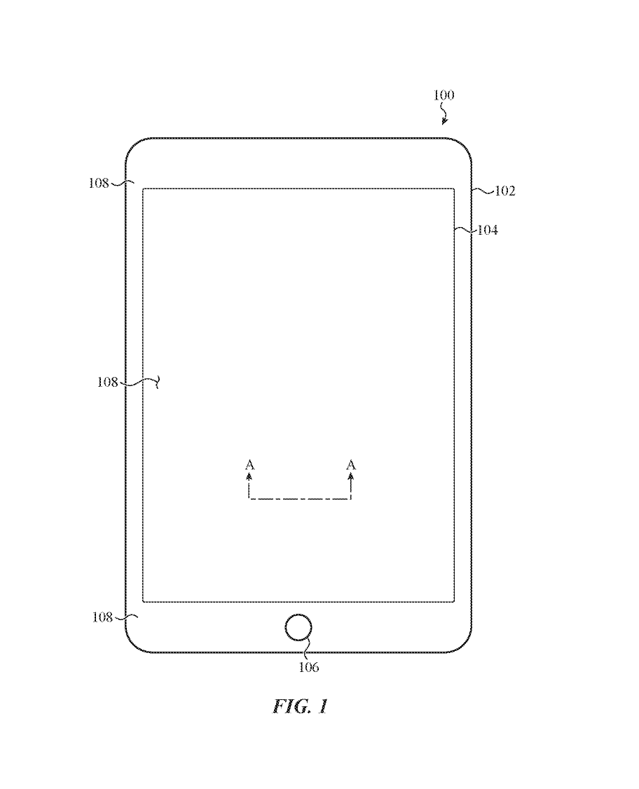

These and other embodiments are discussed below with reference to FIGS. 1-33. However, those skilled in the art will readily appreciate that the detailed description given herein with respect to these Figures is for explanatory purposes only and should not be construed as limiting.

FIG. 1 depicts an example of an electronic device that can provide localized deflection of a surface. In the illustrated embodiment, the electronic device 100 is implemented as a tablet computing device. Other embodiments can implement the electronic device differently. For example, an electronic device can be a smart phone, a laptop computer, a wearable computing device, a digital music player, a kiosk, a stand-alone touch screen display, a mouse, a keyboard, and other types of electronic devices that are configured to provide haptic feedback to a user.

The electronic device 100 includes an enclosure 102 at least partially surrounding a display 104 and one or more input/output (I/O) devices 106. The enclosure 102 can form an outer surface or partial outer surface for the internal components of the electronic device 100. The enclosure 102 can be formed of one or more components operably connected together, such as a front piece and a back piece. Alternatively, the enclosure 102 can be formed of a single piece operably connected to the display 104.

The display 104 can provide a visual output to the user. The display 104 can be implemented with any suitable technology, including, but not limited to, a liquid crystal display (LCD) element, a light emitting diode (LED) element, an organic light-emitting display (OLED) element, an organic electroluminescence (OEL) element, and the like. In some embodiments, the display 104 can function as an input device that allows the user to interact with the electronic device 100. For example, the display 104 can be a multi-touch and/or multi-force sensing touchscreen LED display.

In some embodiments, the I/O device 106 can take the form of a home button, which may be a mechanical button, a soft button (e.g., a button that does not physically move but still accepts inputs), an icon or image on a display, and so on. Further, in some embodiments, the I/O device 106 can be integrated as part of a cover sheet 108 and/or the enclosure 102 of the electronic device 100. Although not shown in FIG. 1, the electronic device 100 can include other types of I/O devices, such as a microphone, a speaker, a camera, a biometric sensor, and one or more ports, such as a network communication port and/or a power cord port.

A cover sheet 108 may be positioned over the front surface (or a portion of the front surface) of the electronic device 100. At least a portion of the cover sheet 108 can function as an input surface that receives touch and/or force inputs. The cover sheet 108 can be formed with any suitable material, such as glass, plastic, sapphire, or combinations thereof. In one embodiment, the cover sheet 108 covers the display 104 and the I/O device 106. Touch and force inputs can be received by the portion of the cover sheet 108 that covers the display 104 and by the portion of the cover sheet 108 that covers the I/O device 106.

In another embodiment, the cover sheet 108 covers the display 104 but not the I/O device 106. Touch and force inputs can be received by the portion of the cover sheet 108 that covers the display 104. In some embodiments, touch and force inputs can be received on other portions of the cover sheet 108, or on the entire cover sheet 108. The I/O device 106 may be disposed in an opening or aperture formed in the cover sheet 108. In some embodiments, the aperture extends through the enclosure 102 and one or more components of the I/O device 106 are positioned in the enclosure.

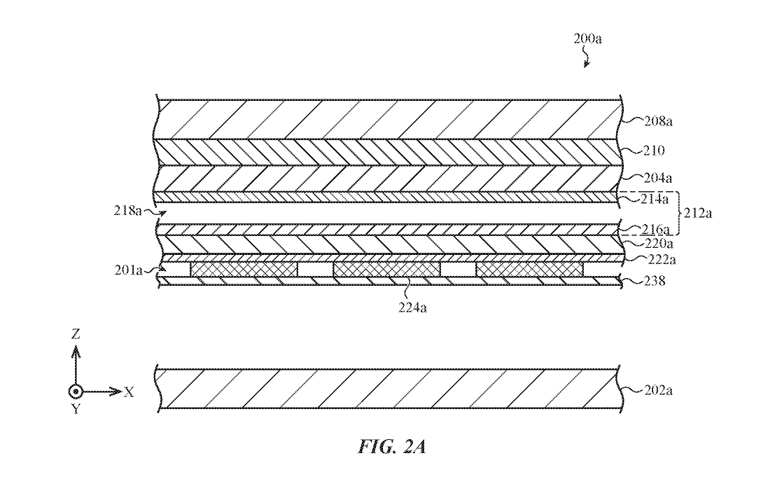

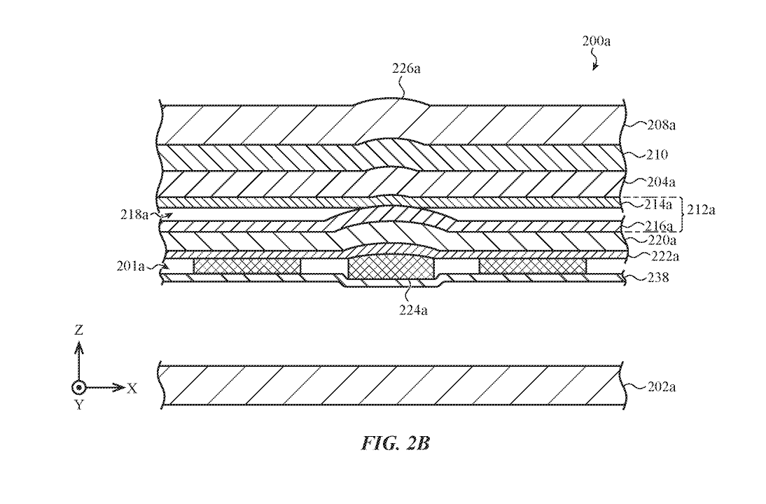

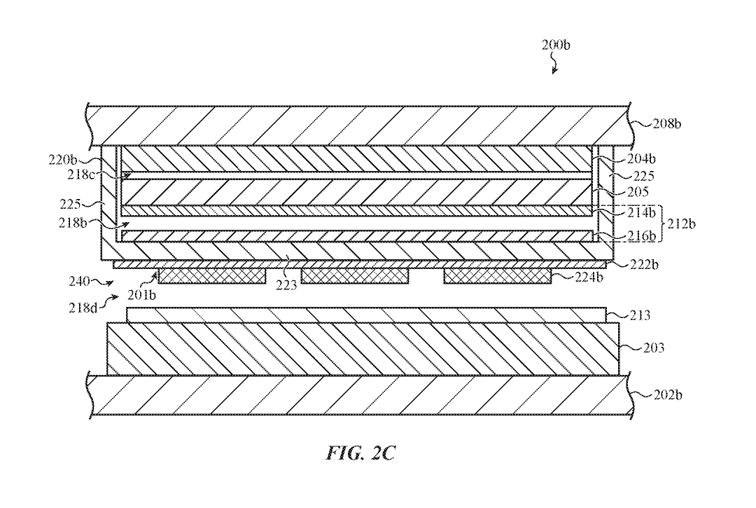

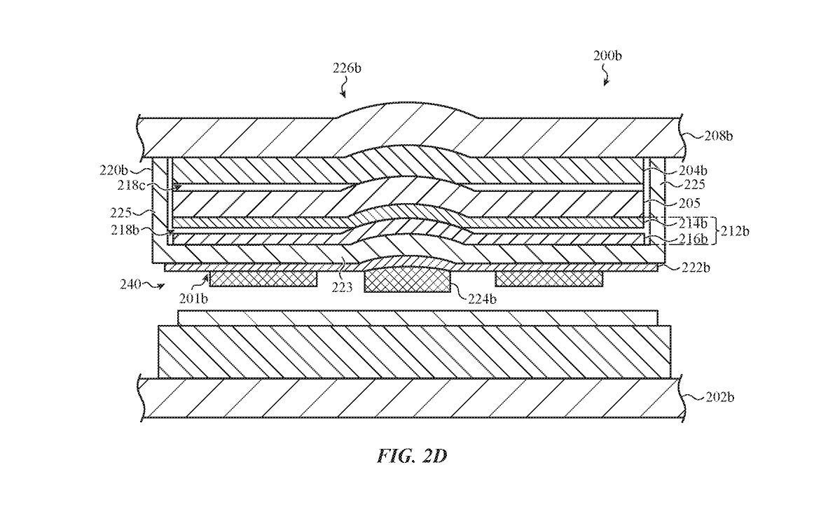

At least one haptic or deflection module (see FIGS. 2A-2D) can be included in the electronic device 100. For example, one or more haptic or deflection modules may be positioned below the cover sheet 108 and/or at least a portion of the enclosure 102. The haptic or deflection modules can be configured to provide localized haptic feedback to a user.

Embodiments are described herein in conjunction with providing haptic output on the cover sheet 108 positioned over the display 104. However, the present invention can be used to deflect or provide haptic output to any suitable surface of an electronic device. For example, the surface can be an input surface of an input device, such as a trackpad, a mouse, and a button. Additionally or alternatively, the surface may be a portion of the enclosure of an electronic device.

FIGS. 2A and 2B depict a cross-sectional view of an example of the electronic device illustrated in FIG. 1, taken along line A-A. FIG. 2A depicts the electronic device 200a when the haptic actuators are not actuated, while FIG. 2B portrays the electronic device 200a when a haptic actuator is actuated. In the illustrated embodiments, a display layer 204a is positioned below the cover sheet 208a. The electronic device 200a may include a touch sensor layer 210 positioned between a display layer 204a and the cover sheet 208a.

The touch sensor layer 210 may include an array of touch sensors that are configured to detect the location of a finger or object on or near the cover sheet 208a. The touch sensors may operate in accordance with a number of different sensing schemes. In some implementations, the touch sensors may operate in accordance with a mutual-capacitance sensing scheme. Under this scheme, the touch sensor layer 210 may include two layers of intersecting transparent traces (e.g., sensing nodes) that are configured to detect the location of a touch by monitoring a change in capacitive or charge coupling between pairs of intersecting traces. In another implementation, the touch sensor layer 210 may operate in accordance with a self-capacitive sensing scheme. Under this scheme, the touch sensor layer 210 may include an array of capacitive electrodes or pads (e.g., sensing nodes) that are configured to detect the location of a touch by monitoring a change in self-capacitance of a small field generated by each electrode. In other implementations, a resistive, inductive, or other sensing scheme could also be used.

The display layer 204a includes the display 104, and may include additional layers such as one or more polarizers, one or more conductive layers, and one or more adhesive layers. In some embodiments, a backlight assembly (not shown) is positioned below the display layer 204a. The display layer 204a, along with the backlight assembly, is used to output images on the display. In other embodiments, the backlight assembly may be omitted.

The electronic device 200a may further include a force sensor layer 212a, which may be positioned below the display layer 204a, and may further be positioned above a support structure 220a. The support structure 220a may be substantially rigid, and may provide support for a circuit layer 222a and one or more haptic actuators 224a. In some embodiments, the support structure 220a may form a chassis to support components of the electronic device 200a, such as the display layer 204a. The support structure 220a may further be positioned above the enclosure 202a. However, the relative position of the various layers described above may change depending on the embodiment. Some layers, such as the touch sensor layer 210 and the force sensor layer 212a, may be omitted in other embodiments. The electronic device 200a may include additional layers and components, such as control circuitry, a processing unit, a battery, etc., which have been omitted from FIGS. 2A and 2B for clarity.

Localized haptic feedback may be provided by means of the one or more haptic actuators 224a coupled to the support structure 220a. The support structure 220a may be made from a rigid material, such as a metal or metal alloy (e.g., stainless steel, aluminum, and so on), plastic, silicone, glass, ceramic, fiber composite, or other suitable materials, or a combination of these materials. The support structure 220a may extend along a length and a width of the display layer 204a, although this is not required. The support structure 220a can have any shape and/or dimensions in other embodiments. In some embodiments, the support structure 220a may be a single structure, while in other embodiments the support structure 220a may be an array of support structures 220a.

The support structure 220a may be coupled to another component of the electronic device 200a. For example, the support structure 220a can be coupled to the cover sheet 208a such that the support structure 220a is suspended from the cover sheet 208a. In other embodiments, the support structure 220a may be coupled to a component other than the cover sheet 208a. For example, the support structure 220a can be attached to the enclosure 202a of the electronic device 200a or to a frame or other support component in the enclosure 202a. For example, the support structure 220a can be attached to a support component positioned below the support structure 220a. In such embodiments, the support structure 220a can include one or more legs that contact the support component and position the support structure 220a below the display layer 204a.

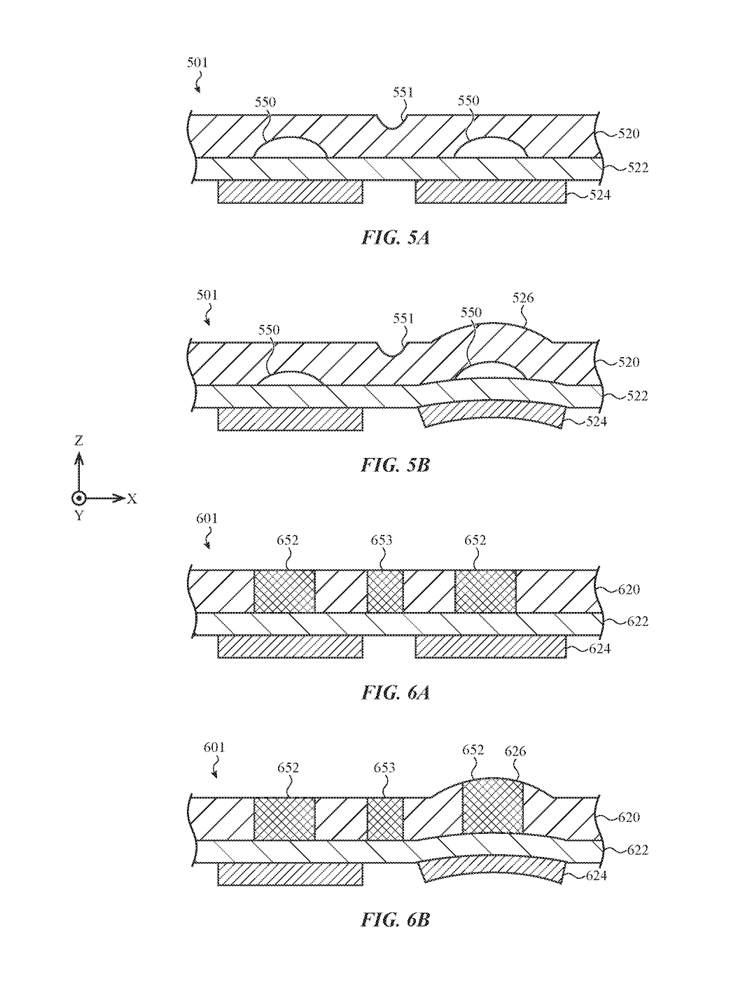

The support structure 220a may further be shaped to amplify the effect of a haptic actuator 224a. Example embodiments of the support structure 220a are further illustrated below with respect to FIGS. 5A-11H. In the illustrated embodiment, the haptic actuators 224a are coupled to a bottom surface of the support structure 220a. However, in other implementations, one or more haptic actuators 224a may be coupled to a top surface and/or a side of the support structure 220a. In yet other implementations, one or more haptic actuators 224a may be coupled to the top surface and/or the bottom surface of the support structure 220a.

In some embodiments, one or more haptic actuators 224a may be affixed or coupled to the support structure 220a through a circuit layer 222a attached to a bottom surface of the support structure 220a. In the illustrated embodiment, each haptic actuator 224a is further attached and electrically connected to the circuit layer 222a. The circuit layer 222a includes signal lines that are electrically connected to the haptic actuators 224a. The signal lines can be used to transmit electrical signals to each haptic actuator 224a to selectively actuate one or more haptic actuators 224a. A ground layer 238 may be attached and electrically connected to a bottom surface of each haptic actuator 224a. The ground layer 238 provides a common reference voltage to the haptic actuators 224a.

In other embodiments, the circuit layer 222a may be omitted and the one or more haptic actuators 224a attached to the support structure 220a. Signal lines or electrical traces may be included in the support structure 220a and electrically connected to the haptic actuators 224a. Additionally or alternatively, signal lines or electrical traces can be formed on at least one surface of the support structure 220a and electrically connected to the haptic actuators 224a. The signal lines can be used to transmit electrical signals to each haptic actuator 224a to selectively actuate one or more haptic actuators 224a.

Any suitable circuit layer 222a and ground layer 238 can be used. For example, in one embodiment the circuit layer 222a and ground layer 238 may be a flexible printed circuit or a flexible printed circuit board. The circuit layer 222a and the ground layer 238 can be made from any number of suitable materials, such as polyimide or polyethylene terephthalate, with conductive traces formed from materials such as copper, silver, aluminum, and so on.

Each haptic actuator 224a can be selectively activated in the embodiment shown in FIGS. 2A and 2B. In particular, the ground layer 238 can provide a common reference voltage to the haptic actuators 224a, while the circuit layer 222a can apply an electrical signal across each individual haptic actuator 224a independently of the other haptic actuators 224a. The haptic output produced by one or more haptic actuators 224a can cause the support structure 220a to deflect or otherwise move. As illustrated in FIG. 2B, when the support structure 220a deflects, it moves into the force sensor layer 212a, causing a corresponding deflection in the force sensor layer 212a. The deflection in the force sensor layer 212a in turn moves into and causes a corresponding deflection in the display layer 204a, the touch sensor layer 210, and the cover sheet 208a. The transmitted deflection causes one or more sections of the cover sheet 208a to deflect or move to provide localized haptic feedback to the user. In particular, the cover sheet 208a bends or deflects at a location 226a that substantially corresponds to the location of the haptic actuator 224a on the support structure 220a.

Any suitable type of haptic actuator can be used. For example, in one embodiment each haptic actuator 224a is a piezoelectric transducer. The piezoelectric transducer may be formed from an appropriate piezoelectric material, such as sodium potassium niobate, lead zirconate titanate (PZT), quartz, and other ceramic or non-ceramic materials. A piezoelectric transducer is actuated with an electrical signal. When activated, the piezoelectric transducer converts the electrical signal into mechanical movement, vibrations, and/or force. The mechanical movement, vibrations, and/or force generated by the actuated haptic actuator is known as haptic output. When the haptic output is applied to a surface, a user can detect or feel the haptic output and perceive the haptic output as haptic feedback.

Different types of haptic actuators 224a can be used in other embodiments. For example, in one embodiment one or more electromagnetic actuators can be disposed on the support structure 220a and used to produce localized deflection of the cover sheet 208a. Alternatively, one or more piston actuators may be disposed on the support structure 220a and used to produce localized deflection of the cover sheet 208a.

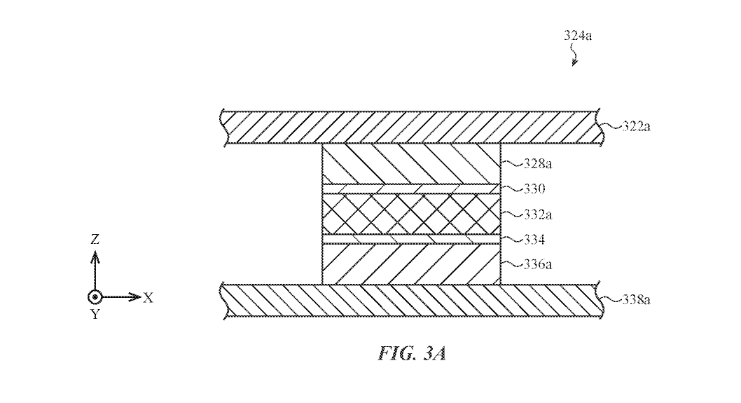

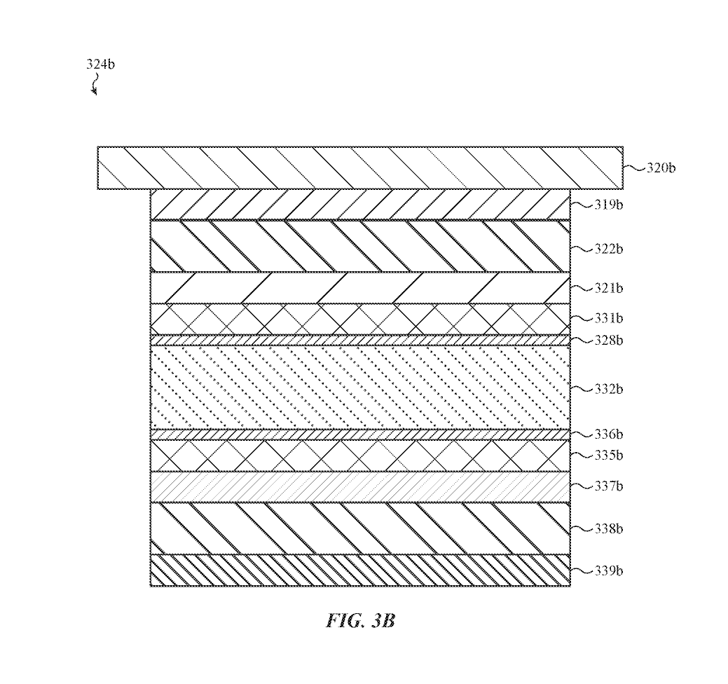

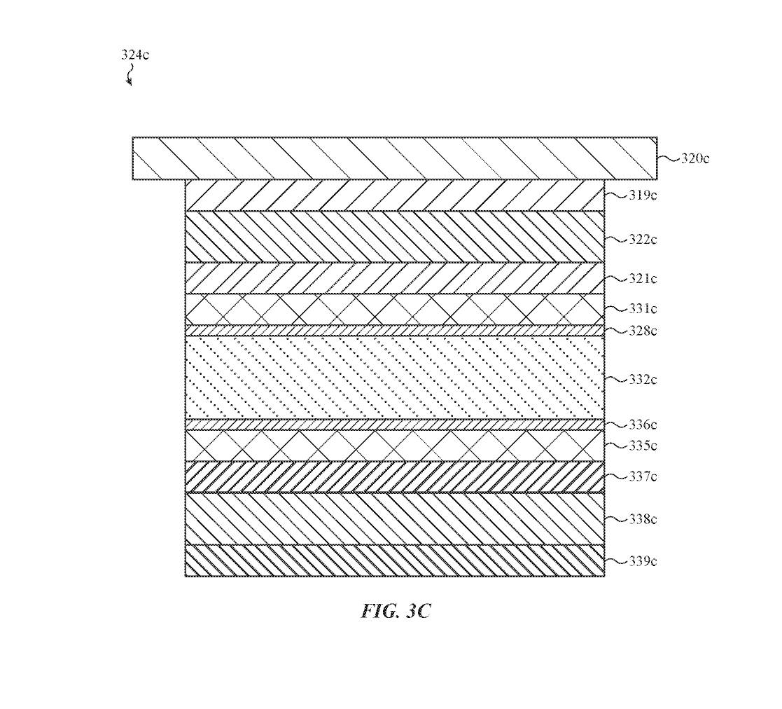

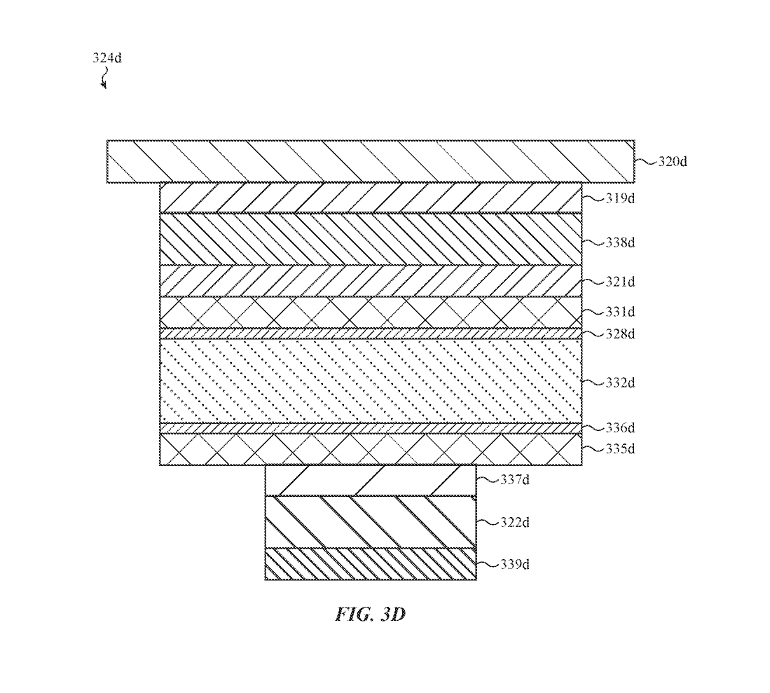

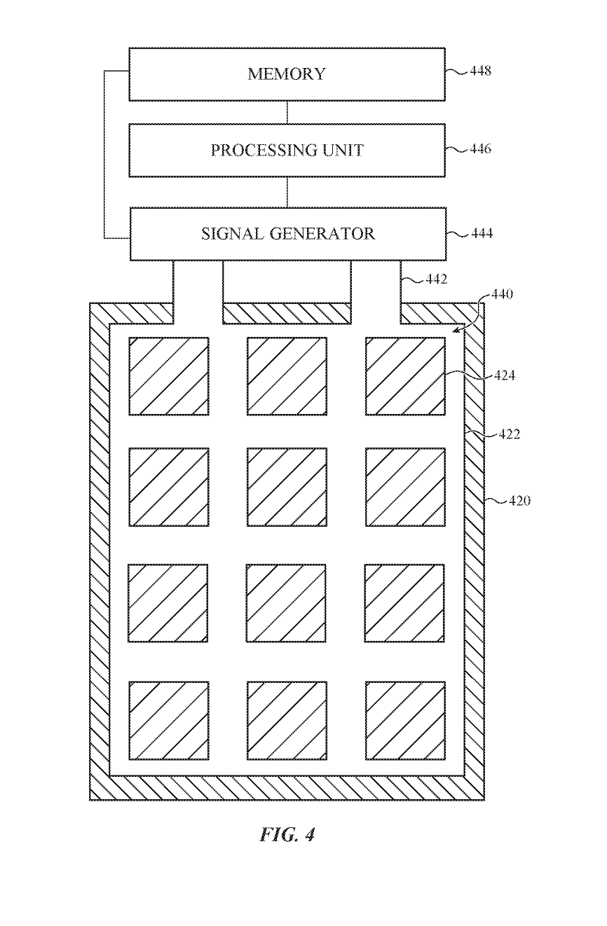

An example haptic actuator 224a and circuit layer 222a are further illustrated below with respect to FIG. 3. An electronic device 200a implementing an array 240 of haptic actuators 224a is depicted below with respect to FIG. 4.

The layer or layers between the cover sheet 208a and the support structure 220a are referred to herein as intermediate layer(s). In the illustrated embodiment, the display layer 204a, the optional touch sensor layer 210, and the optional force sensor layer 212a are intermediate layers.

In the illustrated embodiment, the force sensor layer 212a is formed between the support structure 220a and an intermediate layer (e.g., the display layer 204a). The support structure 220a is positioned to define a gap 218a between the support structure 220a and the display layer 204a. A first force-sensing component 214a and a second force-sensing component 216a may be positioned within the gap 218a. For example, the first force-sensing component 214a can be affixed to the bottom surface of the display layer 204a and the second force-sensing component 216a to the top surface of the support structure 220a. Together, the first and second force-sensing components 214a, 216a form the force sensor layer 212a. The force sensor layer 212a can be used to measure an amount of force that is applied to the cover sheet 208a.

In some implementations, the first force-sensing component 214a represents a first array of electrodes and the second force-sensing component 216a a second array of electrodes. The first and second arrays of electrodes can each include one or more electrodes. Each electrode in the first array of electrodes is aligned in at least one direction (e.g., vertically) with a respective electrode in the second array of electrodes to form an array of capacitive sensors. The capacitive sensors are used to measure a force applied to the cover sheet 208a through measured capacitances or measured changes in capacitances. For example, as the cover sheet 208a deflects in response to a received amount of force, a distance between the electrodes in at least one capacitive sensor changes, which varies the capacitance of that capacitive sensor. Drive and sense circuitry can be operatively (e.g., electrically) connected to each capacitive sensor and configured to sense or measure the capacitance of each capacitive sensor. A processing unit may be operatively (e.g., electrically) connected to the drive and sense circuitry and configured to receive signals representing the measured capacitance of each capacitive sensor. The processing unit can be configured to correlate the measured capacitances into an amount of force.

In other embodiments the force sensor layer 212a can employ a different type of sensor to measure force or the deflection of the first force-sensing component 214a relative to the second force-sensing component 216a. In some representative examples, the force sensor layer 212a can operate with optical displacement sensors, magnetic displacement sensors, or inductive displacement sensors. In other embodiments, the force sensor layer 212a may be formed from a strain-sensitive material, such as a piezoresistive, piezoelectric, or similar material having an electrical property that changes in response to stress, strain, and/or deflection. Example strain-sensitive materials include carbon nanotube materials, graphene-based materials, piezoresistive semiconductors, piezoresistive metals, metal nanowire material, and the like.

In other embodiments, the force sensor layer 212a can be positioned at a different location within the electronic device 200a. For example, the force sensor layer 212a may be positioned between the display layer 204a and the cover sheet 208a. In some embodiments, the force sensor layer 212a may be combined with the touch sensor layer 210 to form a single force- and touch-sensing layer. In further examples, the first and second force-sensing components 214a, 216a may be separated by another layer rather than a gap 218a, such as being separated by the display layer 204a.

In some embodiments, the haptic actuators 224a, the touch sensor layer 210, and/or the force sensor layer 212a may work together to enhance a user's experience. In one non-limiting example, at least one haptic actuator 224a may provide localized haptic or tactile output at a location of a touch in response to a touch input. Alternatively, at least one haptic actuator 224a can provide haptic or tactile output in response to a force input having an amount of force that exceeds a given threshold. Additionally or alternatively, in some implementations, at least one haptic actuator 224a may provide a first type of haptic output or a haptic output at a first location in response to a first amount of detected force, and may provide a second type of haptic output or a haptic output at a second location in response to a second amount of detected force.

In addition to the above, the haptic actuators 224a, the touch sensor layer 210, and/or the force sensor layer 212a may also work in conjunction to determine a location of a received touch input and/or force input. When such a location is determined, actuation of at least one haptic actuator 224a and any associated haptic output may be localized at the determined position.

In another implementation, at least one haptic actuator 224a may provide haptic output in an area surrounding or adjacent the determined location. To achieve this, one or more haptic actuators 224a may be actuated at different times and at different locations to effectively cancel out (or alternatively enhance) the haptic output.

FIG. 2B depicts a cross-sectional view of the electronic device 200a shown in FIG. 2A when a haptic actuator 224a is actuated and produces a localized deflection in the cover sheet 208a. In the illustrated embodiment, the haptic actuator 224a has been activated with an electrical signal. The haptic actuator 224a moves (e.g., contracts) in response to the electrical signal, which causes the support structure 220a to deflect. While being deflected, the support structure 220a, the circuit layer 222a, and the second force-sensing component 216a move into the gap 218a and contact the first force-sensing component 214a. The deflection of the support structure 220a propagates through the first force-sensing component 214a, the display layer 204a, the touch sensor layer 210, and the cover sheet 208a. In response to the transmitted deflection, the cover sheet 208a bends or deflects at a location 226a that substantially corresponds to the location of the haptic actuator 224a on the support structure 220a. The cover sheet 208a around the deflected location 226a is substantially unaffected by the haptic output produced by the haptic actuator 224a. A user can detect the local deflection of the cover sheet 208a and perceive the deflection as localized haptic feedback.

In the embodiments shown in FIGS. 2A and 2B, the haptic actuators 224a, the circuit layer 222a, and the support structure 220a collectively form a haptic or deflection module 201a. In embodiments that omit the circuit layer 222a, the haptic or deflection module 201a includes the haptic actuators 224a and the support structure 220a.

FIGS. 2C and 2D depict a cross-sectional view of another example of the electronic device, taken along line A-A of FIG. 1. FIG. 2C depicts the electronic device 200b when the haptic actuators are not actuated, while FIG. 2D portrays the electronic device 200b when a haptic actuator is actuated. FIGS. 2C and 2D include layers arranged differently from FIGS. 2A and 2B. For example, a display layer 204b is positioned below the cover sheet 208b. The display layer 204b includes the display 104, and may include additional layers such as one or more polarizers, one or more conductive layers, and one or more adhesive layers.

In some embodiments, a backlight assembly 205 is positioned below the display layer 204b. The display layer 204b, along with the backlight assembly 205, is used to output images on the display. A gap 218c may be present between the display layer 204b and the backlight assembly 205. Additionally or alternatively, one or more gaps may exist between the elements or layers in the backlight assembly 205. The backlight assembly 205 may be omitted in other embodiments.

The electronic device 200b can also include a support structure 220b. In the illustrated embodiment, the support structure 220b is a U-shaped support structure that includes a support plate 223 and sides 225 that extend from the support plate 223 to the cover sheet 208b. The support plate 223 is depicted as a substantially horizontal support plate, although this is not required.

The support structure 220b can be made of any suitable material or materials, such as the materials described above with respect to FIG. 2A. Some embodiments can form the support structure 220b, the support plate 223, and/or the sides 225 with a different material or combination of materials (e.g., a metal support plate 223 and plastic or ceramic sides 225). In the illustrated embodiment, the support plate 223 extends along a length and a width of the display layer 204b, although this is not required. The support structure 220b and/or the support plate 223 can have any given shape and/or dimensions in other embodiments.

The sides 225 of the support structure 220b can be connected to the cover sheet 208b such that the support structure 220b is suspended from the cover sheet 208b. In other embodiments, the support structure 220b may be connected to the cover sheet 208b through one or more intermediate layers, or the support structure 220b can be connected to a component other than the cover sheet 208b. For example, the support structure 220b can be attached to an enclosure 202b of the electronic device 200b (e.g., 102 in FIG. 1) or to a frame or other support component in the enclosure 202b. For example, the support structure 220b can be attached to a support component positioned below the support structure 220b. In such embodiments, the sides 225 of the support structure 220b can contact the support component and position the support plate 223 below the display layer 204b (or below the backlight assembly 205 when the backlight assembly 205 is present).

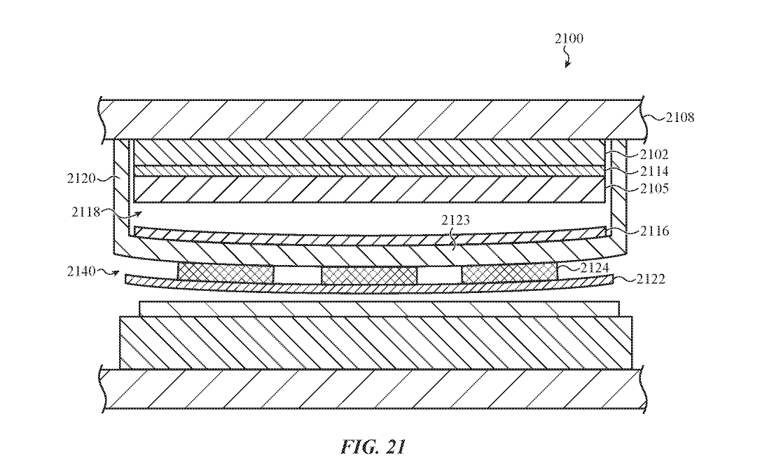

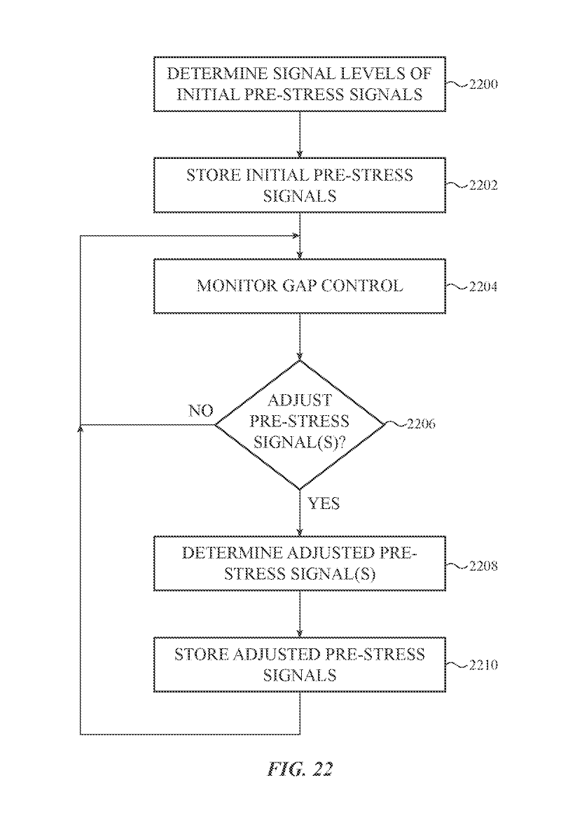

An array 240 of haptic actuators 224b may be affixed, through a circuit layer 222b, to a surface of the support structure 220b (e.g., to the support plate 223). Any suitable circuit layer 222b can be used, such as described above with respect to FIG. 2A. In other embodiments, the circuit layer 222b can be attached to the opposite side of the array 240 of haptic actuators 224b (the side opposite the support plate 223; see FIG. 21). In still other embodiments, the circuit layer 222b may be omitted and signal lines or electrical traces may be included in the support structure 220b and electrically connected to the haptic actuators 224b.

In the illustrated embodiment, the array 240 of haptic actuators 224b is coupled to a bottom surface of the support plate 223. However, in other implementations, one or more haptic actuators 224b may be coupled to a top surface of the support plate 223 and/or to one or more sides 225 of the support structure 220b. In yet other implementations, one or more haptic actuators 224b may be coupled to the top and bottom surfaces of the support plate 223 or to one or more sides 225 as well as to the top and bottom surfaces of the support plate 223. Although the array 240 is depicted with three haptic actuators 224b, other embodiments are not limited to this number. The array 240 can include one or more haptic actuators 224b.

Any suitable type of haptic actuator can be used, such as described above with respect to FIG. 2A. The haptic actuators 224b may similarly be selectively activated in the embodiment shown in FIGS. 2C and 2D. In particular, each individual haptic actuator 224b can receive an electrical signal via the circuit layer 222b independent of the other haptic actuators 224b. The haptic output produced by one or more haptic actuators 224b can cause the support structure 220b to deflect or otherwise move. In the illustrated embodiment, the deflection(s) of the support structure 220b can cause the support plate 223 to move upward such that the deflection transmits through the backlight assembly 205 and the display layer 204b to the cover sheet 208b (see FIG. 2D). The transmitted deflection(s) cause one or more sections of the cover sheet 208b to deflect or move and provide localized haptic output on the surface of the cover sheet 208b. In particular, the cover sheet 208b moves or deflects at a location 226b that substantially corresponds to the location of the haptic actuator(s) 224b on the support structure 220b.

The intermediate layer(s) illustrated in FIGS. 2C and 2D include the display layer 204b, the backlight assembly 205, and the optional force sensor layer 212b. The support structure 220b is constructed and attached to the cover sheet 208b to define a gap 218b between the top surface of the support plate 223 and a bottom surface of the intermediate layer (e.g., the bottom surface of the backlight assembly 205). In some embodiments, a force sensor layer 212b is formed across the gap 218b. The force sensor layer 212b may include a first force-sensing component 214b affixed to the bottom surface of the backlight assembly 205 and a second force-sensing component 216b affixed to the top surface of the support plate 223. The force sensor layer 212b may be similar to the force sensor layer 212a described above with respect to FIG. 2A.

In some embodiments, a battery 203 is positioned below the support structure 220b. The battery 203 provides power to the various components of the electronic device 200b. The battery 203 can be positioned such that a gap 218d is defined between the array 240 of haptic actuators 224b and a top surface of the battery 203. The gap 218d allows the battery 203 to expand due at least in part to heat or temperature.

As shown in FIG. 2C, an additional force sensor 213 can be disposed on a top surface of the battery 203. The additional force sensor 213 may be used to detect a second amount of force. In some embodiments, the amount of force applied to the cover sheet 208b may be sufficient to cause the intermediate layer to deflect such that the first force-sensing component 214b traverses into the gap 218b and contacts the second force-sensing component 216b. When the intermediate layer is deflected to a point where the first force-sensing component 214b contacts the second force-sensing component 216b, the amount of force detected by the force-sensing device reaches a maximum level (e.g., a first amount of force). The force-sensing device cannot detect force amounts that exceed that maximum level. In such embodiments, the additional force sensor 213 can detect the amount of force that exceeds the maximum level of the force-sensing device (e.g., a second amount of force) by associating an amount of deflection between the support plate 223 and the additional force sensor 213. For example, in some embodiments, the additional force sensor 213 represents one or more electrodes that can be used to measure a change in capacitance between the support plate 223 and the additional force sensor 213.

FIG. 2D depicts a cross-sectional view of the electronic device 200b shown in FIG. 2C when a haptic actuator is actuated and produces a localized deflection in the cover sheet 208b. In the illustrated embodiment, the haptic actuator 224b in the array 240 has been activated with an electrical signal. The haptic actuator 224b moves (e.g., contracts) in response to the electrical signal (e.g., a received stimulus), which causes the support structure 220b to deflect. When the support structure 220b deflects, the support plate 223, the circuit layer 222b, the second force-sensing component 216b, and the haptic actuator 224b can move upward toward the cover sheet 208b. In particular, the second force-sensing component 216b and the support plate 223 (and possibly the circuit layer 222b and the haptic actuator 224b) move into the gap 218b and contact the first force-sensing component 214b. The deflection of the support structure 220b propagates through the first force-sensing component 214b and the backlight assembly 205 such that the gap 218c is closed. Once the gap 218c is closed, the deflection propagates through the display layer 204b and the cover sheet 208b. In response to the transmitted deflection, the cover sheet 208b moves or deflects at a location 226b that substantially corresponds to the location of the haptic actuator 224b on the support structure 220b. The cover sheet 208b around the deflected location 226b is substantially unaffected by the haptic output produced by the haptic actuator 224b. A user can detect the local deflection of the cover sheet 208b and perceive the deflection as localized haptic feedback.

The array 240 of haptic actuators 224b, the circuit layer 222b, and the support structure 220b collectively form a deflection module 201b. In embodiments that omit the circuit layer 222b, the deflection module 201b includes the array 240 of haptic actuators 224b and the support structure 220b.

Additionally, in some embodiments, the support structure 220b and/or the support plate 223 can be attached to, or suspended from, the cover sheet 208b, the enclosure 202b (e.g., 102 in FIG. 1), and/or another support component such that haptic output is produced on a different region or surface in the electronic device 200b. In one non-limiting embodiment, the support structure 220b can attach to the enclosure 202b such that haptic output is applied to the bottom surface of the enclosure 202b. In another non-limiting embodiment, the support plate 223 can be included in an I/O device (e.g., a button, a trackpad, or I/O device 106 in FIG. 1) such that haptic output is applied to a surface of the I/O device.

FIGS. 3A-3D illustrate cross-sections of example haptic actuators, including various configurations of layers comprising a haptic actuator. FIG. 3A depicts a first example haptic actuator 324a, in the form of a piezoelectric transducer. The haptic actuator 324a includes a piezoelectric material 332a coupled to a pair of conductive pads 328a, 336a. The piezoelectric material 332a may be formed from a suitable material, such as a ceramic piezoelectric material. Example materials include potassium-based ceramics (e.g., potassium-sodium niobate. potassium niobate), lead-based ceramics (e.g., PZT, lead titanate), quartz, bismuth ferrite, and other suitable piezoelectric materials.

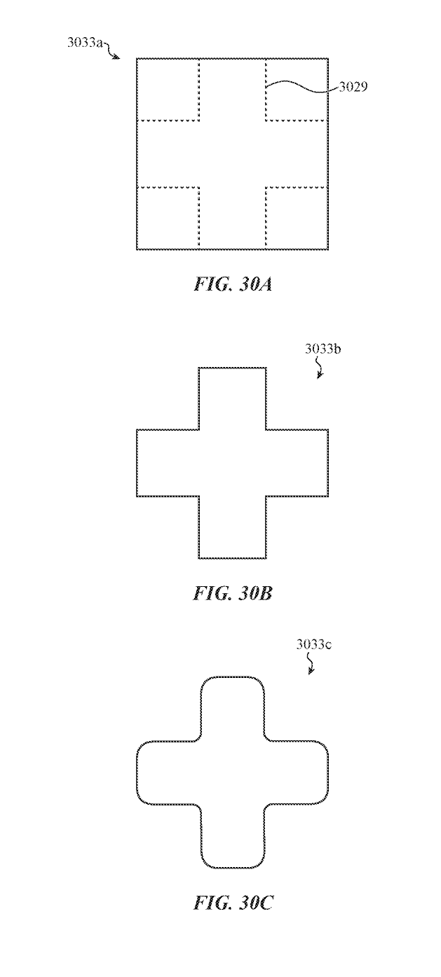

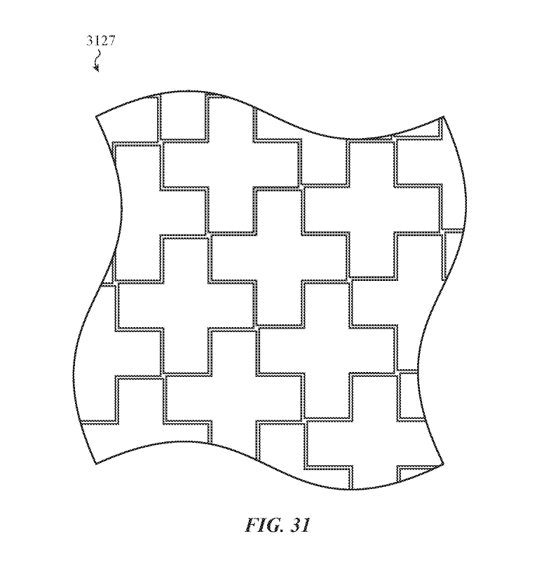

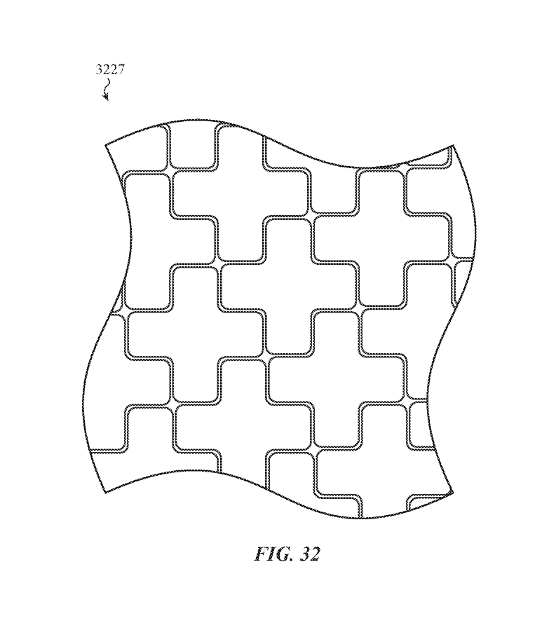

In some embodiments, the piezoelectric material 332a takes a different shape than that depicted. For example, the piezoelectric material 332a may have a cross-shape such as depicted in FIGS. 30B and 30C. In such implementations, the haptic actuator 324b may also have the same or a similar shape. The piezoelectric material 332b may be 3 cm in width and may be approximately 100 μm thick although other dimensions may be used.

When a voltage is applied across the piezoelectric material 332a, the voltage may induce the piezoelectric material 332a to expand or contract in a direction or plane orthogonal to the applied voltage (e.g., the x-y plane). If the piezoelectric material 332a is constrained from moving in the direction orthogonal to the applied voltage (e.g., the x-y plane), it may instead deflect in a direction parallel to the applied voltage (e.g., the z-direction).

For example, returning to FIG. 2B, the haptic actuator 224a may be affixed to the support structure 220a, constraining the movement of the piezoelectric material 332a in the x-y plane. Accordingly, when a voltage is applied, the piezoelectric material 332a of the haptic actuator 224a moves in the z-direction. This is depicted in further detail with respect to FIGS. 5A-11H below.

To apply a voltage across the piezoelectric material 332a, it may be coupled to a first conductive pad 328a (e.g., a top electrode) and a second conductive pad 336a (e.g., a bottom electrode). The conductive pads 328a, 336a may be formed from a suitable conductive material, such as metals (e.g., copper, aluminum, gold, silver), polyethyleneioxythiophene (PEDOT), indium tin oxide (ITO), graphene, piezoresistive semiconductor materials, piezoresistive metal materials, and the like. The first conductive pad 328a may be formed from the same material as the second conductive pad 336a, while in other embodiments the conductive pads 328a, 336a may be formed from different materials.

The conductive pads 328a, 336a may be coupled to the piezoelectric material 332a through a first adhesive layer 330 and a second adhesive layer 334. The adhesive layers 330, 334 may be any adhesive or bonding agent suitable for promoting adhesion between the conductive pads 328a, 336a and the piezoelectric material 332a. In some embodiments, the adhesive layers 330, 334 may be formed from a pressure-sensitive adhesive. The first adhesive layer 330 may be made from the same adhesive as the second adhesive layer 334, while in other embodiments the two layers 330, 334 may be made from different adhesives.

The first conductive pad 328a may provide an active voltage, while the second conductive pad 336a may serve as a reference or ground. The first conductive pad 328a may be activated through an electrical signal from the connected circuit layer 322a. The second conductive pad 336a may be connected to the ground layer 338a as a reference. In other embodiments, the roles of the first conductive pad 328a and second conductive pad 336a may be reversed.

In some embodiments, the conductive pads 328a, 336a may be formed or deposited directly on the piezoelectric material 332a. The conductive pads 328a, 336a may be formed using a suitable disposition technique such as, but not limited to: vapor deposition, sputtering, plating, printing, roll-to-roll processing, gravure, pick and place, adhesive, mask-and-etch, and so on. In further embodiments, the conductive pads 328a, 336a may be electrically coupled to the circuit layer 322a by an adhesive layer, such as an isotropic or anisotropic conductive film.

FIG. 3B depicts a second example haptic actuator 324b, which may be a piezoelectric transducer. The haptic actuator 324b includes a sheet of piezoelectric material 332b. Two electrodes are provided on opposite faces of the piezoelectric material 332b. For example, a first conductive pad 328b (e.g., a top electrode) can be formed on a top face of the piezoelectric material 332b and a second conductive pad 336b (e.g., a bottom electrode) can be formed on a bottom face of the piezoelectric material 332b.

The first conductive pad 328b and the second conductive pad 336b can be formed in any number of suitable ways. In one embodiment, the first conductive pad 328b and the second conductive pad 336b are thin-film layers formed by sputtering, physical vapor deposition, printing, or any other suitable technique. The first conductive pad 328b and the second conductive pad 336b are typically formed from metal or a metal alloy such as silver, silver ink, copper, copper-nickel alloy, and so on. In other embodiments, other conductive materials can be used.

The haptic actuator 324b may also include a first bonding material 331b provided on the first conductive pad 328b and a second bonding material 335b provided on the second conductive pad 336b. The bonding material may be used to couple two flexible circuits to the haptic actuator 324b. For example, the haptic actuator 324b may include a circuit layer 322b and a ground layer 338b.

In particular, the first conductive pad 328b forms a first electrical connection, via the first bonding material 331b, with a top electrical contact 321b that extends from a circuit layer 322b. In some embodiments, the top electrical contact 321b is a drive trace for the haptic actuator 324b. Similarly, the second conductive pad 336b forms a second electrical connection, via a second bonding material 335b, with a bottom electrical contact 337b that extends from a ground layer 338b. In some embodiments, the bottom electrical contact 337b is a ground trace for the haptic actuator 324b. In other embodiments, the ground layer 338b may be above the piezoelectric material 332b and the circuit layer 322b may be below the piezoelectric material 332b.

The first bonding material 331b and second bonding material 335b can be formed from any suitable electrically conductive material or combination of materials such as, but not limited to: electrically conductive adhesive, electrically conductive tape or film (isotropic or anisotropic), solder, and so on. In other cases, one or both of the first bonding material 331b and the second bonding material 335b may be nonconductive. In these examples, the piezoelectric material 332b can be driven capacitively.

The circuit layer 322b and the ground layer 338b can be made from any number of suitable materials, such as described above with respect to FIG. 2. In this particular embodiment the circuit layer 322b and the ground layer 338b are formed from a nonconductive material such as, for example, polyimide. The electrical contacts 321b, 337b are made of copper although other materials may be used.

In this particular embodiment, the top electrical contact 321b and the bottom electrical contact 337b are formed from copper. Although copper is specifically mentioned, the top electrical contact 321b and the bottom electrical contact 337b may be formed from silver or any other metal or electrically conductive materials.

The haptic actuator 324b also includes shield 339b positioned adjacent the ground layer 338b. The shield 339b acts to reduce or eliminate electromagnetic interference between the components of the haptic actuator 324b. In the illustrated embodiment, the shield 339b is made from copper, although other materials may be used.

In some embodiments, the haptic actuator 324b may also include a stiffener, such as a support structure 320b. The support structure 320b may be used to enhance the haptic output as the haptic actuator 324b deflects. The support structure 320b is coupled to the circuit layer 322b using an adhesive layer 319b. In some cases, the adhesive layer 319b is a nonconductive bonding material such as an adhesive, a tape, a film and so on.

In the embodiment illustrated in FIG. 3B, copper and polyimide are used with the flexible circuits due to the high reliability of these materials. However, the cost of these materials may be prohibitive. Accordingly, FIG. 3C illustrates a cross-section of a third example haptic actuator 324c. The haptic actuator 324c includes similar components to the haptic actuator 324b described above. For example, the haptic actuator 324c includes a piezoelectric material 332c, a first conductive pad 328c (e.g., a top electrode) on a top face of the piezoelectric material 332c and a second conductive pad 336c (e.g., a bottom electrode) on a bottom face of the piezoelectric material 332c.

The haptic actuator 324c also includes a circuit layer 322c and a ground layer 338c. The first conductive pad 328c forms a first electrical connection, via the first bonding material 331c, with a top electrical contact 321c that extends from the circuit layer 322c. Similarly, the second conductive pad 336c forms a second electrical connection, via a second bonding material 335c, with a bottom electrical contact 337c that extends from a ground layer 338c.

In this particular implementation, the circuit layer 322c and the ground layer 338c may be made from any nonconductive material, such as, for example, polyethylene terephthalate (PET). The electrical contacts 321c, 337c are made of silver although other materials may be used.

The haptic actuator 324c also includes a shield 339c coupled or otherwise adjacent the ground layer 338c. In this embodiment, the shield 339c may be made from silver although other materials may be used. The haptic actuator 324c also includes a support structure 320c coupled to the circuit layer 322c via an adhesive layer 319c. Each of these components may function in a similar manner described above.

The haptic actuator 324c may be cheaper to produce than the haptic actuator 324b described above with respect to FIG. 3B due to the difference in the cost of materials. However, the flexible circuits made from silver and PET may be less reliable than the flexible circuits made from copper and polyimide. For example, the flexible circuits made from silver and PET may exhibit electrochemical migration or other undesirable effects when used in a high voltage application.

FIG. 3D depicts a cross-section view of a fourth example haptic actuator 324d. The haptic actuator 324d is a hybrid haptic structure that incorporates components from the haptic actuator 324b of FIG. 3B and the haptic actuator 324c of FIG. 3C to balance cost and reliability.

The haptic actuator 324d includes a piezoelectric material 332d, a first conductive pad 328d on a top face of the piezoelectric material 332d, and a second conductive pad 336d on a bottom face of the piezoelectric material 332d.

The haptic actuator 324d also includes a circuit layer 322d and a ground layer 338d. The first conductive pad 328d forms a first electrical connection, via the first bonding material 331d, with a top electrical contact 321d that extends from the ground layer 338d. Similarly, the second conductive pad 336d forms a second electrical connection, via a second bonding material 335d, with a bottom electrical contact 337d that extends from a circuit layer 322d.

In this embodiment, the ground layer 338d is PET or other such nonconductive material and the top electrical contact 321d is a silver drive trace. The circuit layer 322d is polyimide or other such nonconductive material and the bottom electrical contact 337d is a copper ground trace.

A shield 339d may be positioned adjacent the circuit layer 322d. In some embodiments, the shield may be made of copper, silver or any other material that reduces or eliminates interference. As with the other embodiments described herein, the haptic actuator 324d may also include a support structure 320d coupled to the circuit layer 322d using an adhesive layer 319d.

As shown in FIG. 3D, the circuit layer 322d, bottom electrical contact 337d, and shield 339d may have a width that is less than a width of the remainder of the haptic actuator 324d. The decrease in width reduces the cost of producing the haptic actuator 324d while maintaining reliability. In addition, the reduction in width may improve actuation performance as there is less material constraining the deflection of the piezoelectric material 332d.

Further, since silver is used as the top electrical contact 321d and functions as the ground trace and only a positive voltage is applied to the bottom electrical contact 337d, electrochemical migration of the top electrical contact 321d is less likely due to the outgoing electric field direction.

Although the decrease in width of the drive flexible circuit is shown with respect to FIG. 3C, the drive flex of any of the other embodiments may also be reduced in a similar manner. However, in order to prevent the haptic actuator 324d and, more specifically, the piezoelectric material 332d from breaking or cracking, the surface area of the piezoelectric material 332d may be supported by the ground layer 338d.

The haptic actuators 324a-324d depicted in FIGS. 3A-3D may be one of an array of haptic actuators, as depicted below with respect to FIG. 4. The circuit layer 322a-322d may be common to more than one haptic actuator 324a-324d, and in some embodiments the circuit layer 322a-322d may be common to all haptic actuators 324a-324d. Each individual haptic actuator 324a-324d can receive an electrical signal via the circuit layer 322a-322d independent of the other haptic actuators 324a-324d. This may provide localized haptic feedback as depicted in FIGS. 2B and 2D.

In some embodiments, the ground layer 338a-338d may additionally or alternatively be common to multiple or all haptic actuators 324a-324d. The ground layer 338a-338d may provide a common reference voltage to all haptic actuators 324a-324d within the array. For clarity, the ground layer 338a-338d is omitted from FIGS. 2C, 2D, 4-13C, and 17-21.

FIG. 4 depicts a plan view of one example of the deflection module shown in FIGS. 2A-2D, as viewed from below. Although the array 440 of haptic actuators 424 is shown as having twelve haptic actuators, other embodiments are not limited to this configuration. The array 440 of haptic actuators 424 can include one or more haptic actuators 424 in still other embodiments. Each haptic actuator 424 is depicted in a square shape. In some embodiments the haptic actuators 424 may have any given shape, such as a round, rectangular, triangular, or other geometric shape (including non-regular geometric shapes).

The haptic actuators 424 are attached and electrically connected to the circuit layer 422. The circuit layer 422 may correspond to the circuit layer 322a-322d of FIGS. 3A-3D, and may be configured to provide electrical signals to each individual haptic actuator 424 to selectively actuate one or more haptic actuators 424 concurrently, with some overlap in time, or sequentially. Any suitable attachment method can be used to affix the haptic actuators 424 to the circuit layer 422. For example, in one embodiment an adhesive is used to attach the haptic actuators 424 to the circuit layer 422.

Similarly, the circuit layer 422 is attached to the support structure 420 using any suitable attachment method. In one non-limiting embodiment, an adhesive is used to attach the circuit layer 422 to the support structure 420, which may be a pressure-sensitive adhesive.

The circuit layer 422 may be operatively (e.g., electrically) connected to a signal generator 444 through one or more circuit layer extensions 442. The one or more circuit layer extensions 442 transmit electrical signals from the signal generator 444 to respective conductors or traces in the circuit layer 422. The signal lines or electrical traces in the circuit layer 422 transmit one or more electrical signals to at least one haptic actuator 424. A ground layer (not shown), which may correspond to the ground layer 338a-338d of FIGS. 3A-3D, may also be attached to each haptic actuator 424. The transmitted signal may apply a voltage to the haptic actuator 424 and actuate the haptic actuator 424. In other embodiments, the signal generator 444 is operatively connected to the circuit layer 422 through contact pads or wires instead of through the one or more circuit layer extensions 442.

A processing unit 446 is operatively (e.g., electrically) connected to the signal generator 444. The processing unit 446 is configured to control the generation of the electrical signals for the array 440 of haptic actuators 424. The processing unit 446 can be implemented as any electronic device capable of processing, receiving, or transmitting data or instructions. For example, the processing unit 446 can be a microprocessor, a central processing unit (CPU), an application-specific integrated circuit (ASIC), a digital signal processor (DSP), or combinations of multiple such devices. As described herein, the term “processing unit” is meant to encompass a single processor or processing unit, multiple processors, multiple processing units, or other suitably configured computing element or elements.

In some embodiments, a memory 448 can be operatively (e.g., electrically) connected to the processing unit 446 and/or to the signal generator 444. The memory 448 can be configured as any type of memory. By way of example only, memory 448 can be implemented as random access memory, read-only memory, Flash memory, removable memory, or other types of storage elements, in any combination.

The memory 448 can store electronic data that can be used by the signal generator 444. For example, the memory 448 can store electrical data or content, such as timing signals, algorithms, and one or more different electrical signal characteristics that the signal generator 444 can use to produce one or more electrical signals. The electrical signal characteristics include, but are not limited to, an amplitude, a phase, a frequency, and/or a timing of an electrical signal. The processing unit 446 can cause the one or more electrical signal characteristics to be transmitted to the signal generator 444. In response to the receipt of the electrical signal characteristic(s), the signal generator 444 can produce an electrical signal that corresponds to the received electrical signal characteristic(s).

In some embodiments, each haptic actuator 424 can produce different types of haptic output based on the signal characteristic(s) of the electrical signal (e.g., the stimulus) that is used to actuate the haptic actuator 424. For example, a haptic actuator 424 can generate haptic output that varies in magnitude and/or frequency based on the particular signal characteristics of the electrical signal used to activate the haptic actuator 424.

The support structure 420 may be formed from a rigid material which can impact the actuation performance (e.g., the energy creation) of a haptic actuator 424 and the effectiveness of the transmission of that energy from the back of one or more intermediate layers to the surface of the cover sheet. For example, in some situations, the magnitude of the haptic output (e.g., the amount of energy) produced by a haptic actuator 424 may be limited or reduced by the size of the support structure 420. When one or more haptic actuators 424 are activated, the material in the support structure 420 around the activated haptic actuator(s) 424 (in all directions of the x-y plane) is pulled in to deflect the support structure 420. With a larger-sized support structure 420, the amount of material around the haptic actuator(s) 424 can be considerable, which limits the amount of material the one or more haptic actuators 424 can pull in during actuation. Consequently, the magnitude of the haptic output produced by the haptic actuator(s) 424 may be reduced, which decreases the magnitude of the haptic feedback to the user.

To overcome any reduction in the haptic output produced by a haptic actuator 424, the support structure may be shaped to instead amplify the output of the haptic actuator 424. Section I, FIGS. 5A-11H depict embodiments of the support structure which are shaped or designed to amplify the output of the haptic actuator 424.

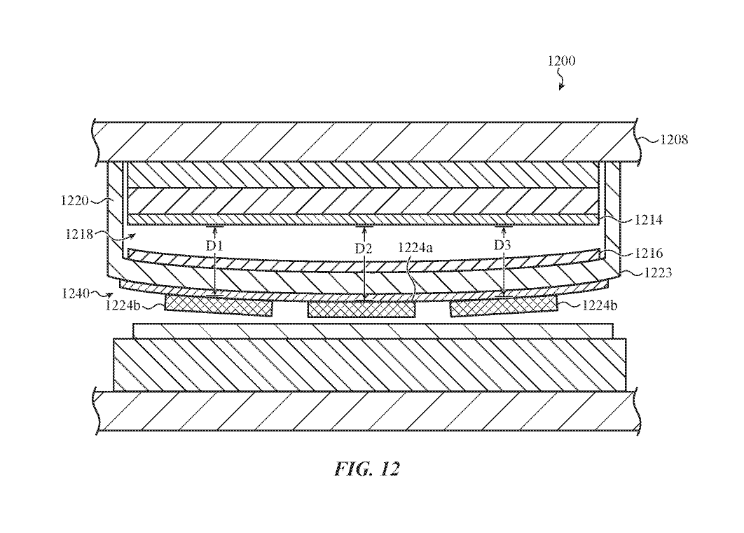

In some embodiments, the signal generator 444 may be configured to provide pre-stress signals to pre-stress one or more haptic actuators 424. The processing unit 446 may be configured to control the generation of the pre-stress and actuation signals by the signal generator 444. Section II, FIGS. 12-23 depict embodiments in which the haptic actuators 424 may be pre-stressed to increase actuator performance.

In some embodiments, the haptic actuators 424 may be attached to the support structure in a manner to relieve strain. Strain relief may increase the deflection of the support structure 420 and consequently increase the deflection at a cover sheet of the electronic device. Section III, FIGS. 24-28 depict embodiments in which the support structure 420 may include strain relief to increase deflection.

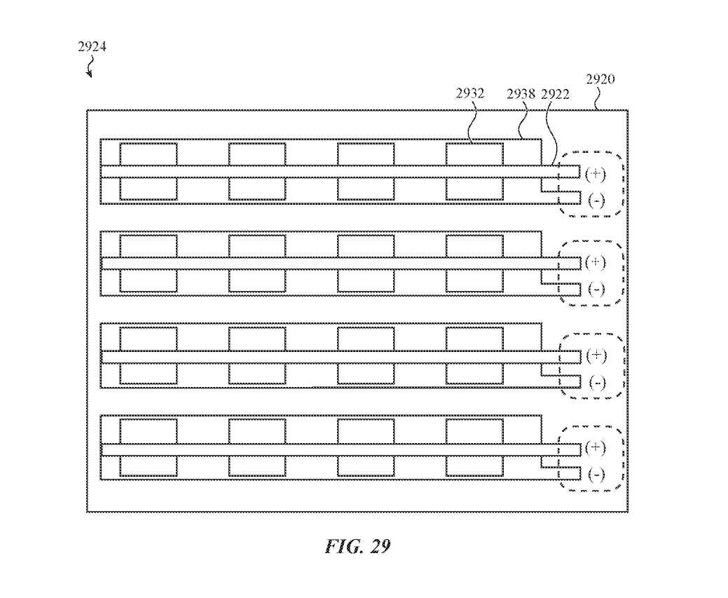

In some embodiments, the piezoelectric material of the haptic actuators 424 may be shaped to reduce cost and increase haptic performance. Section IV, FIGS. 29-32 depict embodiments in which the piezoelectric material has a different shape, such as a cross shape.

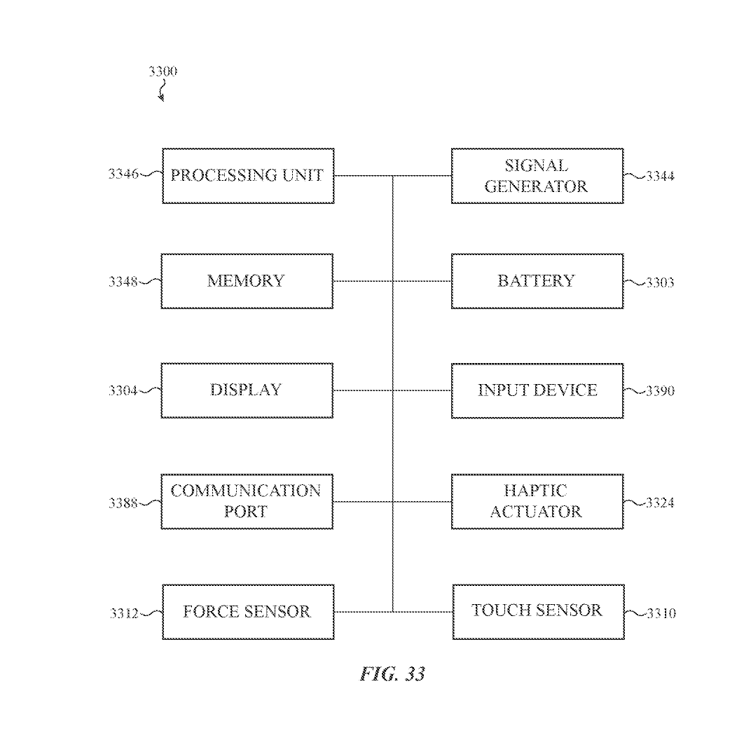

A system diagram of additional components which may be included in an electronic device according to the present invention are depicted in Section V, FIG. 33.

### I. Support Structures for Haptic Output Amplification

FIGS. 5A and 5B depict an example of a first deflection module 501 having a support structure 520 shaped to amplify the output of a haptic actuator 524. FIG. 5A depicts the deflection module 501 when the haptic actuators 524 are not actuated, while FIG. 5B portrays the deflection module 501 when a haptic actuator 524 is actuated. The deflection module 501 includes a haptic actuator 524 coupled to a circuit layer 522. The haptic actuator 524 may be similar to the haptic actuator 324 depicted in FIG. 3, and the circuit layer 522 may be similar to the circuit layer 322a-322d depicted in FIGS. 3A-3D. Other components of the haptic actuator 324 depicted in FIGS. 3A-3D, such as the ground layer 338a-338d, have been omitted from FIGS. 5A and 5B for clarity. The circuit layer 522 may be coupled to a geometrically tuned support structure 520.

The support structure 520 is geometrically tuned to amplify the output of a haptic actuator 524. The support structure 520 may include one or more cavities 550 in a surface of the support structure 520 adjacent each haptic actuator 524. In one embodiment, a cavity 550 may be substantially centrally positioned over each haptic actuator 524. The cavity 550 may amplify the output of a haptic actuator 524 by reducing the thickness of the support structure 520 directly above the haptic actuator 524, which in turn increases the flexibility of the support structure 520 such that it is more responsive to deflection at a location 526 directly above the haptic actuator 524. In the illustrated embodiment, a cavity 550 is formed in the bottom surface of the support structure 520 above each haptic actuator 524. In other embodiments, one or more cavities 550 may be formed in the bottom and/or top surface of the support structure 520.

Each cavity 550 may span a portion of a dimension (e.g., width and/or length) of the corresponding haptic actuator 524. As depicted, the cavity 550 may be substantially hemispherically shaped. However, in other embodiments the cavity 550 may be shaped as a semi-cylinder, a pyramid, a rectangular cavity, or another suitable geometric shape, including a non-regular shape. The cavity 550 may be formed within the support structure 520 by a suitable technique, such as molding, cutting, etching, etc.

Each haptic actuator 524 may be affixed to a portion of the support structure 520 (e.g., via the circuit layer 522) toward one or more edges of the haptic actuator 524. This may impose a boundary condition on the haptic actuator 524. When the haptic actuator 524 is actuated, as depicted in FIG. 5B, the haptic actuator 524 may compress in all directions of the x-y plane. As the haptic actuator 524 is affixed to the support structure 520 surrounding the cavity 550, the compression of the haptic actuator 524 may cause a similar compression in the support structure 520. This may cause the support structure 520 in turn to deflect in the z-direction at the location 526 directly above the haptic actuator 524.

The cavity 550 may cause an amplified deflection at the location 526 by making the support structure 520 thinner (and consequently more flexible) and/or by allowing greater compression of the support structure 520 across the cavity 550. The amplified deflection at the location 526 directly above the haptic actuator 524 may in turn cause an amplified haptic effect at a corresponding location of the surface (e.g., the cover sheet 108 in FIG. 1) of the electronic device.

The support structure 520 may in some embodiments further include a relief 551 in the top surface of the support structure 520 (e.g., the side opposite the cavity 550). The relief 551 may be positioned between a pair of cavities 550, and in some embodiments a relief 551 may be positioned between adjacent cavities 550 in an array of cavities 550 corresponding to an array of haptic actuators 524. The relief 551 may be shaped as a rounded channel or slot (e.g. semi-cylinder) formed in the surface of the support structure 520. The relief 551 may run substantially along a dimension (e.g., width) of the cavity 550. In other embodiments the relief 551 may be shaped as a hemisphere, a pyramid, a rectangular trench, or another suitable geometric shape, including a non-regular shape. In still other embodiments, one or more reliefs 551 may be formed in the top and/or bottom surface of the support structure 520. The relief 551 may be formed within the support structure 520 by a suitable technique, such as molding, cutting, etching, etc.

The relief 551 may isolate the portion of the support structure 520 above one haptic actuator 524 from the haptic response of another haptic actuator 524. The relief 551 may additionally or alternatively assist to amplify the haptic response of a haptic actuator 524 by adding flexibility to the support structure 520 and/or relieving tension in the bulk portion of the support structure 520 caused by the compression at the cavity 550.

FIGS. 6A and 6B depict an example of a second deflection module 601 having a support structure 620 shaped to amplify the output of a haptic actuator 624. FIG. 6A depicts the deflection module 601 when the haptic actuators 624 are not actuated, while FIG. 6B portrays the deflection module 601 when a haptic actuator 624 is actuated. Similar to the example in FIGS. 5A and 5B, the deflection module 601 includes a haptic actuator 624 coupled to a circuit layer 622. The circuit layer 622 may be coupled to a materially tuned support structure 620.

The support structure 620 is materially tuned to amplify the output of a haptic actuator 624. Portions of the support structure 620 may be formed from distinct materials bonded together. For example, a force concentration region 652 may be formed from a material having a lower Young's Modulus of Elasticity (E) compared to surrounding materials. A force concentration region 652 may be positioned above each haptic actuator 624 and may amplify the output of the haptic actuator 624 by increasing the flexibility of the support structure 620 at a location 626 directly above the haptic actuator 624.

As described above, the force concentration region 652 is formed from a material with a lower E than the surrounding material of the support structure 620. For example, the surrounding material may be formed from a stiff metal (e.g., steel), while the force concentration region 652 is formed from a more elastic metal (e.g., aluminum). In other embodiments, different materials and combinations of materials may be used, including metals, plastics, ceramics, glass, etc. The material of the force concentration region 652 may be bonded to the surrounding support structure 620 material by a suitable technique. For example, the force concentration region 652 may be fused, welded, molded, or otherwise adhered to the surrounding material.

Each force concentration region 652 may span a portion of a dimension (e.g., width, length) of the corresponding haptic actuator 624. As depicted, the force concentration region 652 may comprise the entire height of the support structure 620. In other embodiments, the force concentration region 652 may only comprise a portion of the height (e.g., filling a cavity formed within the support structure 620), or the force concentration region 652 may be comprised of multiple layers of lower and higher E materials. In still other embodiments, more than one force concentration region 652 may be positioned above each haptic actuator 624.

Each haptic actuator 624 may be affixed to the support structure 620 (e.g., via the circuit layer 622) along substantially the entire width and/or length of the haptic actuator 624. This may impose a boundary condition on the haptic actuator 624. When the haptic actuator 624 is actuated, as depicted in FIG. 6B, the haptic actuator 624 may compress in all directions of the x-y plane. As the haptic actuator 624 is affixed to the support structure 620, the haptic actuator 624 may compress primarily along the bottom of the haptic actuator 624, causing the haptic actuator 624 to deflect in the z-direction. This may cause an amplified deflection in the support structure 620 at the location 626 directly above the haptic actuator 624.

The force concentration region 652 may cause an amplified deflection by making the support structure 620 more flexible at the location 626 directly above each haptic actuator 624 and/or by allowing greater compression of the support structure 620 across the force concentration region 652 to result in a higher z-deflection. The amplified deflection at the location 626 directly above the haptic actuator 624 may in turn cause an amplified haptic effect at a corresponding location of the surface (e.g., cover sheet 108 in FIG. 1) of the electronic device.

The support structure 620 may in some embodiments further include a relief region 653 between a pair of force concentration regions 652, and in some embodiments a relief region 653 may be positioned between adjacent force concentration regions 652 in an array of force concentration regions 652 corresponding to an array of haptic actuators 624. The relief region 653 is formed from a material with a lower Young's Modulus E than the surrounding material of the support structure 620 (e.g., the same or a different material than the force concentration region 652). For example, the surrounding material may be formed from a stiff metal (e.g., steel), while the relief region 653 is formed from a more elastic metal (e.g., aluminum). In other embodiments, different materials and combinations of materials may be used, including metals, plastics, ceramics, glass, etc. The material of the relief region 653 may be bonded to the surrounding support structure 620 material by a suitable technique (e.g., the same or a different technique than the force concentration region 652). For example, the relief region 653 may be fused, welded, molded, or otherwise adhered to the surrounding material.

As depicted, the relief region 653 may comprise the entire height of the support structure 620. In other embodiments, the relief region 653 may only comprise a portion of the height (e.g., filling a relief formed within the support structure 620 on an opposite side from the haptic actuator 624), or the relief region 653 may be comprised of multiple layers of lower and higher E materials. In still other embodiments, more than one relief region 653 may be positioned above each haptic actuator 624.

The relief region 653 may isolate a portion of the support structure 620 above one haptic actuator 624 from the haptic response of another haptic actuator 624. The relief region 653 may additionally or alternatively assist to amplify the haptic response of a haptic actuator 624 by adding flexibility to the support structure 620 and/or relieving tension in the portion of the support structure 620 surrounding the force concentration region 652.

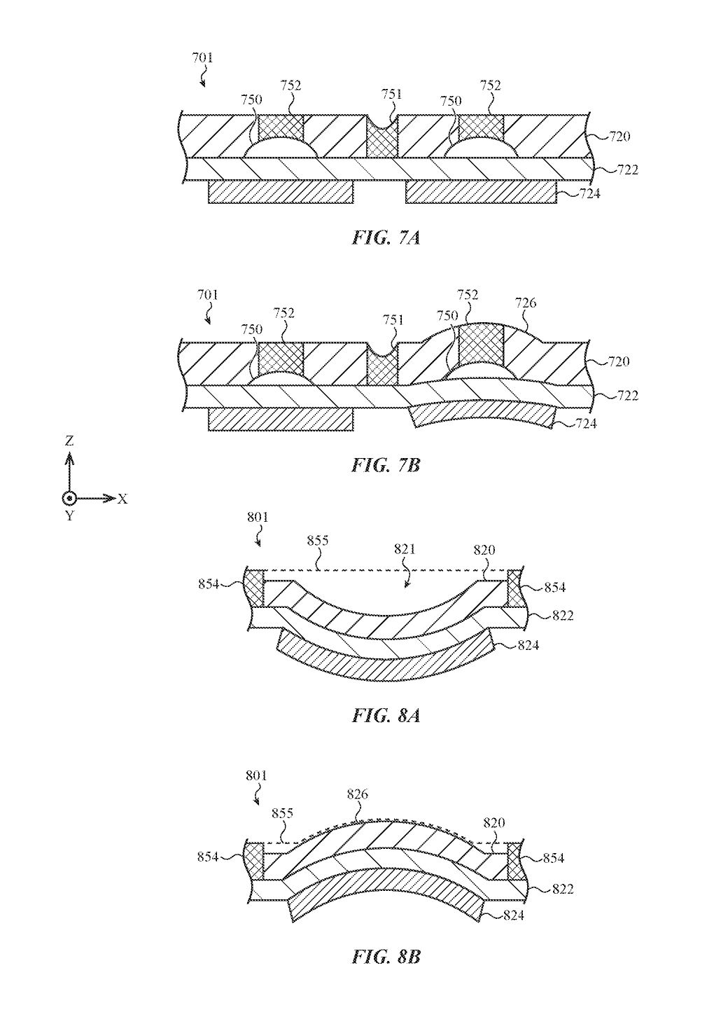

FIGS. 7A and 7B depict an example of a third deflection module 701 having a support structure 720 shaped to amplify the output of a haptic actuator 724. FIG. 7A depicts the deflection module 701 when the haptic actuators 724 are not actuated, while FIG. 7B portrays the deflection module 701 when a haptic actuator 724 is actuated. The deflection module 701 may combine features of the examples in FIGS. 5A-6B, and may similarly include haptic actuators 724 coupled to a circuit layer 722. The circuit layer 722 may be coupled to a multi-feature support structure 720, as described below.

The support structure 720 combines the features of the previous figures (FIGS. 5A-6B) to further amplify the output of a haptic actuator 724. The support structure 720 may include one or more cavities 750 in a surface of the support structure 720 adjacent each haptic actuator 724. Each cavity 750 may be substantially similar to those described above with respect to FIGS. 5A and 5B.

Additionally, a portion of the support structure 720 above each cavity 750 may be formed from a material having a lower Young's Modulus E than the surrounding material of the support structure 720, forming a force concentration region 752. The force concentration region 752 may be substantially similar to those described above with respect to FIGS. 6A and 6B.

Each haptic actuator 724 may be affixed to a portion of the support structure 720 (e.g., via the circuit layer 722) toward one or more edges of the haptic actuator 724. This may impose a boundary condition on the haptic actuator 724. When the haptic actuator 724 is actuated, as depicted in FIG. 7B, the haptic actuator 724 may compress in all directions of the x-y plane. As the haptic actuator 724 is affixed to the support structure 720 surrounding the cavity 750, the compression of the haptic actuator 724 may cause a similar compression in the support structure 720. This may cause the support structure 720, in turn, to deflect in the z-direction at the location 726 directly above the haptic actuator 724.

The combined cavity 750 and force concentration region 752 may cause an amplified deflection by making the support structure 720 thinner and more flexible at the location 726 directly above the haptic actuator 724 and/or by allowing greater compression of the support structure 720 across the cavity 750 and force concentration region 752. The amplified deflection at the location 726 directly above the haptic actuator 724 may in turn cause an amplified haptic effect at a corresponding location of the surface (e.g., cover sheet 108 in FIG. 1) of the electronic device.

The support structure 720 may in some embodiments further include a relief region 751 between a pair of haptic actuators 724. In some embodiments the relief region 751 may be positioned between adjacent haptic actuators 724 in an array of force concentration regions 752. The relief region 751 includes a relief formed in a surface of the support structure 720, as described above with respect to FIGS. 5A and 5B, and the relief region 751 is formed from a material having a lower Young's Modulus E than the surrounding material of the support structure 720, as described above with respect to FIGS. 6A and 6B.

The relief region 751 may further isolate a portion of the support structure 720 above one haptic actuator 724 from the haptic response of another haptic actuator 724. The relief region 751 may additionally or alternatively assist to amplify the haptic response of a haptic actuator 724 by adding flexibility to the support structure 720 and/or relieving tension in the support structure 720 between haptic actuators 724.

FIGS. 8A and 8B depict an example of a fourth deflection module 801 having a support structure 820 shaped or configured to amplify the output of a haptic actuator 824. FIG. 8A depicts the deflection module 801 when the haptic actuator 824 is not actuated, while FIG. 8B portrays the deflection module 801 when the haptic actuator 824 is actuated. Similar to the examples in FIGS. 5A-7B, the deflection module 801 includes a haptic actuator 824 coupled to a circuit layer 822. The circuit layer 822 may be coupled to a pre-curved support structure 820.

In the illustrated embodiment, the support structure 820 is pre-curved in order to provide a “pop” response to amplify the output of a haptic actuator 824. The support structure 820 may curve away from an intermediate layer 855 (illustrated here as a dashed line, which may correspond to an intermediate layer such as the force sensor layer depicted above with respect to FIGS. 2A and 2B). The support structure 820 may be formed with a curved channel, and a radial width of the channel may substantially match a dimension (e.g., width) of the haptic actuator 824. In other embodiments the support structure 820 may be formed with a hemispherical shape or another suitable geometric shape. In still other embodiments, the support structure 820 may be placed under mechanical strain to create a similar curve away from the intermediate layer 855. For example, rigid supports 854 may hold the support structure 820 under mechanical strain.

The support structure 820 may be bonded on each side to rigid supports 854. The rigid supports 854 may impose a boundary condition on the support structure 820 such that it may primarily deflect along the z-direction, rather than along the x-y plane. The support structure 820 may be bonded to the rigid supports 854 through a suitable technique, such as fusing, welding, molding, or otherwise adhering the support structure 820 to the rigid supports 854. In some embodiments, the rigid supports 854 may simply be positioned adjacent to the support structure 820 without bonding. In other embodiments the rigid supports 854 and support structure 820 may be formed as a single piece. The rigid supports 854 may be formed from a rigid material, such as a metal or plastic (e.g., the same or a different material from the support structure 820).

The curved shape of the support structure 820 may act as a spring when the haptic actuator 824 is actuated. The haptic actuator 824 may be affixed to the support structure 820 (e.g., via the circuit layer 822) along substantially the entire width and/or length of the haptic actuator 824. This may impose a boundary condition on the haptic actuator 824. When the haptic actuator 824 is actuated, as depicted in FIG. 8B, the haptic actuator 824 may compress in all directions of the x-y plane. As the haptic actuator 824 is affixed to the support structure 820, the haptic actuator 824 may compress primarily along the bottom of the haptic actuator 824, causing the haptic actuator 824 to deflect in the z-direction.

Because the rigid supports 854 impose a boundary condition on the support structure 820, as the haptic actuator 824 begins to deflect in the z-direction, it may cause the support structure 820 to deflect in the z-direction at the location 826 directly above the haptic actuator 824. As the support structure 820 deflects, it may become mechanically unstable as the support structure 820 is compressed. The support structure 820 may also store potential energy as its curved shape becomes flattened, which potential energy may be released with a “pop” as the support structure 820 continues deflecting upward through a midpoint, suddenly deflecting and contacting the intermediate layer 855. The deflection may be transmitted through the intermediate layer 855 and in turn cause an amplified haptic effect at a corresponding location of the surface (e.g., cover sheet 108 in FIG. 1) of the electronic device.

The support structure 820 may return to its original, unactuated state in response to a reverse signal being applied to the haptic actuator 824 (e.g., by applying a voltage with a reversed polarity across the haptic actuator 824). In other embodiments, compression forces in layers above the support structure 820 may cause it to return once the haptic actuator 824 is de-energized.

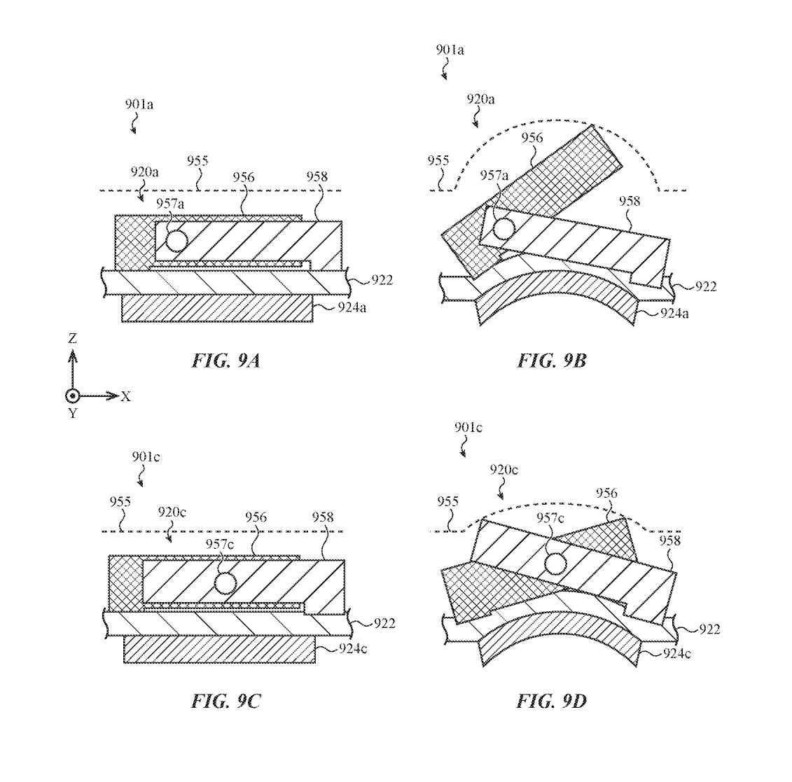

FIGS. 9A and 9B depict an example of a fifth deflection module 901a having a support structure 920a shaped to amplify the output of a haptic actuator 924a. FIG. 9A depicts the deflection module 901a when the haptic actuator 924a is not actuated, while FIG. 9B portrays the deflection module 901a when the haptic actuator 924a is actuated. Similar to the examples in FIGS. 5A-8B, the deflection module 901a includes a haptic actuator 924a coupled to a circuit layer 922. The circuit layer 922 may be coupled to a scissor support structure 920a.

The support structure 920a depicted in FIGS. 9A and 9B may include a first scissor arm 956 and a second scissor arm 958 positioned a distance below an intermediate layer 955. The second scissor arm 958 may be rotatably coupled to the first scissor arm 956 at a hinge 957a. The hinge 957a may be positioned at an end of the second scissor arm 958 and a corresponding point (e.g., middle region) of the first scissor arm 956. The hinge 957a may be any appropriate hinge mechanism, such as a pin or similar linkage.

The haptic actuator 924a may be affixed to the support structure 920a (e.g., via the circuit layer 922) at an interface with the first scissor arm 956 and an interface with the second scissor arm 958. This may impose a boundary condition on the haptic actuator 924a. When the haptic actuator 924a is actuated, as depicted in FIG. 9B, the haptic actuator 924a may compress in all directions of the x-y plane. As the haptic actuator 924a is affixed to the first scissor arm 956 and the second scissor arm 958, the compression of the haptic actuator 924a may move the scissor arms 956, 958 together. Because the end of the second scissor arm 958 is coupled to the first scissor arm 956 at a hinge 957a, when the scissor arms 956, 958 move together the end of the first scissor arm 956 may be displaced and contact the intermediate layer 955. The displacement may cause a deflection to be transmitted through the intermediate layer 955, which in turn causes an amplified haptic effect at a corresponding location of the surface (e.g., cover sheet 108 in FIG. 1) of the electronic device.

FIGS. 9C and 9D depict another embodiment of the fifth deflection module 901b depicted in FIGS. 9A and 9B. FIG. 9C depicts the deflection module 901b when the haptic actuator 924c is not actuated, while FIG. 9D portrays the deflection module 901b when the haptic actuator 924c is actuated. The deflection module 901b includes a haptic actuator 924c coupled to a circuit layer 922. The circuit layer 922 may be coupled to a scissor support structure 920c.

The support structure 920c depicted in FIGS. 9C and 9D may be substantially similar to the support structure 920a depicted in FIGS. 9A and 9B, with the hinge 957c positioned at substantially a midpoint of the support structure 920c. When the haptic actuator 924c is actuated, as depicted in FIG. 9D, the end of the first scissor arm 956 and the end of the second scissor arm 958 may be displaced and contact the intermediate layer 955, transmitting a deflection in the intermediate layer 955 upward. While this may result in a haptic effect which may not be as strong as the previous example at a corresponding location of the surface of the electronic device, the area of the haptic effect may be larger than the support structure 920a depicted in FIGS. 9A and 9B.

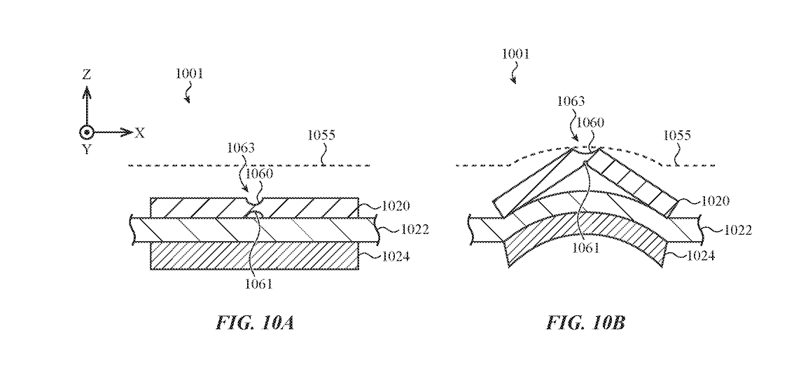

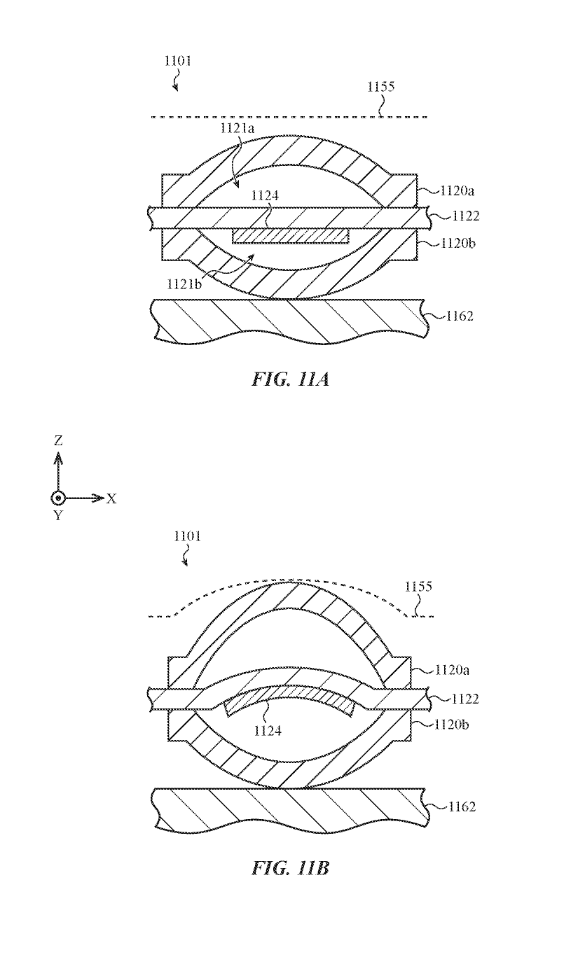

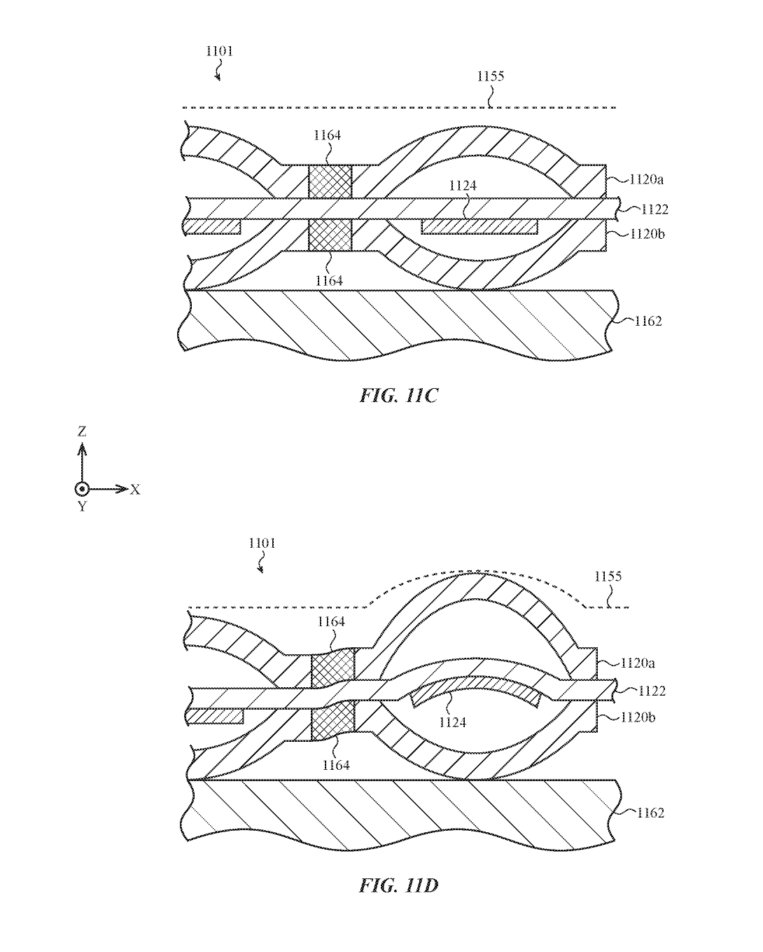

FIGS. 10A and 10B depict an example of a sixth deflection module 1001 having a support structure 1020 shaped to amplify the output of a haptic actuator 1024. FIG. 10A depicts the deflection module 1001 when the haptic actuator 1024 is not actuated, while FIG. 10B portrays the deflection module 1001 when the haptic actuator 1024 is actuated. Similar to the examples in FIGS. 5A-9D, the deflection module 1001 includes a haptic actuator 1024 coupled to a circuit layer 1022. The circuit layer 1022 may be coupled to a support structure 1020 having a central flexure 1063.

The support structure 1020 may include a flexure 1063 at substantially a center of the support structure 1020. The flexure 1063 may be formed by reliefs 1060, 1061 formed in the top and bottom surfaces of the support structure 1020 respectively. The reliefs 1060, 1061 may be shaped as a rounded slot (e.g. semi-cylinder) formed in the surface of the support structure 1020. In other embodiments the reliefs 1060, 1061 may be shaped as a hemisphere, a pyramid, a rectangle, or another suitable geometric shape, including a non-regular shape. The reliefs 1060, 1061 may be formed within the support structure 1020 by a suitable technique, such as molding, cutting, etching, etc.

The reliefs 1060, 1061 may form a flexure 1063, a point at which the support structure 1020 bends in a hinge-like manner. The flexure 1063 may also divide the support structure 1020 into two arms. The haptic actuator 1024 may be affixed to the support structure 1020 (e.g., via the circuit layer 1022) at one or more edges of the haptic actuator 1024. This may impose a boundary condition on the haptic actuator 1024. When the haptic actuator 1024 is actuated, as depicted in FIG. 10B, it may compress in all directions of the x-y plane. As the edges of the haptic actuator 1024 are affixed to the support structure 1020, the support structure 1020 may bend upward (e.g., along the z-direction) at the flexure 1063, and may deflect upward and contact the intermediate layer 1055. When the support structure 1020 deflects, the top relief 1060 may widen, while the bottom relief 1061 narrows, allowing for greater flexibility at the flexure 1063. In other words, the flexure 1063 flexibly connects the two arms of the support structure 1020, allowing a second end of each arm to deflect upward and contact the intermediate layer 1055. The deflection may be transmitted through the intermediate layer 1055 and in turn cause an amplified haptic effect at a corresponding location of the surface (e.g., cover sheet 108 in FIG. 1) of the electronic device.

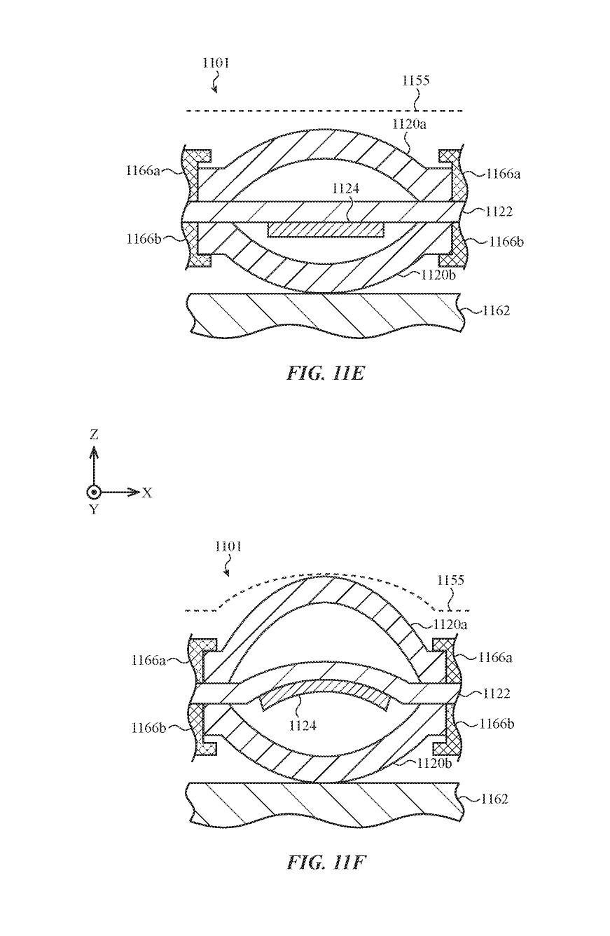

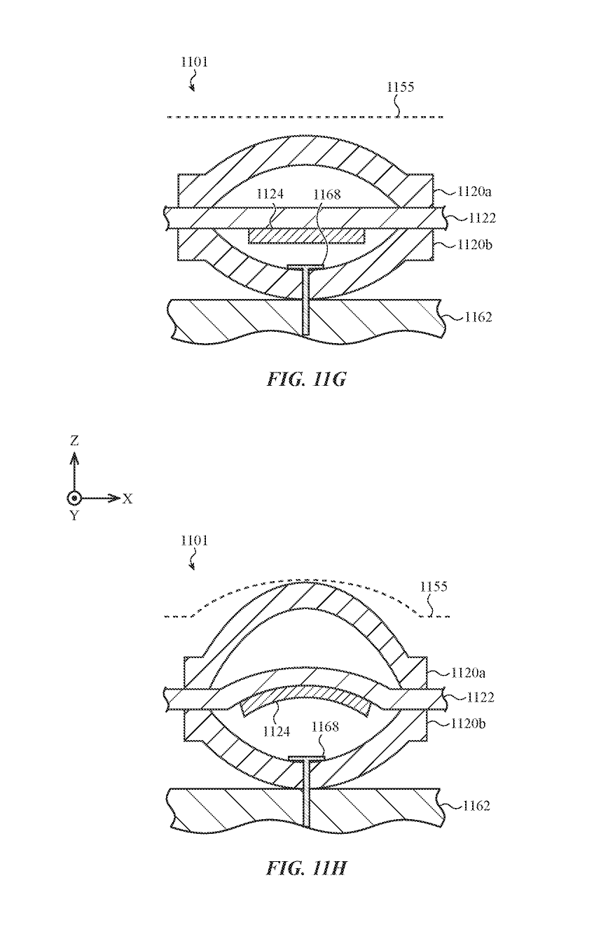

FIGS. 11A and 11B depict an example of a seventh deflection module 1101 having a support structure 1120a, 1120b shaped to amplify the output of a haptic actuator 1124. FIG. 11A depicts the deflection module 1101 when the haptic actuator 1124 is not actuated, while FIG. 11B portrays the deflection module 1101 when the haptic actuator 1124 is actuated. The deflection module 1101 includes a haptic actuator 1124 coupled to a circuit layer 1122. The circuit layer 1122 may be coupled between an upper support structure 1120a and a lower support structure 1120b.

The upper support structure 1120a and the lower support structure 1120b may amplify the output of the haptic actuator 1124. The upper support structure 1120a and the lower support structure 1120b may both be pre-curved, and the lower support structure 1120b may rest on a lower layer 1162. Each may curve away from the circuit layer 1122. Both support structures 1120a, 1120b may be formed with a curved channel 1121a, 1121b having a dimension (e.g., width, length) greater than a corresponding dimension of the haptic actuator 1124. In other embodiments, the support structures 1120a, 1120b may be formed with a hemispherical shape or another suitable geometric shape. In some embodiments, the upper support structure 1120a may have a different shape from the lower support structure 1120b. In still other embodiments, the support structures 1120a, 1120b may be placed under mechanical strain to create a similar curve away from the circuit layer 1122.

The curved shape of the upper support structure 1120a may substantially match the curved shape of the lower support structure 1120b. The support structures 1120a, 1120b may be affixed to the circuit layer 1122, and may enclose the haptic actuator 1124 and a portion of the circuit layer 1122 within a round or ovular cavity. Because the support structures 1120a, 1120b are affixed to the circuit layer 1122, a deflection of the circuit layer 1122 along the x-y plane may cause a deflection in the support structures 1120a, 1120b.

When the haptic actuator 1124 is actuated, as depicted in FIG. 11B, the haptic actuator 1124 may compress in all directions of the x-y plane. As the haptic actuator 1124 is affixed to the circuit layer 1122, the actuation may in turn cause the circuit layer 1122 to compress along the x-y plane. This in turn may compress the support structures 1120a, 1120b.

When the upper support structure 1120a is compressed along the x-y plane, its curved shape may cause it to deflect along the z-direction. The lower support structure 1120b may similarly deflect along the z-direction. As the lower support structure 1120b rests on a lower layer 1162, which may be a rigid layer, the deflection of the lower support structure 1120b may be transferred upward to amplify the deflection of the upper support structure 1120a (e.g., by lifting the upper support structure 1120a). Thus the upper support structure 1120a is deflected and contacts the intermediate layer 1155. The deflection may be transmitted through the intermediate layer 1155 and in turn cause an amplified haptic effect at a corresponding location of the surface (e.g., cover sheet 108 in FIG. 1) of the electronic device.

Because in the example deflection module 1101 depicted in FIGS. 11A and 11B the deflection module 1101 moves vertically, the deflection module 1101 may typically include a linking mechanism to allow movement while directing the haptic response into the intermediate layer 1155, and consequently to the surface of the electronic device. Example linking mechanisms are further illustrated below with respect to FIGS. 11C-11H.

FIGS. 11C and 11D depict an embodiment of the seventh deflection module 1101 depicted in FIGS. 11A and 11B, illustrating a first example linking mechanism. FIG. 11C depicts the deflection module 1101 when the haptic actuator 1124 is not actuated, while FIG. 11D portrays the deflection module 1101 when the haptic actuator 1124 is actuated. The deflection module 1101 includes a haptic actuator 1124 coupled to a circuit layer 1122. The circuit layer 1122 may be coupled between an upper support structure 1120a and a lower support structure 1120b.

The first example linking mechanism is a binding material 1164 linking adjacent support structures 1120a, 1120b. The binding material 1164 may be compliant and/or formed from a material with a lower Young's Modulus E than the support structures 1120a, 1120b. For example, the support structures 1120a, 1120b may be formed from a stiff metal (e.g., steel), while the binding material 1164 is formed from a more elastic metal (e.g., aluminum). In other embodiments, different materials and combinations of materials may be used, including metals, plastics, ceramics, glass, etc. A binding material 1164 may be bonded to the upper support structure 1120a and the lower support structure 1120b by a suitable technique. For example, the binding material 1164 may be fused, welded, molded, or otherwise adhered to the support structures 1120a, 1120b.

The binding material 1164 may bind adjacent support structures 1120a, 1120b together while allowing the deflection module 1101 to move vertically. When the haptic actuator 1124 is in an unactuated state, the deflection module 1101 may rest in parallel with an adjacent deflection module 1101. When the haptic actuator 1124 is actuated, as depicted in FIG. 11D, it may cause deflection and vertical movement as described above with respect to FIG. 11B. The binding material 1164 may allow for this vertical movement while isolating adjacent deflection module 1101s from the movement.

FIGS. 11E and 11F depict another embodiment of the seventh deflection module 1101 depicted in FIGS. 11A and 11B, illustrating a second example linking mechanism. FIG. 11E depicts the deflection module 1101 when the haptic actuator 1124 is not actuated, while FIG. 11F portrays the deflection module 1101 when the haptic actuator 1124 is actuated. The deflection module 1101 includes a haptic actuator 1124 coupled to a circuit layer 1122. The circuit layer 1122 may be coupled between an upper support structure 1120a and a lower support structure 1120b.

The second example linking mechanism includes brackets 1166a, 1166b on either side of the support structures 1120a, 1120b, which allow for vertical movement while restricting horizontal movement. The brackets 1166a, 1166b may be fixed in place, and may be attached to other components of the electronic device. An upper portion of a bracket 1166a may provide an upper boundary on vertical motion, while a lower portion of a bracket 1166b may provide a lower boundary on vertical motion.

When the haptic actuator 1124 is in an unactuated state, the lower support structure 1120b may rest against a flange of the lower portion of the brackets 1166b. When the haptic actuator 1124 is actuated, as depicted in FIG. 11F, it may cause deflection and vertical movement as described above with respect to FIG. 11B. The brackets 1166a, 1166b may allow for this vertical movement, and the upper support structure 1120a may rest against a flange of the upper portion of the brackets 1166a in the actuated state. In some examples, the brackets 1166a, 1166b may be formed differently. For example, the brackets 1166a, 1166b may omit one or both flanges.

FIGS. 11G and 11H depict another embodiment of the seventh deflection module 1101 depicted in FIGS. 11A and 11B, illustrating a third example linking mechanism. FIG. 11G depicts the deflection module 1101 when the haptic actuator 1124 is not actuated, while FIG. 11H portrays the deflection module 1101 when the haptic actuator 1124 is actuated. The deflection module 1101 includes a haptic actuator 1124 coupled to a circuit layer 1122. The circuit layer 1122 may be coupled between an upper support structure 1120a and a lower support structure 1120b.

The third example linking mechanism is a pin 1168 through the lower support structure 1120b. The lower support structure 1120b may be fixed in place by a pin 1168 or similar mechanism which retains the lower support structure 1120b in place while allowing the upper support structure 1120a to deflect upward when the haptic actuator 1124 is actuated, as depicted in FIG. 11H. The pin 1168 may be placed through a point substantially at the center of the lower support structure 1120b and into the lower layer 1162.

The example linking mechanisms depicted in FIGS. 11C-11H are described for illustrative purposes, and it should be understood that other linking mechanisms would be within the scope of the present disclosure.

### II. Pre-Stressed Haptic Actuators

Turning to FIGS. 12-23, in some embodiments, the processing unit (such as processing unit 446 depicted in FIG. 4) is configured to cause one or more haptic actuators 1224a, 1224b to be placed in a pre-stressed state based on an application program running on the electronic device. For example, a user interface can include one or more icons or input regions that a user will interact with during the operation of the application program. Based on the known locations of the icon(s) or input regions, the processing unit may cause the haptic actuator(s) 1224a, 1224b located below and/or adjacent the icon(s) or input regions to be placed in a pre-stressed state. Thus, in some embodiments, only a portion of the haptic actuators 1224a, 1224b may be placed in the pre-stressed state. Additionally or alternatively, the processing unit can cause the array 1240 of haptic actuators 1224a, 1224b to be placed in the pre-stressed state.

As depicted in FIG. 12, in some situations, the support structure 1220 of the electronic device 1200 and/or the support plate 1223 can slump or sag over time due at least in part to gravity and/or damage caused by an impact (e.g., a drop event). The sagging support structure 1220 and/or support plate 1223 causes the size of the gap 1218 to vary across the width and/or length of the deflection module. As shown in FIG. 12, at least one distance (e.g., distance D2) between a haptic actuator 1224a and the first force-sensing component 1214 may differ from the distances between the haptic actuators 1224b and the first force-sensing component 1214 (e.g., distances D1 and D3). The differing distances can result in a non-uniform deflection of the cover sheet 1208. For example, when the haptic actuators 1224a, 1224b are activated simultaneously, the top surface of the cover sheet 1208 at the location corresponding to the haptic actuators 1224b can deflect ahead of the location corresponding to the haptic actuator 1224a because the portion of the support structure 1220 (or the portion of the second force-sensing component 1216) associated with the haptic actuator 1224a (e.g., the portion over and possibly surrounding the haptic actuator 1224a) has to travel a greater distance to close the gap 1218 and contact the first force-sensing layer 1214. Due to the differing distances, the actuation performances of the haptic actuators 1224a, 1224b can be non-linear across the array 1240. In other words, if all of the haptic actuators 1224a, 1224b are activated simultaneously, the timing and magnitude of the deflections in the cover sheet 1208 can differ depending on the location(s) of the haptic actuators 1224a, 1224b in the array 1240.

Accordingly, in some embodiments, one or more haptic actuators 1224a, 1224b are electrically pre-stressed to position the haptic actuator(s) 1224a, 1224b closer to the cover sheet 1208. In some situations, the haptic actuator(s) 1224a, 1224b are electrically pre-stressed to close the gap 1218 such that the second-force sensing component 1216 contacts the first force-sensing component 1214 without deflecting (or substantially deflecting) the top surface of the cover sheet 1208. In other situations, the one or more haptic actuators 1224a, 1224b are electrically pre-stressed such that the second force-sensing component 1216 and the support structure 1220 move into the gap 1218 but do not close the gap 1218. Additionally, the gap 218c (FIG. 2) may be closed when the haptic actuator(s) 1224a, 1224b are electrically pre-stressed.

Pre-stressing the haptic actuators 1224a, 1224b can reduce, minimize, or cancel the non-uniform and/or non-linear actuation performances of the haptic actuators 1224a, 1224b. Additionally, one or more of the pre-stressed haptic actuators 1224a, 1224b may deflect the cover sheet 1208 to provide haptic feedback faster than when not pre-stressed. In other words, the time lag between the time when a pre-stressed haptic actuator 1224a, 1224b is activated and the time when a deflection is produced in the cover sheet 1208 may be reduced.

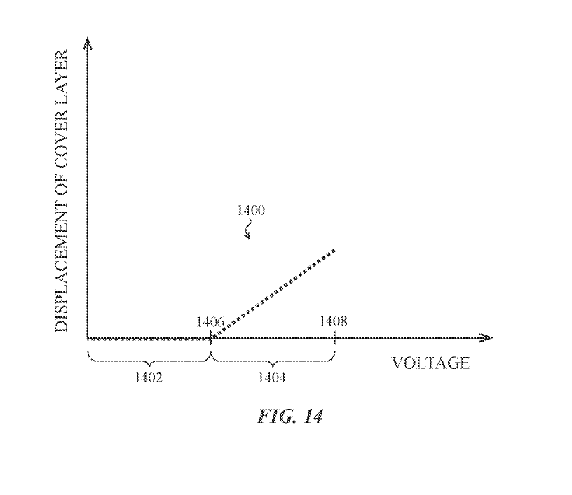

In other embodiments, one or more haptic actuators 1224a, 1224b are electrically pre-stressed to position the haptic actuator(s) 1224a, 1224b farther from the cover sheet 1208. An example embodiment is shown in FIG. 14.

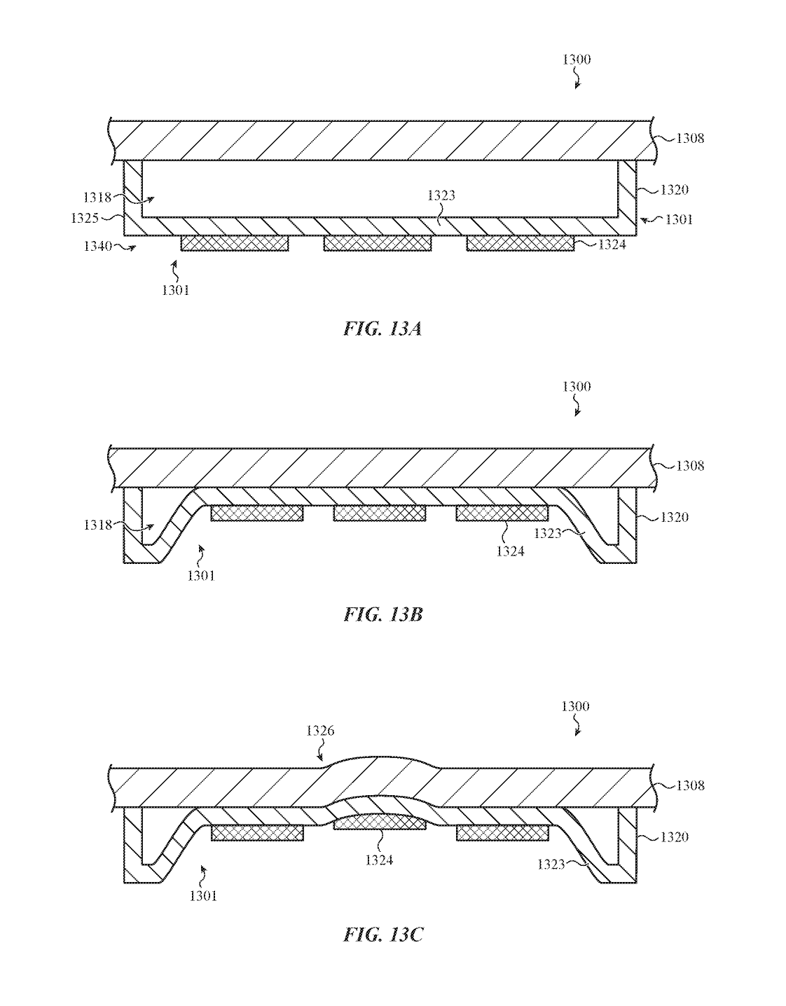

The haptic actuators 1324 are electrically pre-stressed by applying a pre-stress signal (e.g., a direct current signal) to each haptic actuator 1324. FIGS. 13A-13C depict the operations of pre-stressing an array 1340 of haptic actuators 1324 and providing a haptic output with one of the pre-stressed haptic actuators 1324. FIG. 13A depicts a cross-sectional view of another example electronic device with the haptic actuators 1324 in a non-actuated state.

An electronic device 1300 includes a cover sheet 1308 and a support structure 1320. In the illustrated embodiment, the support structure 1320 is a U-shaped support structure that includes a support plate 1323 and sides 1325 that extend from the support plate 1323 and attach to the cover sheet 1308. The support structure 1320 is configured to attach to, and suspend from, the cover sheet 1308 such that a gap 1318 is defined between the cover sheet 1308 and the support plate 1323.

An array 1340 of haptic actuators 1324 is attached to the bottom surface of the support plate 1323. In the illustrated embodiment, the array 1340 includes three haptic actuators 1324. In other embodiments, the array 1340 can include one or more haptic actuators 1324. As shown in FIGS. 13A-13C, the haptic actuators 1324 are attached directly to a bottom surface of a support plate 1323. In other embodiments, the haptic actuators 1324 can be coupled to the support plate 1323 through a circuit layer.

The support structure 1320 and the array 1340 of haptic actuators 1324 collectively form a deflection module 1301. In FIG. 13A, the deflection module 1301 is shown in a rest configuration. FIG. 13B depicts the deflection module 1301 in a pre-stressed configuration. The pre-stressed configuration is produced by applying a pre-stress signal to each haptic actuator 1324 in the array 1340 to place the haptic actuators 1324 in a pre-stressed state.

In the illustrated embodiment, when the haptic actuators 1324 are in the pre-stressed state, the support structure 1320 deflects such that the support plate 1323 and the haptic actuators 1324 move upward into the gap 1318. When the deflection module 1301 is in the pre-stressed configuration, the array 1340 of haptic actuators 1324 are positioned closer to the cover sheet 1308. In the illustrated embodiment, the top surface of the support plate 1323 contacts the bottom surface of the cover sheet 1308, although this is not required. In some embodiments, the support plate 1323 and the haptic actuators 1324 can move into the gap 1318 to position the haptic actuators 1324 closer to the cover sheet 1308 without having the top surface of the support plate 1323 contact the bottom surface of the cover sheet 1308. Thus, the deflection module 1301 can be placed in multiple pre-stress configurations with each pre-stress configuration placing the haptic actuators 1324 closer to (or farther from) the cover sheet 1308.

FIG. 13C depicts the electronic device shown in FIG. 13B with one haptic actuator in a haptic output state. In the illustrated embodiment, an actuation signal (e.g., an alternating current signal) is applied to the haptic actuator 1324 to place the haptic actuator 1324 in a haptic output state. The haptic output state increases the deflection of the support plate 1323 locally (e.g., above and around the haptic actuator 1324), which in turn produces a localized deflection in the cover sheet 1308. In other words, a deflection is produced in the cover sheet 1308 at a location 1326 that substantially corresponds to the location of the haptic actuator 1324 on the support structure 1320. The cover sheet 1308 further or distal from the deflection is substantially unaffected by the haptic output produced by the haptic actuator 1324. The area of the cover sheet 1308 that is deflected depends at least in part on the type of haptic actuators 1324, the signal level of the actuation signal, and the density of the haptic actuators 1324 in the array 1340.

In some embodiments, an intermediate layer (e.g., one or more layers) can be positioned between the top surface of the support plate 1323 and the bottom surface of the cover sheet 1308. In such embodiments, the top surface of the support plate 1323 can contact, or be positioned closer to, the bottom surface of the intermediate layer when the deflection module 1301 is in the pre-stressed configuration. For example, in one embodiment, the electronic device 1300 is constructed similar to the electronic device 100 shown in FIG. 2C. When the deflection module 201b is in the pre-stressed configuration, the second force-sensing component 216b contacts, or is positioned closer to, the first force-sensing component 214b.

FIG. 14 depicts an example graph representing the deflection of a cover sheet in response to the application of a signal to a haptic actuator. In the plot 1400, the signal (e.g., a voltage signal) is represented on the horizontal axis while the amount of displacement or deflection in the cover sheet is represented on the vertical axis. A pre-stress signal 1402 places the haptic actuator in a pre-stressed state and an actuation signal 1404 produces a displacement or deflection in the cover sheet. The pre-stress signal 1402 extends along the horizontal axis between zero and a first signal (voltage) level 1406. The haptic actuator is placed in the pre-stressed state when a signal level of the pre-stress signal 1402 is greater than zero and less than or equal to the first signal level 1406. Thus, the pre-stressed state of a haptic actuator includes a range of pre-stressed levels or sub-states.

For example, in the embodiment shown in FIG. 2D, the signal level 1406 represents the signal level that causes the support structure 220b to deflect such that the second force-sensing component 216b contacts the first force-sensing component 214b but does not produce a deflection in the cover sheet 208b. In another example, the first signal level 1406 represents the signal level that causes the support structure 1320 in FIG. 13B to deflect such that the support plate 1323 contacts the cover sheet 1308.

The actuation signal 1404 produces a displacement or deflection in the cover sheet. Thus, the haptic actuator is placed in a haptic output state (a state that produces a deflection in the cover sheet) when a signal level of the actuation signal 1404 is greater than the first signal level 1406 and less than or equal to a second signal level 1408. In the illustrated embodiment, the signal level 1408 represents a signal level that produces a maximum displacement in the cover sheet. Accordingly, the haptic output state of the haptic actuator includes a range of displacement magnitudes up to the maximum displacement.

Some embodiments can use one or more haptic actuators or another type of sensor to detect the amount of deflection of the support structure. For example, in FIG. 13C, the haptic actuator 1324 may be configured to detect when the top surface of the support plate 1323 contacts the bottom surface of the cover sheet 1308 (e.g., detect when the gap 1318 is closed). One type of haptic actuator that can be used to deflect the support structure 1320 and to detect the closure of the gap 1318 is a haptic actuator that includes a piezoelectric material. When an actuation signal is applied to the piezoelectric material, the piezoelectric material converts the actuation signal into physical movement. This physical movement can be used to deflect the support structure 1320 and, ultimately, the cover sheet 1308. Additionally, a piezoelectric material accumulates charge in response to an applied stress or pressure. This accumulated charge can be sensed from the piezoelectric material as an output signal (e.g., a current signal). This output signal may be used to detect when the gap 1318 is closed.

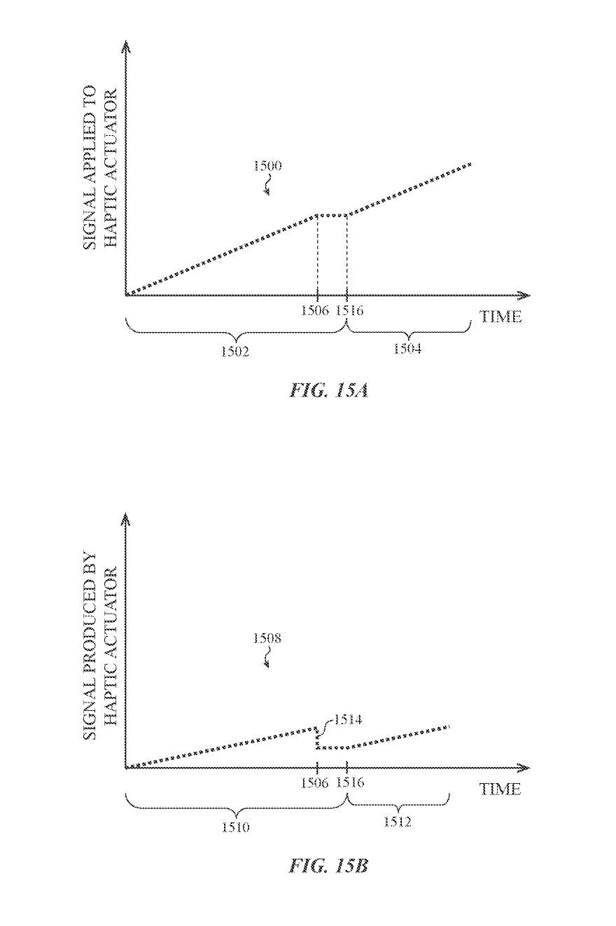

FIGS. 15A and 15B depict first technique for pre-stressing a haptic actuator and sensing the closure of a gap. FIGS. 15A and 15B are described in conjunction with the haptic actuators 1324 shown in FIGS. 13A-13C. FIG. 15A illustrates an example plot of an input signal that can be applied to the haptic actuator 1324. The input signal 1500 includes a pre-stress signal 1502 and an actuation signal 1504. The pre-stress signal 1502 can be applied to the array 1340 of haptic actuators 1324 to place the haptic actuators 1324 in a pre-stressed state (FIG. 13B). The increasing pre-stress signal 1502 can be applied to the haptic actuators 1324 over a period of time (e.g., from zero to a time 1506).

In embodiments where the haptic actuators 1324 include a piezoelectric material, the mechanical deflection (e.g., the movement and/or vibrations) of each haptic actuator 1324 produces an output signal (e.g., an alternating current signal) in each haptic actuator. FIG. 15B depicts an example output signal that is produced by the haptic actuator 1324 based on the input signal shown in FIG. 15A. The output signal 1508 includes a first output signal 1510 that is associated with the pre-stressed state of the haptic actuator 1324 (FIG. 13B) and a second output signal 1512 that is associated with the actuation state of the haptic actuator (FIG. 13C). Application of the pre-stress signal 1502 to the haptic actuator 1324 over time produces the increasing first output signal 1510.

Time 1506 represents the time when the gap 1318 is closed and the support plate 1323 contacts the cover sheet 1308. A signal displacement 1514 occurs in the output signal 1508 when the support plate 1323 contacts the cover sheet 1308. The signal displacement 1514 occurs because the deflection of the haptic actuator 1324 changes when the support plate 1323 contacts the cover sheet 1308.

The haptic actuator is maintained in the pre-stressed state during the time period between time 1506 and time 1516. At time 1516, the actuation signal 1504 is applied to the haptic actuator 1324 to place the haptic actuator 1324 in the haptic output state and produce a deflection in the cover sheet 1308. Accordingly, at time 1516, the second output signal 1512 increases based on the increased actuation of the haptic actuator 1324. As the actuation signal 1504 increases, a deflection is produced in the cover sheet 1308 at a location 1326 that substantially corresponds to the location of the haptic actuator 1324 on the support structure 1320 (see FIG. 13C). The second output signal 1512 increases after time 1516 because the pressure applied to the haptic actuator 1324 by the deflection of the cover sheet 1308 increases after time 1516.

In some embodiments, the closure of the gap 1318 is detected by sensing or identifying the signal displacement 1514 in the output signal 1508. A processing unit can receive an output signal from one or more haptic actuators 1324 in the array 1340 and analyze the output signal(s) to detect the signal displacement 1514. When the processing unit detects a signal displacement in an output signal received from a respective haptic actuator 1324, the processing unit can cause the signal level of the corresponding pre-stress signal 1502 for that haptic actuator 1324 to be maintained at that signal level. This allows the haptic actuator 1324 to remain in the pre-stressed state until the haptic actuator 1324 receives an actuation signal 1504, or until the haptic actuator 1324 stops receiving the pre-stress signal 1502.

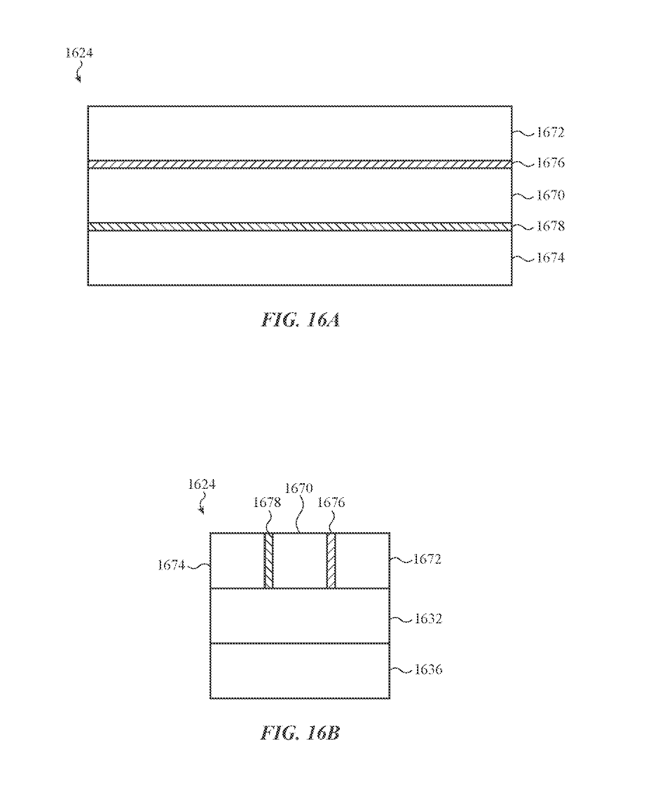

FIG. 16A depicts a top view of an example haptic actuator that can be used to sense the closure of a gap. The haptic actuator 1624 includes a sense electrode 1670 positioned between a first drive electrode 1672 and a second drive electrode 1674. In some embodiments, an insulating (e.g., ground) electrode 1676, 1678 is positioned between each drive electrode 1672, 1674 and the sense electrode 1670 to electrically isolate the sense electrode 1670 from the first and the second drive electrodes 1672, 1674. In other embodiments, the electrodes 1676, 1678 can be omitted and air gaps may be used to electrically isolate the sense electrode 1670 from the first and the second drive electrodes 1672, 1674.

The sense electrode 1670 is used to sense or receive an output signal from the haptic actuator 1624. As described earlier, a processing unit can receive the output signal from the haptic actuator 1624 and analyze the output signal to detect a signal displacement (e.g., signal displacement 1514 in FIG. 15B). The signal displacement indicates the gap between a cover sheet or intermediate layer and the support structure is closed.

The first and the second drive electrodes 1672, 1674 are used to apply an input signal to the haptic actuator 1624. As discussed earlier, the input signal includes a pre-stress signal that places the haptic actuator 1624 in a pre-stressed state and an actuation signal that places the haptic actuator 1624 in a haptic output state. In some embodiments, the pre-stressed state causes a support structure to deflect to position the haptic actuator 1624 closer to a spaced-apart overlying layer (e.g., the first force-sensing component 214b in FIG. 2D or the cover sheet 1308 in FIG. 13B). The actuation signal causes the deflection of the support structure to increase locally to produce a deflection in the cover sheet (e.g., the cover sheet 1308 in FIG. 13C).

FIG. 16B depicts a side view of the haptic actuator 1624 shown in FIG. 16A. A piezoelectric material 1632 is positioned below the sense electrode 1670 and the first and the second drive electrodes 1672, 1674. A conductive pad (e.g., third electrode) 1636 (e.g., a ground electrode) is disposed below the piezoelectric material 1632. As described earlier, any suitable piezoelectric material can be used. For example, the piezoelectric material 1632 can include a piezoelectric polymer material such as a polyvinylidene fluoride, a piezoelectric ceramic material such as lead zirconate titanate, a semiconductor material, or a lead-free piezoelectric material such as potassium-sodium niobate.

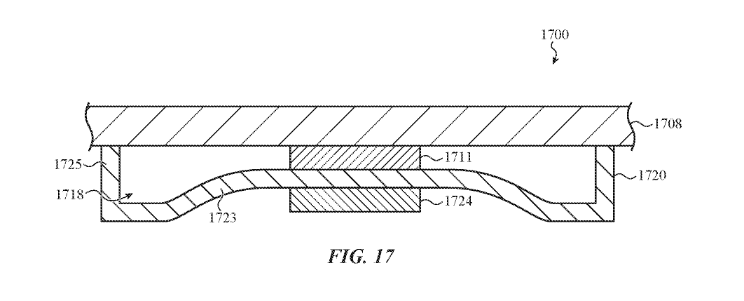

FIG. 17 depicts a second technique for pre-stressing a haptic actuator 1724 and sensing the closure of a gap. An electronic device 1700 includes a cover sheet 1708 and a support structure 1720. In the illustrated embodiment, the support structure 1720 is a U-shaped support structure that includes a support plate 1723 and sides 1725 that extend from the support plate 1723 and attach to the cover sheet 1708. The support structure 1720 is configured to attach to, and suspend from, the cover sheet 1708 such that a gap 1718 is defined between the cover sheet 1708 and the support plate 1723. As described earlier, other embodiments can configure the support structure 1720 and/or the support plate 1723 differently.

A haptic actuator 1724 is attached to the bottom surface of the support plate 1723. Although only one haptic actuator 1724 is shown in FIG. 10, other embodiments can include two or more haptic actuators. In the illustrated embodiment, the haptic actuator 1724 is attached directly to a bottom surface of a support plate 1723. In other embodiments, the haptic actuator 1724 can be coupled to the support plate 1723 through a circuit layer.

A strain sensor (e.g., a force sensor) 1711 is attached to the top surface of the support plate 1723. Although only one strain sensor 1711 is shown in FIG. 17, other embodiments can include two or more strain sensors. Additionally, in some embodiments, the one or more strain sensors can be attached to the cover sheet 1708, or to both the cover sheet 1708 and the support structure 1720. For example, strain sensors may be affixed to the cover sheet 1708, the support plate 1723, and/or to at least one side 1725 of the support structure.

Any suitable strain sensor 1711 can be used. In a non-limiting embodiment, the strain sensor 1711 is a strain gauge. The strain gauge can be made of any suitable transparent, translucent, or opaque strain-responsive material. Example strain-responsive materials include, but are not limited to, polyethyleneioxythiophene (PEDOT), indium tin oxide (ITO), carbon nanotubes, graphene, piezoresistive semiconductor materials, piezoresistive metal materials, metallic nanowires, strain-responsive elastomers, metals or metal alloys, and the like.

Closure of the gap 1718 can be detected based on an output or strain signal produced by the strain sensor 1711. When a pre-stress signal is applied to the haptic actuator 1724, the support structure 1720 deflects such that the support plate 1723 moves upward toward the cover sheet 1708. When the support plate 1723 moves into the gap 1718 such that the strain sensor 1711 contacts the bottom surface of the cover sheet 1708, a stress is applied to the strain sensor 1711. The stress produces strain in the strain-responsive material of the strain sensor 1711, which causes an electrical property of the strain-responsive material (e.g., a resistance) to change. This change in electrical property can be detected by applying an input or drive signal (e.g., current signal) to the strain-responsive material in the strain sensor 1711 and receiving an output or strain signal (e.g., current) from the strain-responsive material in the strain sensor 1711.

For example, in some embodiments, drive circuitry can be coupled to the strain sensor 1711 and configured to apply the drive signal to the strain-responsive material. Sense circuitry may also be coupled to the strain-responsive material and configured to receive the strain signal from the strain-responsive material in the strain sensor 1711. Drive circuitry and sense circuitry may form part of a signal generator (e.g., signal generator 44 in FIG. 4) or other circuitry coupled to a processing unit. A processing unit can be configured to receive the strain signal and correlate the strain signal to an applied stress (or to an absence of applied stress). In some embodiments, a strain signal is received continuously from the strain sensor 1711 during the time period between a pre-stress signal being transmitted to the haptic actuator 1724 and an actuation signal being transmitted to the haptic actuator 1724 (or until the pre-stress signal is no longer transmitted to the haptic actuator 1724).

In embodiments where the strain sensor 1711 is affixed to the bottom surface of the cover sheet 1708, the top surface of the support plate 1723 can contact the strain sensor 1711 when a pre-stress signal is applied to the haptic actuator 1724. In such embodiments, a stress is applied to the strain sensor 1711, which produces strain in the strain-responsive material in the strain sensor 1711. This strain can be detected by applying a drive signal to the strain-responsive material in the strain sensor 1711 and receiving a strain signal from the strain-responsive material in the strain sensor 1711.

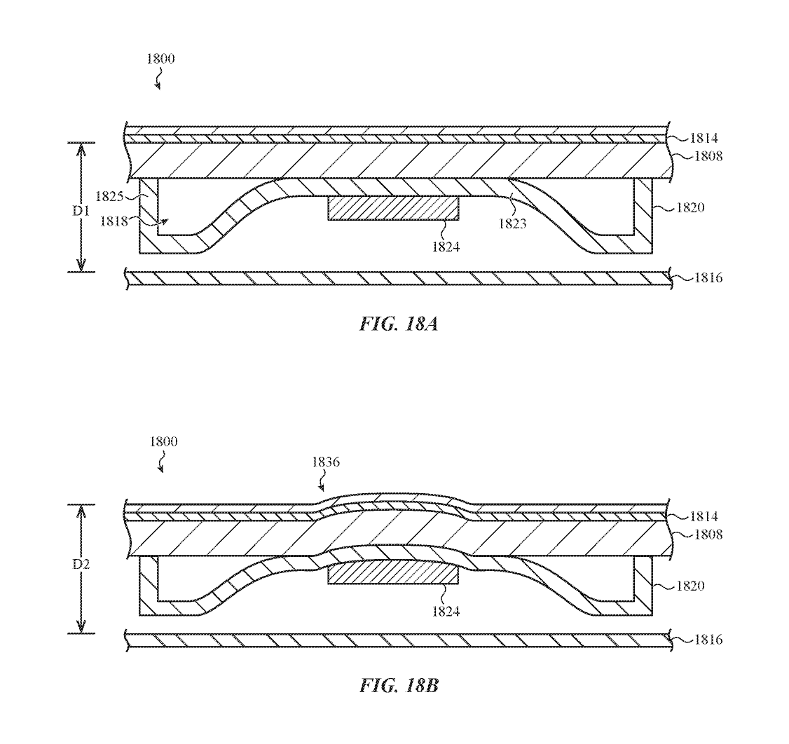

FIGS. 18A and 18B depict a third technique for pre-stressing a haptic actuator 1824 and sensing the closure of a gap. The electronic device 1800 includes a cover sheet 1808 and a support structure 1820. In the illustrated embodiment, the support structure 1820 is a U-shaped support structure that includes a support plate 1823 and sides 1825 that extend from the support plate 1823 and attach to the cover sheet 1808. The support structure 1820 is configured to attach to, and suspend from, the cover sheet 1808 such that a gap 1818 is defined between the cover sheet 1808 and the support plate 1823. As described earlier, other embodiments can configure the support structure 1820 and/or the support plate 1823 differently.

A haptic actuator 1824 is attached to the bottom surface of the support plate 1823. Although only one haptic actuator 1824 is shown in FIGS. 18A and 18B, other embodiments can include two or more haptic actuators. In the illustrated embodiment, the haptic actuator 1824 is attached directly to a bottom surface of a support plate 1823. In other embodiments, the haptic actuator 1824 can be coupled to the support plate 1823 through a circuit layer.

A first force-sensing component 1814 is disposed within the cover sheet 1808. In other embodiments, the first force-sensing component 1814 can be positioned at different locations within the electronic device 1800. For example, the first force-sensing component 1814 may be attached to a bottom surface of the cover sheet 1808.

A second force-sensing component 1816 is positioned below the support structure 1820. In other embodiments, the second force-sensing component 1816 can be positioned at different locations within the electronic device 1800. For example, the second force-sensing component 1816 may be attached to a top surface or a bottom surface of the support plate 1823.

The first force-sensing component 1814 represents a first array of electrodes and the second force-sensing component 1816 a second array of electrodes. The first and the second arrays of electrodes can each include one or more electrodes. Each electrode in the first array of electrodes is aligned in at least one direction (e.g., vertically) with a respective electrode in the second array of electrodes to form an array of capacitive sensors. The capacitive sensors are used to detect a displacement in the cover sheet 1808 through measured capacitances or changes in capacitances.

For example, when a pre-stress signal is applied to the haptic actuator 1824, the support structure 1820 deflects such that the support plate 1823 moves into the gap 1818. When the cover sheet 1808 begins to deflect based on the pre-stress signal, as illustrated by the deflection at location 1836 in FIG. 18B, a distance D1 between the electrodes in at least one capacitive sensor changes to D2, which varies the capacitance of that capacitive sensor. Drive and sense circuitry can be coupled to each capacitive sensor and configured to sense or measure the capacitance of each capacitive sensor. A processing unit may be coupled to the drive and sense circuitry and configured to receive signals representing the measured capacitance of each capacitive sensor. The processing unit can be configured to correlate the measured capacitances into a displacement in the cover sheet 1808. The processing unit can be configured to cause the pre-stress signal to be reduced until the measured capacitances indicate the displacement is gone.

In another embodiment, the support structure 1820 can deflect to increase or expand the gap 1818 (see also FIG. 14). In such embodiments, the displacement of the support structure 1820 (e.g., the support plate 1823) can be detected based on capacitance changes between the support plate 1823 and one of the force sensing components (e.g., second force-sensing component 1816). In such embodiments, the support plate 1823 may be made of any suitable conductive material. When the support structure 1820 deflects, the support plate 1823 moves closer to the second force-sensing component 1816 (e.g., expanding the gap 1818) and the distance between the support plate 1823 and the second force-sensing component 1816 changes (e.g., becomes shorter). This distance change varies the capacitance of at least one capacitive sensor. Drive and sense circuitry can be coupled to each capacitive sensor and configured to sense or measure the capacitance of each capacitive sensor. A processing unit may be coupled to the drive and sense circuitry and configured to receive signals representing the measured capacitance of each capacitive sensor. The processing unit can be configured to correlate the measured capacitances into a displacement of the support plate 1823.

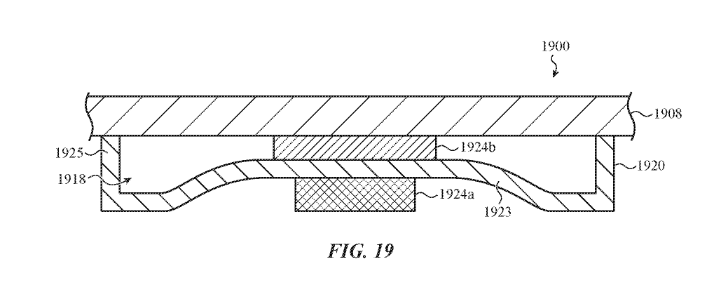

FIG. 19 depicts a fourth technique for pre-stressing a haptic actuator 1924a and sensing the closure of a gap. The electronic device 1900 includes a cover sheet 1908 and a support structure 1920. In the illustrated embodiment, the support structure 1920 is a U-shaped support structure that includes a support plate 1923 and sides 1925 that extend from the support plate 1923 and attach to the cover sheet 1908. The support structure 1920 is configured to attach to, and suspend from, the cover sheet 1908 such that a gap 1918 is defined between the cover sheet 1908 and the support plate 1923. As described earlier, other embodiments can configure the support structure 1920 and/or the support plate 1923 differently.

A first haptic actuator 1924a is attached to the bottom surface of the support plate 1923. Although only one first haptic actuator 1924a is shown in FIG. 19, other embodiments can include two or more first haptic actuators. In the illustrated embodiment, the first haptic actuator 1924a is attached directly to a bottom surface of a support plate 1923. In other embodiments, the first haptic actuator 1924a can be coupled to the support plate 1923 through a circuit layer.

A second haptic actuator 1924b is attached to a top surface of the support plate 1923. Although only one second haptic actuator 1924b is shown in FIG. 19, other embodiments can include two or more second haptic actuators. The second haptic actuator 1924b includes a piezoelectric material (e.g., piezoelectric material 1632 in FIG. 16B). When a pre-stress signal is applied to the first haptic actuator 1924a, the support structure 1920 deflects such that the support plate 1923 moves into the gap 1918. When the support plate 1923 moves into the gap 1918 such that the second haptic actuator 1924b contacts the bottom surface of the cover sheet 1908, a stress is applied to the second haptic actuator 1924b. The stress produces an electrical signal in the piezoelectric material in the second haptic actuator 1924b. This electrical or output signal can be detected and used to determine the gap 1918 is closed.

For example, in some embodiments, drive circuitry can be coupled to the first haptic actuator 1924a and configured to apply the pre-stress signal to the first haptic actuator 1924a. Sense circuitry may be coupled to the second haptic actuator 1924b and configured to receive the output signal from the second haptic actuator 1924b. Drive circuitry and sense circuitry may form part of a signal generator (e.g., signal generator 44 in FIG. 4) or other circuitry coupled to a processing unit. A processing unit can be configured to receive the output signal and determine the gap 1918 is closed.

In other embodiments, one or more second haptic actuators 1924b can be attached to a bottom surface of the cover sheet 1908. When the support plate 1923 moves into the gap 1918 such that the top surface of the support plate 1923 contacts at least one second haptic actuator 1924b, a stress is applied to the at least one second haptic actuator 1924b. The stress produces an electrical signal in the piezoelectric material in the at least one second haptic actuator 1924b. This electrical or output signal can be detected and used to determine the gap 1918 is closed.

Additionally or alternatively, in some embodiments, the first haptic actuator 1924a can be used to decrease or close the gap 1918 and the second haptic actuator 1924b may be used to deflect the cover sheet 1908 and produce the haptic output. In such embodiments, the first haptic actuator 1924a receives a DC signal (e.g., a DC current) to place the first haptic actuator 1924a in a pre-stressed state, which causes the support structure 1920 to deflect and position the support plate 1923 closer to (or farther from) the cover sheet 1908. The second haptic actuator 1924b receives an AC signal (e.g., an AC current) to place the second haptic actuator 1924b in a haptic output state to produce a deflection in the cover sheet 1908. In some embodiments, the second haptic actuator 1924b may also be used to detect the closure of the gap 1918. The AC signal may be applied to the second haptic actuator 1924b after the electrical signal indicating closure of the gap 1918 is received from the second haptic actuator 1924b.

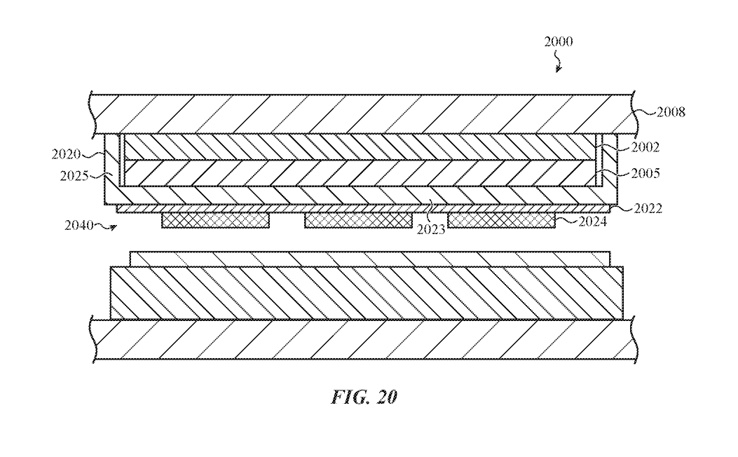

FIG. 20 depicts a cross-sectional view of another example of the electronic device taken along line A-A in FIG. 1. The electronic device 2000 is similar to the electronic device 200b shown in FIGS. 2C and 2D, except for the omission of the gaps 218b, 218c and the first and the second force-sensing components 214b, 216b. In the illustrated embodiment, the array 2040 of haptic actuators 2024 can be placed in a pre-stressed state to cause the support structure 2020 to deflect. In such embodiments, the support plate 2023 can move toward the cover sheet 2008 and produce a deflection in the backlight assembly 2005 and in the display layer 2002 without producing a noticeable or significant deflection in the cover sheet 2008. Thus, the pre-stressed state moves the haptic actuators 2024 closer to the cover sheet 2008 without producing a noticeable deflection in the cover sheet 2008.

FIG. 21 depicts a cross-sectional view of another example of the electronic device 2100 taken along line A-A in FIG. 1, where the haptic actuators are in a pre-stressed state. In the illustrated embodiment, the display layer 2102 is positioned below the cover sheet 2108 and the first force-sensing component 2116 is positioned between the display layer 2102 and the backlight assembly 2105.

An array 2140 of haptic actuators 2124 is affixed to a surface of the support structure 2120 (e.g., to the support plate 2123). As shown in FIG. 21, the array 2140 of haptic actuators 2124 is coupled to a bottom surface of the support plate 2123, although this is not required. Additionally, the array 2140 of haptic actuators 2124 can include one or more haptic actuators 2124.

The array 2140 of haptic actuators 2124 is attached and electrically connected to the circuit layer 2122. In the illustrated embodiment, the circuit layer 2122 is positioned on the sides of the haptic actuators 2124 that are opposite the support plate 2123. In other embodiments, the circuit layer 2122 may be positioned between the array 2140 of haptic actuators 2124 and the support structure 2120. Alternatively, the circuit layer 2122 can be omitted and the array 2140 of haptic actuators 2124 attached to the support structure 2120. Signal lines or electrical traces may be included in the support structure 2120 (or on the surface of the support structure) and electrically connected to the haptic actuators 2124.

As described earlier, the circuit layer 2122 includes signal lines that are electrically connected to the haptic actuators 2124. The signal lines can be used to transmit pre-stress signals to each haptic actuator 2124 to place the haptic actuators 2124 in a pre-stressed state. However, in the illustrated embodiment, the pre-stressed state expands the gap 2118 and positions the support plate 2123 and the haptic actuators 2124 farther from the cover sheet 2108. When an actuation signal is transmitted to at least one haptic actuator 2124 to place the haptic actuator(s) in the haptic output state, the activated haptic actuator(s) moves (e.g., contracts) and deflects the support structure 2120 such that the support plate 2123 traverses the gap 2118 and produces a localized deflection in the cover sheet 2108. When the support plate 2123 deflects, the momentum of that movement transfers to the backlight assembly 2105, the first force-sensing component 2114, and the display layer 2102 (e.g., the intermediate layers) to deflect the intermediate layers and produce the localized haptic output in the cover sheet 2108.

FIG. 22 depicts a flowchart of a method of calibrating the pre-stress signals for an array of haptic actuators. As described earlier, an array of haptic actuators can include one or more haptic actuators. Initially, as shown in block 2200, the signal levels of the initial pre-stress signals that vary the size of the gap are determined. For example, the signal levels of the initial pre-stress signals that cause a support structure to deflect such that the support plate contacts a spaced-apart overlying layer (e.g., first force-sensing component 214b in FIGS. 2C and 2D or the cover sheet 1308 in FIG. 13B) may be determined. Additionally or alternatively, the signal levels of another set of initial pre-stress signals that cause a support structure to deflect such that the support plate moves into the gap a given distance can be determined. In some implementations, the signal levels of another set of initial pre-stress signals that cause the support plate to deflect and increase the size of the gap may be determined. Thus, in some embodiments, multiple sets of pre-stress signals can be determined. Which set of pre-stress signals are used to place the array of haptic actuators in a pre-stressed state can be based on a pre-stress magnitude for the array of haptic actuators. For example, the array of haptic actuators can be placed in different pre-stressed states based on the applications the user is interacting with and/or the amount of actuation latency. The actuation latency refers to the time between transmitting an actuation signal to a haptic actuator and the time a deflection is produced in a surface.

Next, as shown in block 2202, the initial pre-stress signals (or the pre-stress signal characteristics such as amplitude) are stored in a memory (e.g., memory 448 in FIG. 4). Thereafter, as the user interacts with the electronic device, the closure or the expansion of the gap is monitored to determine an effectiveness of the initial pre-stress signals (block 2204).

A determination may be made at block 2206 as to whether the initial pre-stress signals need to be adjusted. The process waits at block 2204 when the initial pre-stress signals do not need to be adjusted. If the initial pre-stress signals need to be adjusted, the method passes to block 2208 where an adjusted signal level for one or more pre-stress signals is determined. The adjusted pre-stress signal(s) are then stored in the memory (block 2210) and the process returns to block 2204.

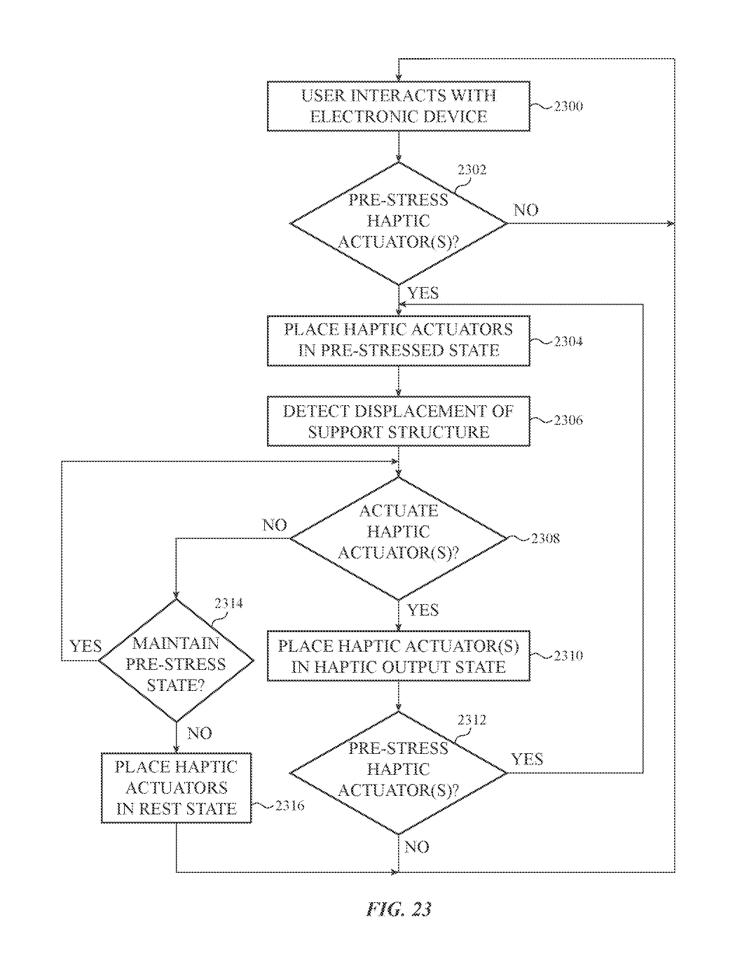

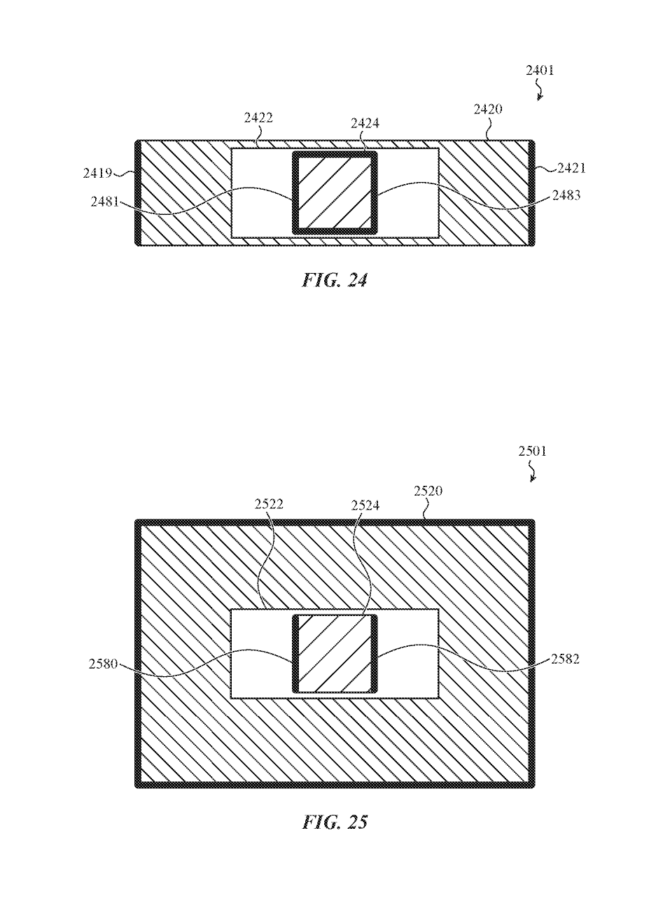

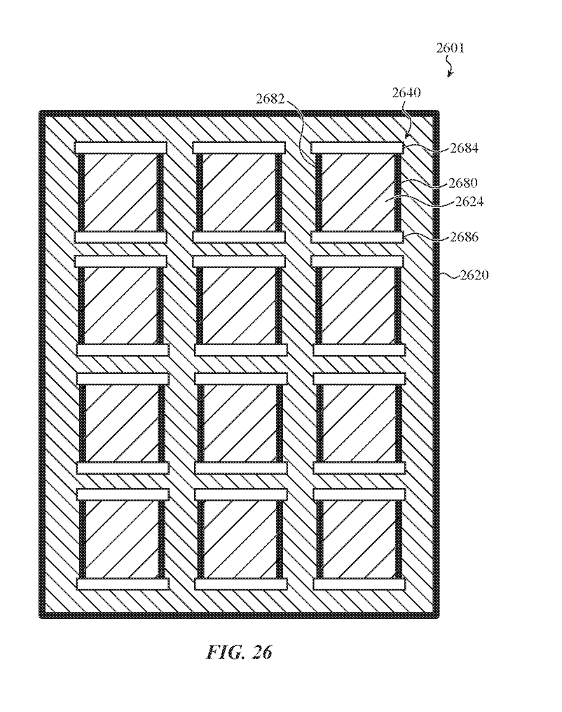

FIG. 23 depicts a flowchart of a method of operating an electronic device. Initially, as shown in block 2300, a user interacts with the electronic device. A determination may be made at block 2302 as to whether or not an array of haptic actuators is to be pre-stressed. The determination to pre-stress the array of haptic actuators can be based on one of several conditions. For example, in one embodiment, the array of haptic actuators may be pre-stressed when a body part (e.g., a finger) is approaching or in contact with a surface of the electronic device. In such embodiments, an output signal from one or more sensors (e.g., touch sensor layer 210 in FIG. 2) may be used to detect a body part (e.g., a finger) is approaching or is in contact with the surface of the electronic device.

Additionally or alternatively, the array of haptic actuators may be placed in a pre-stressed state based on the state of an application. For example, the array of haptic actuators may be placed in a pre-stressed state when the user is interacting with a gaming application that will produce haptic feedback to the user. In another example, the array of haptic actuators can be placed in a pre-stressed state when the user is interacting with a graphical user interface. And in yet another example, the array of haptic actuators may be placed in a pre-stressed state when the user is interacting with an application that requires various inputs, such as entering data into a dialog box or selecting various input elements (e.g., icons, buttons, and the like).

The process returns to block 2300 if the array of haptic actuators will not be placed in a pre-stressed state. The method passes to block 2304 if the array of haptic actuators will be placed in a pre-stressed state. At block 2304, pre-stress signals are transmitted to the haptic actuators to place the array of haptic actuators in the pre-stressed state.

Next, as shown in block 2306, the displacement of the support structure can be detected to either ascertain the closure of the gap or the expansion of the gap. A determination may then be made at block 2308 as to whether one or more haptic actuators are to be actuated (e.g., placed in a haptic output state). The process continues at block 2310 when the one or more haptic actuators is to be placed in a haptic output state. At block 2310, an actuation signal is transmitted to one or more haptic actuators to place the haptic actuator(s) in the haptic output state. The one or more haptic actuators produce one or more deflections in a surface of the electronic device when the haptic actuators are in the haptic output state.

After the one or more deflections are produced in the surface of the electronic device, a determination is made at block 2312 as to whether the array of haptic actuators is to be placed in the pre-stressed state. For example, the haptic actuators can transition from the pre-stressed state to the haptic output state multiple times while a user interacts with the electronic device.

The method returns to block 2304 when the array of haptic actuators is to be placed in the pre-stressed state. Otherwise, the process returns to block 2300 when the array of haptic actuators will not be placed in the pre-stressed state.

Returning to block 2308, the method continues at block 2314 if one or more haptic actuators will not be placed in the haptic output state. At block 2314, a determination is made as to whether the array of haptic actuators is to remain in the pre-stressed state. If so, the process passes to block 2308. If the array of haptic actuators will not remain in the pre-stressed state, the method continues at block 2316 where the array of haptic actuators is placed in the rest state. The pre-stress signals are not transmitted to the haptic actuators to place the haptic actuators in the rest state. Thereafter, the process returns to block 2300.

Although the embodiments have been described herein as electrically pre-stressing the haptic actuators to close a gap, other embodiments are not limited to this implementation. In some embodiments, the support structure or support plate may be pre-stressed through mechanical components or constraints. For example, a shim or a foam structure can be positioned below a support plate to situate the support plate closer to a surface to be deflected (e.g., partially or completely close a gap). Alternatively, in some embodiments, the support plate can be formed in a pre-stressed shape that positions the support plate closer to a surface to be deflected. In another embodiment, the support plate may be pre-stressed (e.g., shaped or bent) and then mechanically held in the pre-stressed state. For example, once in the pre-stressed state, the ends of the support plate can be attached to a structure that maintains the support structure in the pre-stressed state.

### III. Relaxing Strain in Support Structures

FIGS. 24-28 illustrate increasing deflection at a cover sheet of an electronic device by relaxing strain. FIG. 24 depicts one example of a first deflection module that is configured to produce increased deflection. For simplicity, the deflection module 2401 is illustrated with only one haptic actuator 2424. Those skilled in the art will recognize that more than one haptic actuator can be used. For example, two haptic actuators can be included in the deflection module 2401.

The haptic actuator 2424 is attached and electrically connected to a circuit layer 2422. The circuit layer 2422 is attached to a support structure. In the illustrated embodiment, the support structure is configured as a support structure stripe 2420, with two longer sides (e.g., top and bottom sides) and two shorter sides 2419, 2421. In other words, the support structure stripe 2420 has four sides, with two lateral sides 2419, 2421 having a length that is less than the length of the other two sides. In the illustrated embodiment, the length of the opposing sides 2419, 2421 in the support structure stripe 2420 are not much longer than the length of the sides 2481, 2483 of the haptic actuator 2424.

All of the sides of the haptic actuator 2424 are rigidly affixed (bonded) to the circuit layer 2422 (indicated by the thicker lines). However, only the shorter sides 2419, 2421 (the sides having the smaller length) of the support structure stripe 2420 are rigidly attached (indicated by the thicker lines) to a component in an electronic device (e.g., an enclosure, a frame, an input surface, or a cover sheet). Because only the two lateral sides 2419, 2421 of the support structure stripe 2420 are rigidly attached to a component, strain is relaxed in the support structure stripe 2420. The support structure stripe 2420 can experience a greater amount of deflection. The support structure stripe 2420 can buckle in response to the actuation of the haptic actuator 2424.

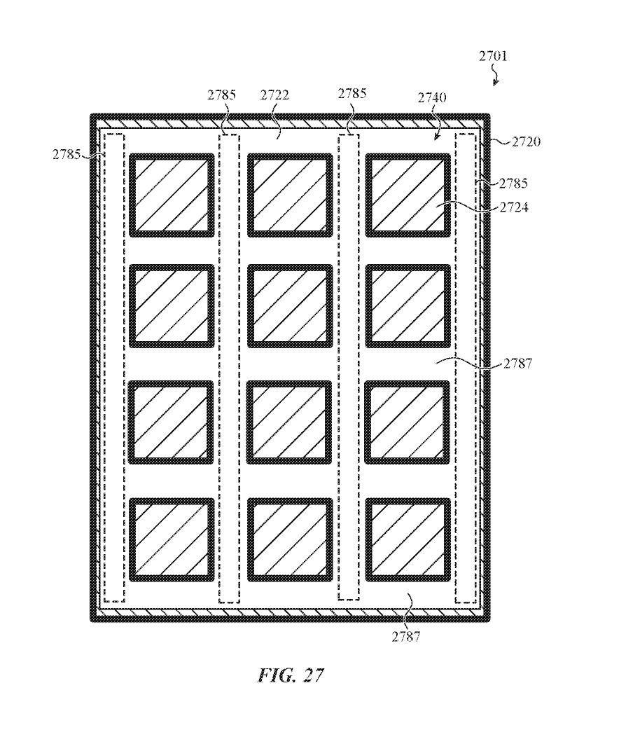

In some embodiments, an electronic device may use a support structure that is larger than a support structure stripe. In such embodiments, multiple haptic actuators may be used to deflect the larger-sized support structure. FIG. 25 depicts one example of a second deflection module that is configured to produce increased deflection. A haptic actuator 2524 is attached and electrically connected to a circuit layer 2522. The circuit layer 2522 is attached to a support structure 2520. All of the sides of the support structure 2520 are rigidly affixed to a component (indicated by the thicker lines) in an electronic device (e.g., a frame or input surface). However, only two sides 2580, 2582 of the haptic actuator 2524 are rigidly attached to the circuit layer 2522 (indicated by the thicker lines). Because only two sides (e.g., opposing lateral sides) of the haptic actuator 2524 are rigidly attached to the circuit layer 2522, the support structure 2520 may be able to experience a greater amount of deflection. The support structure 2520 can buckle in response to the actuation of the haptic actuator 2524 because the un-bonded sides of the haptic actuator 2524 relax the strain in the support structure 2520.

Although the deflection module 2501 is shown with only one haptic actuator 2524, those skilled in the art will recognize that more than one haptic actuator can be used. In some embodiments, two or more haptic actuators may be disposed on the support structure 2520.

FIG. 26 depicts one example of a third deflection module that is configured to produce increased deflection. The deflection module 2601 includes an array 2640 of haptic actuators 2624. As discussed earlier, in some embodiments, each haptic actuator 2624 may be attached and electrically connected to a circuit layer. The circuit layer is omitted from FIG. 26 for clarity and ease of understanding.

The circuit layer is affixed to a support structure 2620. All of the sides of the support structure 2620 are rigidly attached (indicated by the thicker lines) to a component in an electronic device. Two sides 2680, 2682 of each haptic actuator 2624 are rigidly affixed (indicated by the thicker lines) to the circuit layer. In the illustrated embodiment, the sides 2680, 2682 are opposing sides of each haptic actuator 2624.

Openings or slits 2684, 2686 are formed through the support structure 2620 adjacent the sides of each haptic actuator 2624 that are not rigidly affixed to the circuit layer. The openings 2684, 2686 induce strain relaxation and locally transform the larger-sized sheet of the support structure 2620 into support structure stripes. As described in conjunction with FIG. 24, a support structure stripe can buckle in response to the actuation of one or more haptic actuators, which can produce a greater amount of deflection in the support structure 2620.

The openings 2684, 2686 are shown as having a rectangular shape, but this is not required. The openings 2684, 2686 can have any given shape and/or dimensions. Additionally, in some embodiments, one or more openings may be formed through the support structure 2620. The number of openings, as well as the location(s) of the openings, can be based on the amount of deflection a support structure 2620 is to experience.

FIG. 27 depicts one example of a fourth deflection module that is configured to produce increased deflection. The deflection module 2701 includes an array 2740 of haptic actuators 2724. Each haptic actuator 2724 is attached and electrically connected to a circuit layer 2722. The circuit layer 2722 is affixed to a support structure 2720. All of the sides of the support structure 2720 are rigidly attached (indicated by the thicker lines) to a component in an electronic device. Similarly, all of the sides of each haptic actuator 2724 are rigidly affixed (indicated by the thicker lines) to the circuit layer 2722.

The circuit layer 2722 is selectively bonded to the support structure 2720. In particular, only one or more first sections 2785 of the circuit layer 2722 are rigidly affixed (indicated by the dashed lines) to the support structure 2720. One or more second sections 2787 of the circuit layer 2722 are not attached to the support structure 2720. In the illustrated embodiment, each first section 2785 is formed as a rectangular-shaped stripe that is positioned adjacent one or more haptic actuators (e.g., adjacent a line of haptic actuators) or between adjacent haptic actuators (e.g., between two lines of haptic actuators). Other embodiments can affix the one or more first sections 2785 of the circuit layer 2722 at different locations. Additionally or alternatively, each first section 2785 of the circuit layer 2722 can have any given shape and/or dimensions. The number of first sections 2785, the location of each first section 2785, the shape of each first section 2785, and the dimensions of each first section 2785 can be based on the amount of deflection a support structure is to experience. Additionally, at least one first section 2785 can have a location, shape, and/or dimensions that differ from one or more other first sections 2785.

Selectively bonding the circuit layer 2722 to the support structure 2720 relaxes the strain in the support structure 2720 in the directions around the sides of the haptic actuator 2724 that are not adjacent to a first section of the circuit layer 2722. This allows the support structure 2720 to buckle in response to the actuation of one or more haptic actuators 2724, which can produce a greater amount of deflection in the support structure 2720.

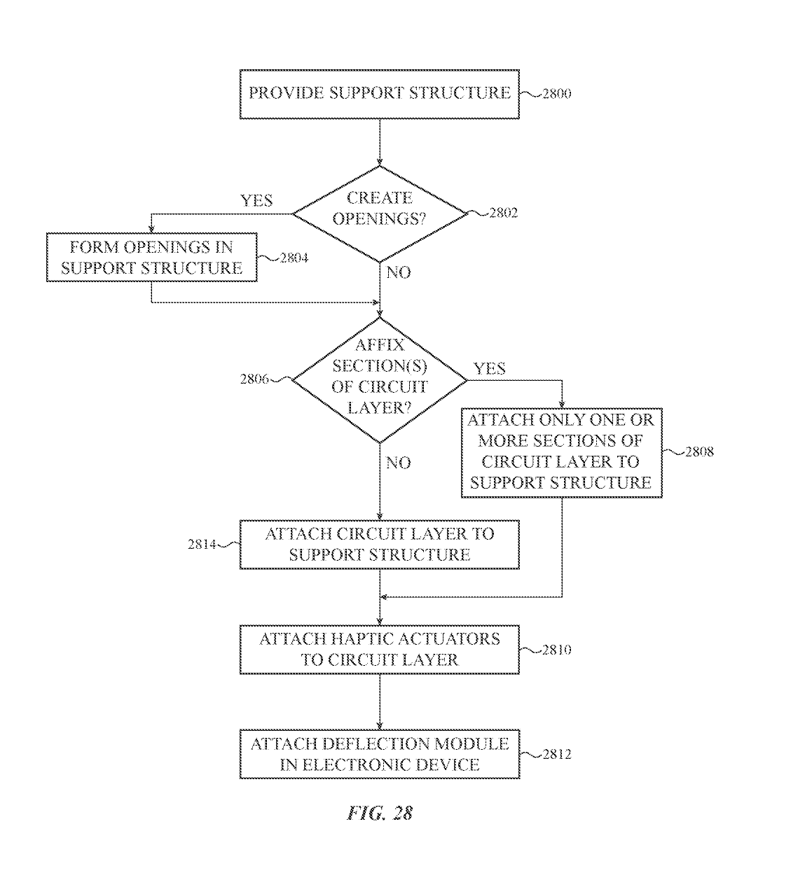

FIG. 28 depicts a flowchart of a method of producing a deflection module that provides localized deflection in a surface of an electronic device that is positioned over the deflection module. Initially, as shown in block 2800, a support structure is provided. A determination is then made at block 2802 as to whether one or more openings are to be formed through the support structure. If so, the process passes to block 2804 where the opening(s) are formed through the support structure. As described earlier, the number of openings, the dimensions of the openings, and/or the location(s) of the openings can be based on the amount of deflection a support structure is to experience.

Next, as shown in block 2806, a determination may be made as to whether only one or more sections of a circuit layer are to be rigidly attached to at least one surface of the support structure. Although the embodiments shown in FIGS. 26 and 27 were described separately, the embodiments can be combined in a haptic or deflection module. In some embodiments, one or more sections of the circuit layer can be selectively attached to the support structure, where the support structure includes opening(s) formed through the support structure. In such embodiments, corresponding opening(s) may be formed in the circuit layer, although this is not required.

If one or more sections of the circuit layer are to be rigidly attached to at least one surface of the support structure, the method continues at block 2808 where the section(s) of the circuit layer are rigidly attached to the surface(s) of the support structure. As described earlier, the number of sections, the location of each section, the dimensions of each section, and/or the shape of each section can be based on the amount of deflection a support structure is to experience.

After the section(s) of the circuit layer are selectively affixed to the surface(s) of the support structure, the process passes to block 2810 where one or more haptic actuators are attached to the circuit layer. The deflection module may then be attached to a component in the electronic device. As discussed earlier, the component can be an enclosure, a frame, an input surface, or a cover sheet in the electronic device.

When the circuit layer will not be selectively affixed to the surface(s) of the support structure at block 2806, the method continues at block 2814 where the circuit layer is attached to the support structure. Blocks 2810 and 2812 may then be performed.

Although the haptic actuators shown in FIGS. 4, 26, and 27 are arranged in an array (e.g., columns and rows), other embodiments are not limited to this configuration. The haptic actuators may be arranged in any pattern or placement. And as described earlier, one or more haptic actuators may be coupled to a top surface, a bottom surface, and/or a side of a support structure.

Additionally, the haptic actuators, the circuit layer, and the support structure are each shown in FIGS. 4, 26, and 27 as having a square or rectangular shape, but other embodiments are not limited to this configuration. Each haptic actuator may have any given shape and/or dimensions. Additionally, the circuit layer and/or the support structure can each have any given shape and/or dimensions.

### IV. Reduced Cost Piezoelectric Wafer

FIGS. 29-32 illustrate embodiments in which the piezoelectric material has a different shape, such as a cross shape. FIG. 29 depicts an arrangement of haptic actuators 2924 that may be used to provide localized haptic output for an electronic device. The haptic actuators 2924 may be any one of the haptic actuators described herein. In some embodiments, each of the haptic actuators 2924 may be arranged in a master-slave configuration. In other cases, each haptic actuator 2924 may operate independently.

As shown in FIG. 29, each haptic actuator 2924 may include a piezoelectric material 2932, a ground layer 2938, and a circuit layer 2922. The ground layer 2938 may include a ground trace made of silver and a PET flex such as described above with respect to FIG. 3D. Likewise, the circuit layer 2922 may include a drive trace made of copper and a polyimide flex such as described with respect to FIG. 3D. In order to further reduce costs, the piezoelectric material 2932 may have a cross-shape. Each haptic actuator 2924 may be coupled to a stiffener, such as a support structure 2920.

As shown, at least one dimension (e.g., a width) of the circuit layer 2922 is smaller than a dimension (e.g., a width) of the ground layer 2938. The reduction in the size of the circuit layer 2922 may reduce the overall cost of the haptic structure 2924 and also improve actuation performance of the haptic actuators 2924.

FIG. 30A depicts an example shape of a piezoelectric wafer 3033a that may be incorporated in the haptic structures described herein. For example, the piezoelectric wafer 3033a may be similar to the piezoelectric material described above with respect to FIGS. 3A-3D, 16B, and 29.

In this example, the piezoelectric wafer 3033a may have a square shape. However, when a signal is applied to the piezoelectric wafer 3033a, the area shown by the dotted line 3029 contributes the majority of the actuation performance. Accordingly, in order to reduce costs while still maintaining desirable performance characteristics, the piezoelectric wafer 3033a may be cut in a cross-shape such as shown in FIG. 30B. In the embodiment shown in FIG. 30B, the piezoelectric wafer 3033b substantially maintains the performance of the piezoelectric wafer 3033a while saving 4/9 of the material.

In the embodiment shown in FIG. 30C, the piezoelectric wafer 3033c may have rounded edges. Specifically, outward and inward right angles of the cross-shaped piezoelectric wafer 3033c may be susceptible to damage. Rounding the corners such as shown can reduce the risk of damage. In some embodiments, the rounded corners may be formed during the cutting/dicing of a piezoelectric sheet. In other implementations, one or more piezoelectric wafers 3033b may be stacked together and a router, a laser or other such tool may be used to round the corners.

FIG. 31 depicts an example piezoelectric sheet 3127 in which a number of cross-shaped piezoelectric elements have been formed. In some embodiments, the piezoelectric elements are arranged in a tessellated pattern such as shown. For example, a portion of one piezoelectric element is adjacent a portion of another piezoelectric element.

In some embodiments, the piezoelectric sheet 3127 undergoes a dicing process to produce the piezoelectric elements. The dicing process may be any cutting process such as, but not limited to, laser cutting, plasma cutting, sawing and so on. In some embodiments, the dicing of the piezoelectric sheet produces the cross-shaped piezoelectric wafer 3033b shown above with respect to FIG. 30B.

FIG. 32 depicts another example piezoelectric sheet 3227 in which a number of rounded cross-shaped piezoelectric elements are formed. The piezoelectric sheet 3227 may be diced in order to produce the cross-shaped piezoelectric wafer 3033c shown above with respect to FIG. 30C. As shown, the various piezoelectric elements in the sheet are arranged in a tessellated pattern once produced. Once cut, the piezoelectric elements shown in FIGS. 31-32 may be used in the various haptic structures described herein.

### IV. System Diagram

FIG. 33 depicts example components of an electronic device in accordance with the embodiments described herein. The schematic representation depicted in FIG. 33 may correspond to components of the devices depicted in FIGS. 1-11H, described above. However, FIG. 33 may also more generally represent other types of electronic devices with a haptic actuator 3324 coupled to a support structure configured to amplify the haptic response.

As shown in FIG. 33, a device 3300 includes a processing unit 3346 operatively connected to computer memory 3348. The processing unit 3346 may be operatively connected to the memory 3348 component via an electronic bus or bridge. The processing unit 3346 may include one or more computer processors or microcontrollers that are configured to perform operations in response to computer-readable instructions. The processing unit 3346 may be the central processing unit (CPU) of the device 3300. Additionally or alternatively, the processing unit 3346 may include other processors within the device 3300 including application specific integrated chips (ASIC) and other microcontroller devices. The processing unit 3346 may be configured to perform functionality described in the examples above.

The memory 3348 may include a variety of types of non-transitory computer-readable storage media, including, for example, read access memory (RAM), read-only memory (ROM), erasable programmable memory (e.g., EPROM and EEPROM), or flash memory. The memory 3348 is configured to store computer-readable instructions, sensor values, and other persistent software elements.

In this example, the processing unit 3346 is operable to read computer-readable instructions stored on the memory 3348. The computer-readable instructions may adapt the processing unit 3346 to perform the operations or functions described above with respect to FIGS. 1-11H. The computer-readable instructions may be provided as a computer-program product, software application, or the like.

The device 3300 may also include a battery 3303 that is configured to provide electrical power to the components of the device 3300. The battery 3303 may include one or more power storage cells that are linked together to provide an internal supply of electrical power. The battery 3303 may be operatively coupled to power management circuitry that is configured to provide appropriate voltage and power levels for individual components or groups of components within the device 3300. The battery 3303, via power management circuitry, may be configured to receive power from an external source, such as an alternating current power outlet. The battery 3303 may store received power so that the device 3300 may operate without connection to an external power source for an extended period of time, which may range from several hours to several days.

In some embodiments, the device 3300 includes one or more input devices 3390. The input device 3390 is a device that is configured to receive user input. The input device 3390 may include, for example, a push button, a touch-activated button, or the like. In some embodiments, the input devices 3390 may provide a dedicated or primary function, including, for example, a power button, volume buttons, home buttons, scroll wheels, and camera buttons. Generally, a touch sensor and a force sensor may also be classified as input components. However, for purposes of this illustrative example, the touch sensor 3310 and force sensor 3312 are depicted as distinct components within the device 3300.

The device 3300 may also include a touch sensor 3310 that is configured to determine a location of a finger or touch over the adaptable input surface of the device 3300. The touch sensor 3310 may be implemented in a touch sensor layer, and may include a capacitive array of electrodes or nodes that operate in accordance with a mutual-capacitance or self-capacitance scheme.

The device 3300 may also include a force sensor 3312 in accordance with the embodiments described herein. As previously described, the force sensor 3312 may be configured to receive force touch input over the adaptable input surface of the device 3300. The force sensor 3312 may also be implemented in a touch-sensing layer, and may include one or more force-sensitive structures that are responsive to a force or pressure applied to an external surface of the device. In accordance with the embodiments described herein, the force sensor 3312 may be configured to operate using a dynamic or adjustable force threshold. The dynamic or adjustable force threshold may be implemented using the processing unit 3346 and/or circuitry associated with or dedicated to the operation of the force sensor 3312.

The device 3300 may also include a haptic actuator 3324. The haptic actuator 3324 may be implemented as described above, and may be a ceramic piezoelectric transducer. The haptic actuator 3324 may be controlled by the processing unit 3346, and may be configured to provide haptic feedback to a user interacting with the device 3300.

The device 3300 may also include a communication port 3388 that is configured to transmit and/or receive signals or electrical communication from an external or separate device. The communication port 3388 may be configured to couple to an external device via a cable, adaptor, or other type of electrical connector. In some embodiments, the communication port 3388 may be used to couple the device 3300 to a host computer.

The device 3300 may also include a signal generator 3344. The signal generator 3344 may be operatively connected to the haptic actuator 3324, and may transmit electrical signals to the haptic actuator 3324. The signal generator is also operatively connected to the processing unit 3346. The processing unit 3346 is configured to control the generation of the electrical signals for the haptic actuator 3324.

The memory 3348 can store electronic data that can be used by the signal generator 3344. For example, the memory 3348 can store electrical data or content, such as timing signals, algorithms, and one or more different electrical signal characteristics that the signal generator 3344 can use to produce one or more electrical signals. The electrical signal characteristics include, but are not limited to, an amplitude, a phase, a frequency, and/or a timing of an electrical signal. The processing unit 3346 can cause the one or more electrical signal characteristics to be transmitted to the signal generator 3344. In response to the receipt of the electrical signal characteristic(s), the signal generator 3344 can produce an electrical signal that corresponds to the received electrical signal characteristic(s).

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

1. An electronic device, comprising:
a cover sheet defining a surface;
a haptic actuator positioned below the cover sheet; and
a support structure coupled to the haptic actuator; wherein
actuation of the haptic actuator causes a deflection in the surface at a location that substantially corresponds to a position of the haptic actuator;
the support structure is configured to amplify the deflection in the surface; and
the deflection in the surface is substantially localized at the location that substantially corresponds to the position of the haptic actuator.

2. The electronic device of claim 1, wherein the haptic actuator comprises a piezoelectric material configured to compress when the haptic actuator is actuated.

3. The electronic device of claim 1, further comprising an array of haptic actuators coupled to the support structure.

4. The electronic device of claim 3, wherein the support structure comprises an array of support structures corresponding to the array of haptic actuators.

5. The electronic device of claim 1, wherein the support structure is configured to be more flexible at a region that substantially corresponds to the position of the haptic actuator.

6. The electronic device of claim 5, wherein:
the haptic actuator is a first haptic actuator;
the electronic device further comprises a second haptic actuator coupled to the support structure; and
the support structure comprises a relief positioned between the first haptic actuator and the second haptic actuator.

7. The electronic device of claim 6, wherein the support structure comprises:
a first cavity adjacent to the first haptic actuator;
a second cavity adjacent to the second haptic actuator; and
a relief channel positioned between the first cavity and the second cavity and positioned on a side opposite the first cavity and the second cavity.

8. The electronic device of claim 5, wherein the region is formed from a material having a lower modulus of elasticity than a surrounding region.

9. The electronic device of claim 1, wherein the support structure is curved away from the cover sheet at a portion of the support structure coupled to the haptic actuator.

10. The electronic device of claim 1, wherein the support structure comprises an arm and an end of the arm is configured to displace upward in response to the actuation of the haptic actuator.

11. The electronic device of claim 1, wherein:
the support structure is an upper support structure which curves away from the haptic actuator; and
the haptic actuator is coupled to a lower support structure which curves away from the haptic actuator.

12. The electronic device of claim 11, wherein in response to the actuation of the haptic actuator the upper support structure and the lower support structure deflect vertically.

13. An electronic device, comprising:
a cover sheet defining a surface;
a support structure positioned below the cover sheet; and
a haptic actuator coupled to the support structure; wherein
a cavity is defined within a side of the support structure opposite the cover sheet;
the cavity is substantially centered over the haptic actuator; and
actuation of the haptic actuator causes a deflection in the surface that is substantially localized at a location that substantially corresponds to the haptic actuator.

14. The electronic device of claim 13, wherein the haptic actuator comprises a piezoelectric material configured to compress when the haptic actuator is actuated.

15. The electronic device of claim 14, wherein actuation of the haptic actuator causes a horizontal compression of the cavity which results in an amplified vertical deflection of the support structure above the cavity.

16. The electronic device of claim 13, wherein:
the haptic actuator is a first haptic actuator;
the cavity is a first cavity;
the electronic device further comprises a second haptic actuator coupled to the support structure;
a second cavity is defined within the support structure and positioned over the second haptic actuator; and
the support structure comprises a relief channel positioned between the first cavity and the second cavity and on a side opposite the first cavity and the second cavity.

17. An electronic device, comprising:
a cover sheet defining a surface;
a support structure positioned below the cover sheet; and
a haptic actuator coupled to the support structure; wherein
the support structure comprises a force concentration region positioned over the haptic actuator;
actuation of the haptic actuator causes an amplified deflection within the force concentration region; and
the amplified deflection within the force concentration region causes a corresponding deflection in the surface that is substantially localized at a location that substantially corresponds to the haptic actuator.

18. The electronic device of claim 17, wherein the force concentration region comprises a material having a lower modulus of elasticity than a surrounding region of the support structure.

19. The electronic device of claim 17, wherein:
the haptic actuator is a first haptic actuator;
the force concentration region is a first force concentration region;
the electronic device further comprises a second haptic actuator coupled to the support structure; and
the support structure further comprises:
a second force concentration region positioned over the second haptic actuator; and
a relief region positioned between the first force concentration region and the second force concentration region.

20. The electronic device of claim 19, wherein the first force concentration region, the second force concentration region, and the relief region each comprise a material having a lower modulus of elasticity than a surrounding region of the support structure.

21.-106. (canceled)
